(19) United States
(12) Patent Application Publication
(10) Pub. No.: US 2004/0030589 A1
(43) Pub. Date: Feb. 12, 2004

(54) Method, system and apparatus for forming an insurance program

(76) Inventors: Steven Charles Leisher, Rancho Santa Fe, CA (US); Robert Burnham Batson, Olivenhain, CA (US); Jeffrey Stratton Patterson, San Diego, CA (US); Daniel James Miller, San Diego, CA (US); Richard John Baker, Carlsbad, CA (US); Howard Bruce Abbott, San Marcos, CA (US)

Correspondence Address: DAVID R PRESTON & ASSOCIATES, 12625 HIGH BLUFF DRIVE, SUITE 205, SAN DIEGO, CA, 92130, US

(21) Appl. No.: 10/607,093

(22) Filed: Jun. 25, 2003

Related U.S. Application Data
(60) Provisional application No. 60/392,556, filed on Jun. 27, 2002.
(60) Provisional application No. 60/408,501, filed on Sep. 3, 2002.

(51) Int. Cl. G06F 17/60

(52) U.S. Cl. 705/4

(57) ABSTRACT

The present invention provides a means of calculating and evaluating a premium financing program. The present invention provides an apparatus which takes into account factors and data such as various alternative sources of funding, various alternative inflows of assets, and various outflows of assets due to taxes, interest payments, selected insurance premiums, reinsurance costs, and transaction fees incurred in maintaining the premium financing program. The present invention provides a means to calculate the amounts needed in order to fund a premium financing program. The present invention additionally provides a means for obtaining lower cost life insurance, by offsetting the cost through reinsurance, and by providing an incentive to an individual to maintain the life insurance policy in full-force by providing the possibility of receiving the individual's death benefit while they are alive.

The present application claims benefit of priority to United States provisional patent application serial No. 60/392,556 filed Jun. 27, 2002 entitled, “Life Insurance and Annuity Financing Program,” naming Steven Charles Leisher et al. as inventors; and U.S. provisional patent application serial No. 60/408,501 filed Sep. 3, 2002 entitled, “Life Insurance and Annuity Financing Program,” naming Steven Charles Leisher et al. as inventors; each of which is incorporated herein by reference in its entirety.

### BACKGROUND

Currently life insurance plans, such as premium financing programs, require clients to fund the cost of insurance through endowment. The life insurance industry costs insurance with an endowment at age 100. This insures that the life insurance policy will always be in-force and the client will be covered regardless of how long they live. As a result, many clients pay for insurance they will never need, in other words, most will die well before the policy endows. With older clients, it is often possible to reasonably estimate about how long they will live with great accuracy. For example, if a client is 75 and has had some serious medical problems, that client probably will not live past the of age 85 or 90. The difference in cost of insuring a client through endowment at age 100, as compared to the age of 90, is substantial. Oftentimes this cost will make a premium financing program prohibitively expensive. Additionally, the costs of premium financing are greatly reduced by reinsuring the insurance costs beyond life expectancy, such as age 90 to endowment. Reinsurance enables the financial professional to purchase insurance for a reasonable amount to cover the period beyond a client's life expectancy. The reinsurer receives money up front to pay any additional premiums required should the client outlive their insurance (age 90 in the above example). Presently, financial professionals lack a method and tools necessary to quickly and accurately analyze the validity of various premium financing programs for a particular client.

There is, thus, a need in the financial industry for an accurate and reliable method, system and apparatus, and a means for such method, system, and apparatus, of calculating the amounts needed to provide a means to evaluate whether a premium financing program is advisable in a particular client's current situation. In particular there is a need for a method that will take into account many factors and data such as various alternative sources of funding, various alternative inflows of assets, and various outflows of assets due to taxes, interest payments, selected insurance premiums, reinsurance costs, and transaction fees incurred in maintaining the premium financing program. There is additionally a need for a computer-implemented means for quickly and accurately performing such calculations.

There is additionally a need in the financial industry for a method and means to rapidly and accurately calculate the amount of single premium immediate annuity distributions and other contributions needed in order to offset any costs associated with the creation and maintenance of a particular premium financing program. There is further a need in the financial industry for a method and means to assist a financial professional in evaluating a particular client's financial situation, considering many factors, and to assist the professional in deciding whether or not a premium financing plan for providing income and asset protection is appropriate in the client's case.

Current methods and systems to review other types of insurance scenarios exist. PCT Publication WO 00/63812 (the '812 application) discloses a graphical interface for displaying options for funding an estate tax liability. U.S. Pat. No. 5,752,236 (the '236 patent) relates to a method and system which calculates at least two insurance plans on the same insured. U.S. Pat. No. 5,893,071 (the '071 patent) involves a computer system for determining annuity funding and incomes of potential or existing contracts. U.S. Pat. No. 5,926,800 (the '800patent) involves a system and method of providing a line of credit secured by an assignment of a life insurance policy. U.S. patent application Ser. No. 2001/0037274 (the '274 application) relates to a method of cost effectively funding a loan. U.S. Pat. No. 6,049,772 (the '772 patent) details a system for managing a hedged investments for insurance companies.

All of these patents and inventions fail to address a plurality of funding sources and options, and most importantly, the use of reinsurance to maximize the returns of the premium financing program disclosed in the present invention. In addition, they fail to provide an accurate and reliable means of calculating the amounts needed to provide a means to evaluate whether a premium financing program is advisable in a particular client's situation. Furthermore, all of these patents and inventions, along with the life insurance industry as a whole, determines the cost of life insurance by projecting the life of the insured to age 100. While this can be a reliable method for a young person in their twenties, this method does not work for an older person with a shorter life expectancy, such as someone who is in their seventies. It is now possible to reasonably determine the life expectancy of people with relatively short life expectancies, such as people over the age of seventy or an individual with a terminal condition such as amyotrophic lateral sclerosis (ALS, commonly known as Lou Gehrig's disease). The present invention determines the cost of life insurance for the insured utilizing the life expectancy plus buffer as described herein. This leads to decreased costs for the insured.

The '812 application discloses a method of funding life insurance that does not utilize reinsurance. Furthermore, th'812 application focuses on reducing tax liability. The focus of the present invention focuses on reducing the cost of insurance through a new method of costing. The '236 patent details a method that will incur higher costs than the current invention, due to its reliance on multiple policies, a longer insurance term, and a lack of a reinsurance option. The '071 patent utilizes software to calculates the value for potential or existing annuity contracts. While the '071 includes insurance in its calculations, it fails to address loans and reinsurance. The '800 patent deals with insurance costing in the traditional manner, which is to project the cost of the plan to age 100 for the insured. This can cost more for the insured, and is less reliable for the insurer. The present invention utilizes a more accurate method of calculating the cost of insurance through the insured's life expectancy. The '274 application discloses a method of where the cost of funding is determined by the traditional insurance costing method (through age 100 for the insured), and utilizes reinsurance to guarantee a lender's loan. The present invention improves upon this by costing insurance to a more accurately reflect the life expectancy of the insured. The '772 patent attempts to reduce the cost of insurance through the purchase of stocks. Fluctuations and losses in the stock market have made this patent an undesirable option for both insurance companies and insured persons.

There exists in the financial industry a need to efficiently and effectively insure objects in the manner disclosed in the present invention. The present invention, in addition to individuals, is also directed towards insurable objects with an accurately determinable life expectancy, such as thoroughbred racehorses, professional athletes, high profile commercial buildings, jet engines, electrical generation plants, and space satellites.

Construction of a new satellite can cost from $150 million to over $500 million. Satellites have an expected life often to fifteen years, dependent upon the amount of maneuvering fuel. Once the maneuvering fuel has be fully utilized, the satellite moves from a stationary orbit above a fixed point to an inclined orbit, taking it to a figure eight orbit over the equator. It is still possible to utilize a satellite in an inclined orbit, however it functionality is quite limited. Satellites are at risk to failure of electronic devices through electrostatic discharge events, dendritic growth causing short circuits in electronic units, failure of the propulsion system used to keep the satellite in the correct orbit, and impact from micrometeoroids. Insurance can be purchased to cover such eventualities, however it can be quite costly. In 1999 the GE-3 satellite spun out of control for approximately 5 hours, causing television transmission interruptions. In 1998, the Galaxy-4 satellite experienced a failure of both its primary and secondary computer systems. The functionality of the Galaxy-4 has not been restored, and the satellite was moved further into space, where it spins irreparably crippled.

To obviate the need to construct a new satellite, it is possible to purchase a used satellite. In 2002, the country of Pakistan agreed to lease a satellite for a term of five years. The manufacturer of the satellite estimated that it has a life expectancy of six to seven years. Pakistan leased the satellite, however no insurance was obtained. Any loss or delay associated with the satellite was fully borne by Pakistan. If the satellite ceases to function before the end of the five year lease, Pakistan will still be responsible for payment of the terms of the lease. There thus exists a need to reasonably insure an object, such as a satellite, which has a accurately determinable life expectancy, with the method disclosed herein.

There also are no computer-based applications which will take into account many factors and data such as various alternative sources of funding, various alternative inflows of assets, and various outflows of assets due to taxes, interest payments, selected insurance premiums, reinsurance costs, and transaction fees incurred in maintaining the premium financing program. Furthermore, there are no means to rapidly and accurately calculate the amount of single premium immediate annuity distributions and other contributions needed in order to offset any costs associated with the creation and maintenance of a particular premium financing program.

### SUMMARY

The current invention enables financial professionals to project future cash flows from the client, annuities, and other resources, and compare the cash flows with the costs of maintaining the financing program such as insurance, interest, and reinsurance.

The present invention is directed to a method that satisfies the needs of financial professionals to review a number of scenarios as rapidly and accurately as possible, when evaluating a premium financing program for a particular client. One preferred embodiment of this method is through a computer-based program or application. This method significantly reduces the costs of life insurance through the use of premium financing.

The method is designed for individuals with life expectancies between two and twenty-five years, such as seniors. The method can utilize one of three methods of funding purchases of insurance, reinsurance, and other associated costs. Funding method A is to have the insured pay any monies due for costs directly. Funding method B is to utilize a loan to facilitate payment of costs. The terms of the loan are typically interest only until maturity, whereby maturity is based upon an individual's life expectancy. The individual is responsible for paying the interest on the loan, and the principal balance of the loan is repaid from the death benefit of the life insurance policy. Funding method C is to utilize a loan to finance the cost of a life insurance policy and a single premium immediate annuity (a “SPIA”). The loan is secured by the life insurance policy, SPIA, and may require additional outside collateral. The terms of the loan are typically interest only until maturity, whereby maturity is based upon an individual's life expectancy. Interest payments are paid from SPIA distributions, and the principal balance of the loan is repaid from the death benefit of the life insurance policy.

In all three methods of funding, life expectancies are obtained through a third party medical consultant and are based upon an individual's medical history and age. The life insurance is purchased for a period based on the individual's life expectancy plus a “grace period” beyond the individual's life expectancy. The date at the end of life expectancy plus “grace period” is the payment date. The method utilizes additional reinsurance to cover potential insurance premium payments past the payment date. The individual pays an up front fee to a reinsurance provider to cover the potential premiums required to keep the life insurance policy in-force. This guarantees that the lender will always have an in-force life policy to cover the principal loan balance, as well as alleviate the individual from additional insurance costs.

The financial professional is able to obtain lower cost life insurance for several reasons. One reason is that the cost of life insurance is offset by the cost of reinsurance. This increases the probability that the life insurance company will receive their annual premiums. A large percentage of life insurance policies lapse due to non-payment of premiums. Another reason is that the individual has a stronger incentive to maintain the life insurance policy in full-force. If the individual survives to the payment date, they essentially receive their death benefit while they are alive. This added incentive further increases the probability that the life insurance company will receive their annual premiums. This increase likelihood of payment tends to lead towards reduced premiums for life insurance for this plan. As this occurs, this premium financing method becomes more attractive to a wider group of individuals.

The financial professional has the individual execute the necessary documents required to obtain the information required for the premium financing method. The financial professional compiles various information about the individual. The individual's medical records are obtained. The individual's medical records are processed by insurance underwriters of the financial professional, as well as a third party medical underwriter, for a medical evaluation and morbidity assessment. Based upon the third party medical examiner's report, the financial professional verifies the life expectancy and morbidity assessment. The financial professional obtains a plurality of life insurance quotes from various insurance providers to determine the individual's insurability and the costs of life insurance. Quotes for life insurance are for the individual's life expectancy plus a “grace period” and through endowment. This enables the financial professional to obtain more accurate and lower cost life insurance quotes. The financial professional, based upon the individual's medical records, obtains quotes for a SPIA. This information is used to project the individual's future income sources as disclosed herein. The financial professional then calculates the optimal combination of funding (from the individual, loans, and/or SPIA) to minimize expenses for the individual, and maximize the death benefit payable to the individual, through the combination of different life insurance and reinsurance options.

Having procured the necessary financial and medical history of an individual, and obtained the optimal combination of life insurance, reinsurance, individual contribution, loans, and/or SPIA, the financial professional is able to facilitate the purchase of life insurance and reinsurance for the individual. In Funding Method A, the individual purchases life insurance through their own funding means, such as investments or savings. The life insurance plan typically has an annual premium that the individual must pay to maintain the life insurance policy in full force. The individual agrees to pay all life insurance premiums through life expectancy plus the “grace period” (the end of this period is the “payment date.”) The individual additionally purchases reinsurance from a reinsurance carrier. The cost of this reinsurance is typically a percentage of the death benefit of the life insurance policy. If the individual dies before the payment date, the beneficiaries of the individual receive the death benefit of the life insurance policy from the life insurer. If the individual is alive on the payment date, the individual receives from the reinsurer the face value (equivalent of the death benefit) of the life insurance policy. The individual executes the necessary documents to name the reinsurer as the beneficiary and/or owner of the life insurance policy, formerly held in the name of the individual. The reinsurer thus has a duty to pay the annual premiums for the life insurance. Upon endowment or the death of the individual, the reinsurer receives the death benefit from the life insurer.

In Funding Method B, the individual receives a loan to purchase life insurance and reinsurance. The terms of the loan are generally interest only until maturity. Maturity is defined as the death of the individual, or the payment date. The loan is guaranteed by the life insurance and/or reinsurance plans. The funds from the loan are utilized to purchase life insurance, which typically has an annual premium that the individual must pay to maintain the life insurance policy in full force. The individual can use either their own funds, or funds from the loan, to pay subsequent annual premiums. The individual agrees to pay all life insurance premiums through payment date. The individual additionally utilizes money from the loan to purchases reinsurance from a reinsurance carrier. The cost of this reinsurance is typically a percentage of the death benefit of the life insurance policy. If the individual dies before the payment date, the beneficiaries of the individual receive the death benefit of the life insurance policy from the life insurer, less the outstanding loan balance and/or interest, which is utilized to repay the loan in full. If the individual is alive on the payment date, the individual receives from the reinsurer the face value of the life insurance policy, less the outstanding loan balance and/or interest, which is repaid from the face value payment. The loan is thus repaid in full. The individual executes the necessary documents to name the reinsurer as the beneficiary and/or owner of the life insurance policy, formerly held in the name of the individual. The reinsurer thus has a duty to pay the annual premiums for the life insurance. Upon endowment or the death of the individual, the reinsurer receives the death benefit from the life insurer.

In Funding Method C, the individual receives a loan to purchase a single premium immediate annuity (SPIA), life insurance and reinsurance. The terms of the loan are generally interest only until maturity. Maturity is defined as the death of the individual, or the payment date. The loan is guaranteed by the life insurance plan, the reinsurance plan, and/or the SPIA. The annual SPIA distribution is calculated to cover the cost of the annual premiums of the life insurance and/or the interest of the loan. The funds from the loan are utilized to purchase a SPIA. The funds from the loan (and/or the SPIA) are utilized to purchase life insurance, which typically has an annual premium that the individual must pay to maintain the life insurance policy in full force. The individual utilizes the annual distributions from the SPIA (and/or the loan) to pay the annual premiums for the life insurance policy. The individual agrees to pay all life insurance premiums through the payment date. The individual additionally utilizes money from the loan (and/or SPIA) to purchase reinsurance from a reinsurance carrier. The cost of this reinsurance is typically a percentage of the death benefit of the life insurance policy. If the individual dies before the payment date, the beneficiaries of the individual receive the death benefit of the life insurance policy from the life insurer, less the outstanding loan balance and/or interest, which is utilized to repay the loan in full. The SPIA ends at the death of the individual. If the individual is alive on the payment date, the individual receives from the reinsurer the face value of the life insurance policy, less the outstanding loan balance and/or interest, which is repaid from the face value payment. The loan is thus repaid in full. The individual continues to receive the annual SPIA distributions until their death. The individual executes the necessary documents to name the reinsurer as the beneficiary and/or owner of the life insurance policy, formerly held in the name of the individual. The reinsurer thus has a duty to pay the annual premiums for the life insurance. Upon endowment or the death of the individual, the reinsurer receives the death benefit from the life insurer.

A variety of manners and systems are available to the financial professional to implement the above-disclosed premium financing method. While this application discloses a computer implemented system and method, it is not meant to limit the present invention from being utilized in other manners, such as mechanically. The computer application disclosed herein is representative of the method as a whole, and is not intended to be limiting in itself. Features and functionality of the computer application are intended to pertain to all other methods, systems, and apparatuses for implementing the present invention.

The financial professional can additionally utilize a computer application to calculate the viability of premium financing. The financial professional inputs a plurality of data pertaining to the individual into the computer application, including life expectancy, insurance quotes, loan quotes, reinsurance quotes, and annuity quotes. The computer application calculates the cost to insure the individual for the period beyond their life expectancy, plus a pre-selected “grace period” up through endowment. The computer application calculates fees and transaction costs associated with the premium financing program. Up-front points on the loan, transaction fees, and insurance fees are included in this calculation and may vary depending upon the type of financing program contemplated. The computer application can consider the effect of various variables such as the effect of Up-front points on the loan to reduce fixed interest rates, or can consider various different floating interest rates. The computer program calculates what the individual pays in Up-front transaction fees, as well as Up-front points for reinsurance to cover any additional costs required to keep the life insurance policy in-force. The life insurance policy is initially funded through the individual's projected life expectancy plus a “grace period.” Should the individual outlive this period, reinsurance would cover the additional premiums required to keep the life policy in-force.

The computer application calculates the total amount of funding required for the premium financing program, including the various costs associated therein. The computer method can calculate costs based upon funding method A, B or C. The computer application calculates the additional loan amounts needed to purchase a SPIA to service interest on the total loan amount. The computer application provides output data which the financial professional can use to evaluate the financial validity of a particular premium financing plan for a particular individual. The computer application further calculates the required SPIA distributions and corresponding loan amount required to fund the individual's case. The computer program indicates to the financial professional the viability of the individual's case. Because the computer program has now done the complex analysis and estimation of distribution and costs of the premium financing plan, the financial professional is now in a better position to use their professional judgment in advising their client as to whether the premium financing plan is advisable in the client's current situation. Reviewing this information, the financial professional can rerun the computer application to calculate the individual's case with different values. Based upon the viability of the individual's case, the financial professional will proceed with preparing a premium financing program tailored for that particular individual.

The premium financing computer application enables the financial professionals to select from three reinsurance options: (a) future premiums only; (b) repay the loan and fund future premiums; or (c) repay loan and pay entire face amount (death benefit). By enabling the financial professional to choose from a number of reinsurance options, the application provides access to numerous reinsurance carriers. Individual reinsurance carriers provide different coverage, and vary in terms of cost. Furthermore, reinsurance carriers vary in the amount of risk they will incur. Some reinsurance providers will assume larger risk (calculation mode C) while others will only cover a smaller potential loss (calculation mode A). The reinsurance option built into the computer program provides the added benefit of pricing different reinsurance carriers, as well as provides an added layer of flexibility in pricing and program design.

In calculation mode A, the reinsurance carrier will cover future life insurance premium payments beyond a specified period. If the client lives beyond the specified period, which can be life expectancy plus a grace period buffer, the reinsurance carrier will fund future premium payments. This option typically is less expensive to the client.

In calculation mode B, the reinsurance carrier will repay total outstanding loan balance and fund future life insurance premium payments required to keep the policy in-force. Calculation mode B provides the added benefit of early loan repayment, which eliminates the interest payment liability. The client further benefits by knowing exactly how long the loan will be outstanding. In calculation mode B the reinsurance carrier takes title to SPIA distributions, which helps to reduce reinsurance costs. Calculation mode B also provides benefits to the lending institution that funded the loan, in that they are able to set a formal loan term.

In calculation mode C, the reinsurance carrier will repay total outstanding loan balance as well as pay the living client their net death benefit. Calculation mode C provides the added benefit of early loan repayment, as well as provides a specified date when clients, if still alive after their projected life expectancy plus a grace period, will receive their net death benefit. In calculation C, the reinsurance carrier takes title to SPIA distributions, which helps to reduce reinsurance costs. Calculation mode C also provides the client with the possibility that they will personally benefit from a premium finance program while they are still alive.

### BRIEF DESCRIPTION OF THE FIGURES

These and other features, aspects, and advantages of the present invention will become better understood with regard to the following description, appended claim, and accompanying drawings where:

FIG. 1 shows a flowchart of the Computer System Overview.

FIG. 2 shows a flowchart of the Software System Overview.

FIG. 3 shows a flowchart of the Computer Process Input Mode Steps.

FIG. 4A shows a flowchart of the Computer Process Calculation Mode A Steps.

FIG. 4B shows a flowchart of the Computer Process Calculation Mode B Steps.

FIG. 4C shows a flowchart of the Computer Process Calculation Mode C Steps.

FIG. 5 shows Calculation Mode A-1—Initial Calculations.

FIG. 6 shows Calculation Mode A-2—Single Premium Immediate Annuity Calculations.

FIG. 7 shows Calculation Mode A-3—Other Inflows Calculations.

FIG. 8 shows Calculation Mode A-4—Outflow Calculations.

FIG. 9 shows Calculation Mode A-5—Loan Calculations.

FIG. 10 shows Calculation Mode A-6—Other Calculations.

FIG. 11 shows Calculation Mode B-1—Initial Calculations.

FIG. 12 shows Calculation Mode B-2—Single Premium Immediate Annuity Calculations.

FIG. 13 shows Calculation Mode B-3—Other Inflows Calculations.

FIG. 14 shows Calculation Mode B-4—Outflow Calculations.

FIG. 15 shows Calculation Mode B-5—Loan Calculations.

FIG. 16 shows Calculation Mode B-6—Other Calculations.

FIG. 17 shows Calculation Mode C-1—Initial Calculations.

FIG. 18 shows Calculation Mode C-2—Single Premium Immediate Annuity Calculations.

FIG. 19 shows Calculation Mode C-3—Other Inflows Calculations.

FIG. 20 shows Calculation Mode C-4—Outflow Calculations.

FIG. 21 shows Calculation Mode C-5—Loan Calculations.

FIG. 22 shows Calculation Mode C-6—Other Calculations.

FIG. 23 shows Output Mode Steps.

FIG. 24 shows a spread sheet of the Input Fields and Initial Calculations.

FIG. 25 shows a spread sheet from the Output Mode entitled Transaction overview

FIGS. 26 A-D show a spread sheet from the Output Mode entitled Insurance & Annuity Cash Flow Analysis Model

FIG. 27 shows Funding Method A—Individual Financed Funding

FIG. 28 shows Funding Method B—Loan Financed Funding

FIG. 29 shows Funding Method C—Loan and SPIA Financed Funding

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for teaching one skilled in the art to employ the present invention in virtually any appropriately detailed system, structure, or manner.

### DEFINITIONS

“Optical data storage devices” can mean any direct access, information containing media, written and read by light, including Compact Disk (CD) and Digital Versatile Disk (DVD).

“Output device” can mean any peripheral that presents output from a computer such as a screen or a printer.

“SPIA” means a contract, purchased with a single premium, that generates regular benefit payments for a specified period of time, including for the remainder of purchasee's life.

“Video output device” can mean any peripheral that presents output from a computer in animated visual form, including Cathode Ray Tube (CRT) and Liquid Crystal Display (LCD).

“Financial professional” can mean anyone who is knowledgeable or well versed in the matter of finance, including a financial analyst.

“Premium financing program” can mean any plan for the payment of insurance premiums with borrowed monies.

“Dump In” can mean additional funds included in SPIA deposit.

“Exclusion Ratio” can mean the portion of annuity payment that is considered return of principal and is thereby non-taxable.

“Endowment” can mean when an insurance policy's cash value equals face value at death benefit Typically, when providing an individual with life insurance, the insurance industry utilizes age 100 for endowment.

“Grace period” can mean a possibly variable period of days or years added onto life expectancy for purposes of calculating life insurance and reinsurance.

“Extra years” (or “years beyond grace period”) can mean a period of years added after life expectancy and grace period to hold or monitor possible reinsurance effect data.

“Object” can mean any non-living thing that has an accurately determinable useful life expectancy, and is further capable of being insured.

“Payment date” (or “specified payment date”) can be the date at the end of the period defined as an individual's life expectancy plus “grace period.” The payment date can determined prior to the start of a premium financing program. On the payment date, if the individual under the premium financing plan is alive, the individual will receive the cash value of the life insurance plan (equivalent to the death benefit of the life insurance plan) from the reinsurer.

“Individual” can mean a potential insured individual, an insured, their agents, assignees, beneficiaries, guardians, trustees or other like fiduciary representative.

“Client” can mean an individual.

### Overview

To achieve these objects, a novel method for assisting financial professionals is described herein. The financial professional is contacted by, or contacts, an individual who desires to obtain the benefits of the premium financing program disclosed herein.

The financial first needs to obtain vital information about an individual. In an unillustrated preliminary background step, the individual executes the necessary documents required to obtain the information required for the premium financing method, including but not limited to personal and medical information. The individual's medical records are obtained. The individual's medical records are processed by insurance underwriters of the financial professional, as well as a third party medical underwriter, for a medical evaluation and morbidity assessment. An accurate life expectancy for the individual is determined in a manner common in the art. Based upon the third party medical examiner's report, the financial professional verifies the life expectancy and morbidity assessment. The financial professional obtains a plurality of life insurance quotes from various insurance providers to determine the individual's insurability and the costs of life insurance. Quotes for life insurance are for the individual's life expectancy plus a “grace period” and through endowment. This enables the financial professional to obtain more accurate and lower cost life insurance quotes. The financial professional, based upon the individual's medical records, obtains quotes for a SPIA. This information is used to project the individual's future income sources as disclosed herein. The financial professional then calculates the optimal combination of funding (from the individual, loans, and/or SPIA) to minimize expenses for the individual, and maximize the death benefit payable to the individual, through the combination of different life insurance and reinsurance options.

Having procured the necessary financial and medical history of an individual, and obtained the optimal combination of life insurance, reinsurance, individual contribution, loans, and/or SPIA, the financial professional is able to facilitate the purchase life insurance and reinsurance for the individual. The financial professional is able to utilize one of three methods for funding the premium financing program;

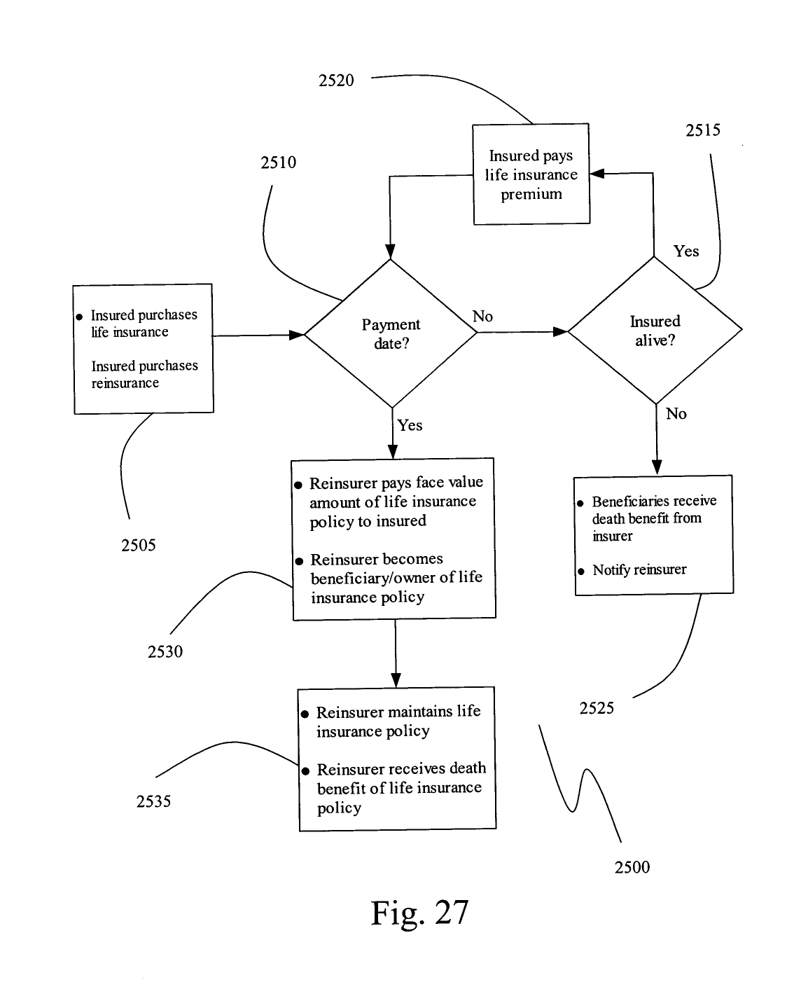

Funding Method A 2500 (as illustrated in FIG. 27), where the individual is responsible for funding the premium financing program from the individual's existing funds;

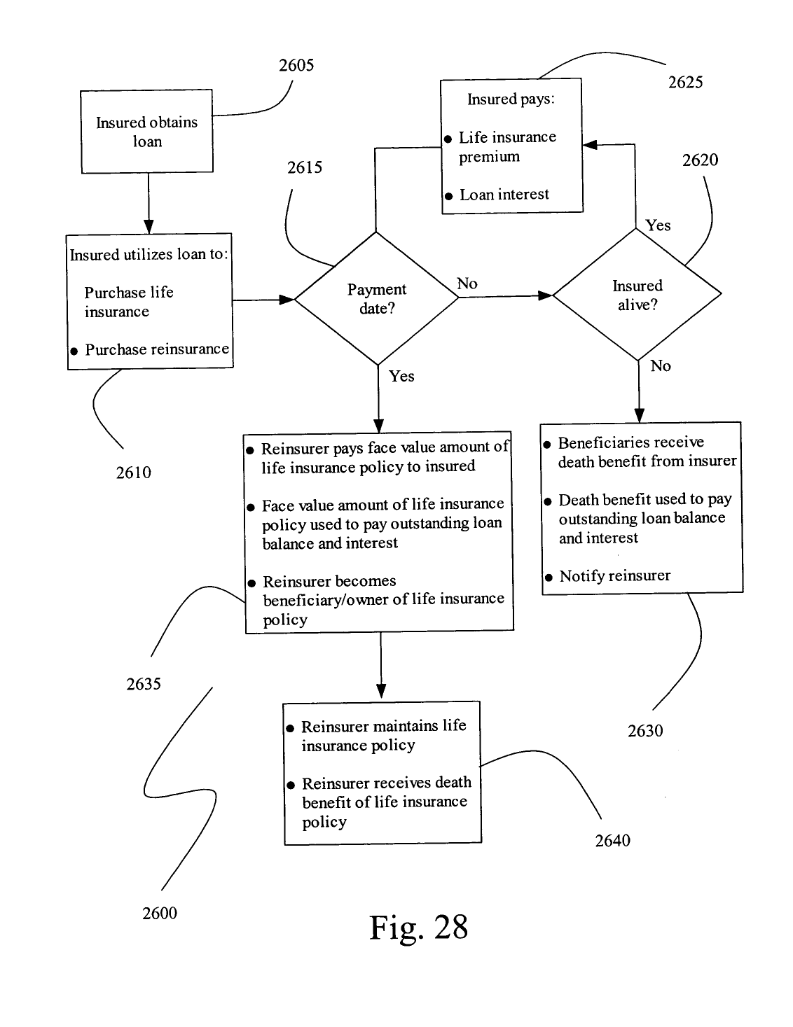

Funding Method B 2600 (as illustrated in FIG. 28), where the individual utilizes a loan for funding the premium financing program; and

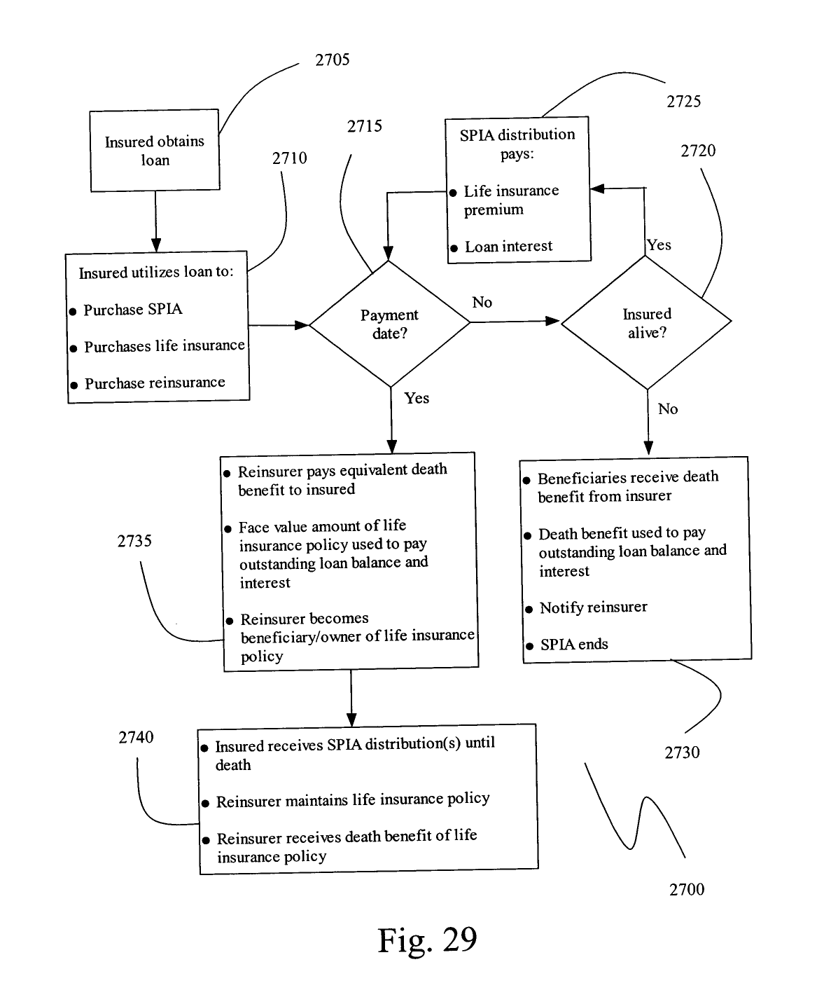

Funding Method C 2700 (as illustrated in FIG. 29), where the individual utilizes a loan and a SPIA to fund the premium financing program.

In Funding Method A 2500, as illustrated by FIG. 27, the individual, at step 2505, purchases life insurance with their own funding means. The life insurance plan typically has an annual premium that the individual must pay to maintain the life insurance policy in full force. The individual agrees to pay all life insurance premiums through the payment date. Additionally at step 2505, the individual purchases reinsurance from a reinsurance carrier. The cost of this reinsurance is typically a percentage of the death benefit of the life insurance policy. The next step in the method is to determine if the payment date has been reached (at step 2510). If the payment date has not been reached, it has to be determined if the individual is still alive (step 2515). If the individual is still alive, the individual pays the annual life insurance premium (step 2520), and the method proceeds to step 2510.

If at step 2515 it is determined that the individual is no longer alive (and is thus also before the payment date), the beneficiaries of the individual receive the death benefit of the life insurance policy from the life insurer (step 2525), and the reinsurer is notified.

If at step 2510 it is determined that the payment date has been reached, and the individual is thus still alive, the individual receives from the reinsurer the face value (equivalent of the death benefit) of the life insurance policy at step 2530. Additionally at step 2530, the individual executes the necessary documents to name the reinsurer as the beneficiary and/or owner of the life insurance policy, formerly held in the name of the individual. At step 2535, the reinsurer thus has a duty to pay the annual premiums for the life insurance. Upon endowment or the death of the individual, the reinsurer receives the death benefit from the life insurer, and the premium financing method for that individual ends.

In Funding Method B 2600, as illustrated by FIG. 28, the individual, at step 2605, receives a loan to purchase life insurance and reinsurance. The terms of the loan are generally interest only until maturity. Maturity is defined as the death of the individual, or the payment date. The loan is guaranteed by the life insurance and/or reinsurance plans. At step 2610, the funds from the loan are utilized to purchase life insurance, which typically has an annual premium that the individual must pay to maintain the life insurance policy in full force. The individual agrees to pay all life insurance premiums through payment date. At step 2610, the individual additionally utilizes money from the loan to purchases reinsurance from a reinsurance carrier. The cost of this reinsurance is typically a percentage of the death benefit of the life insurance policy. The next step in the method is to determine if the payment date has been reached (at step 2615). If the payment date has not been reached, it has to be determined if the individual is still alive (step 2620). If the individual is still alive, the individual pays the annual life insurance premium and interest on the loan (step 2625), and the method proceeds to step 2615.

If at step 2620 it is determined that the individual is no longer alive (and is thus also before the payment date), the beneficiaries of the individual receive the death benefit of the life insurance policy from the life insurer, less the outstanding loan balance and/or interest, which is utilized to repay the loan in full (step 2630), and additionally the reinsurer is notified.

If when at step 2615 it is determined that the payment date has been reached (and the individual is thus still alive), the individual, at step 2635, receives from the reinsurer the face value of the life insurance policy, less the outstanding loan balance and/or interest, which is utilized to repay the loan in full. Additionally at step 2635, the individual executes the necessary documents to name the reinsurer as the beneficiary and/or owner of the life insurance policy, formerly held in the name of the individual. Continuing to step 2640, the reinsurer thus has a duty to pay the annual premiums for the life insurance. Further at step 2640, upon endowment or the death of the individual, the reinsurer receives the death benefit from the life insurer, and the premium financing method for the individual ends.

In Funding Method C 2700, as illustrated by FIG. 29, the individual, at step 2705, receives a loan to purchase life insurance, reinsurance, and a SPIA. The terms of the loan are generally interest only until maturity. Maturity is defined as the death of the individual, or the payment date. The loan is guaranteed by the life insurance, reinsurance, and/or SPIA. At step 2710, the funds from the loan are utilized to purchase life insurance, which typically has an annual premium that the individual must pay to maintain the life insurance policy in full force. The individual agrees to pay all life insurance premiums through payment date. Additionally at step 2710, the funds from the loan are utilized to purchase a SPIA. The annual SPIA distribution is calculated to cover the cost of the annual premiums of the life insurance and/or the interest of the loan. Further at step 2710, the individual utilizes funds from the loan to purchase reinsurance from a reinsurance carrier. The cost of this reinsurance is typically a percentage of the death benefit of the life insurance policy. The next step in the method is to determine if the payment date has been reached (at step 2715). If the payment date has not been reached, it has to be determined if the individual is still alive (step 2720). If the individual is still alive, the individual utilizes the SPIA to pay the annual life insurance premium and interest on the loan (step 2725), and the method proceeds to step 2715.

If at step 2720 it is determined that the individual is no longer alive (and is thus also before the payment date), the beneficiaries of the individual receive the death benefit of the life insurance policy from the life insurer, less the outstanding loan balance and/or interest, which is utilized to repay the loan in full (step 2730), and additionally the reinsurer is notified. The SPIA ends at the death of the individual.

If when at step 2715 it is determined that the payment date has been reached (and the individual is thus still alive), the individual, at step 2735 receives from the reinsurer the face value of the life insurance policy, less the outstanding loan balance and/or interest, which is utilized to repay the loan in full. Additionally at step 2735, the individual executes the necessary documents to name the reinsurer as the beneficiary and/or owner of the life insurance policy, formerly held in the name of the individual. Continuing to step 2740, the reinsurer thus has a duty to pay the annual premiums for the life insurance. The individual continues to receive annual SPIA distributions until their death. Further at step 2640, upon endowment or the death of the individual, the reinsurer receives the death benefit from the life insurer, and the premium financing method for the individual ends.

To further facilitate the financial professional in determining whether a premium financing program is viable for an individual, a novel computer based application for assisting the financial professional is described herein. The application evaluates a wide range of data, some provided by the client and supplied to the application by the professional, some provided by outside sources and also supplied to the application by the professional, and some data supplied directly to the application by outside databases and other financial computer-based applications.

The computer-based application described herein has three modes of use. The first of these modes is an input mode. In this input mode, the user of the computer-based application is prompted to enter the pertinent information about the client into the correct fields. Once the information is entered into these fields, the application while in input mode will error check the data contained in those fields so as to attempt to limit the error in calculations due to faulty user supplied data. If the data entered by the user is found to be in error, the application will then prompt the user to re-enter the correct data in place of the erroneous data. Once the user has entered all relevant data, and such data has been checked for errors and determined not to be faulty, the user is then presented with a choice of at least one of three algorithms for processing that data. The appropriate data is then passed by the application to the correct branch of the next mode of the application, the calculation mode.

The second mode of the computer-based application is the calculation mode. In this second mode, the data supplied by the user of the application, as well as data supplied from outside sources, databases, or other computer-based applications, will be combined and analyzed using the methods disclosed herein. The application will use at least one of three algorithms to perform calculations on the data. Once the calculations are done using the data supplied from the first mode, the output from the calculations is passed to the third mode, or the output mode.

The third mode of the application is the output mode. In this mode, the application will format the data calculated by the second mode and passed to it by the second mode into a meaningful text or graphical user interface format which will allow the user of the application to make use of the calculated results efficiently. Once this data is presented to the user, the user will have the option of saving the data to various magnetic or optical data storage devices (i.e., a floppy disk, a CD-R, a CD R/W, a hard drive) for later retrieval and use. The user will also have the choice of printing the data out as a hard copy by way of an output device such as a printer. Next, the user will have the option of directing the application to perform optimizing calculations. If the user chooses this, the application will solve, using the data input in the Input Mode, and also the data calculated during the Calculation Mode to solve for the single premium immediate annuity or client contribution amount needed. The user will then be asked if they wish to direct the application to do another round of input and calculations, to perform new calculations using a different calculation mode procedure using the same data from the preceding input mode, or to exit.

### Computer System Overview

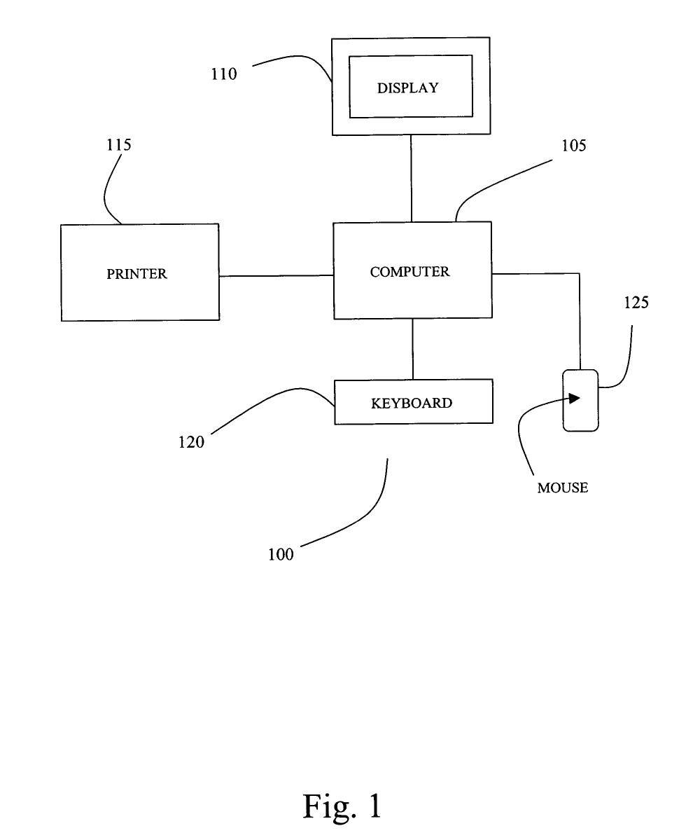

The computer-based application of the present invention includes computer hardware and software. FIG. 1 shows an apparatus 100 for carrying out the preferred embodiment of the invention. A computer 105 of the traditional type, including an unillustrated motherboard, is shown. The unillustrated motherboard contains a central processing unit (CPU), a basic input/output system (BIOS), one or more RAM memory devices and ROM memory devices, mass storage interfaces which connect to magnetic or optical storage devices including hard disk storage and one or more floppy drives, and may include serial ports, parallel ports, and USB ports, and expansion slots. The computer 105 is operatively connected by wires to a display monitor 110, a printer 115, a keyboard 120, and a mouse 125, though a variety of connection means and input and output devices may be substituted without departing from the invention.

The computer used in connection with the computer program may run an IBM-compatible personal computer, running a variety of operating systems including MS-DOS®, Microsoft® Windows®, Linux® or Lindows™. Alternatively, the computer program may run on other computer environments, including mainframe systems such as UNIX® and VMS®, or the Macintosh® personal computer environment.

All of these elements and the manner in which they are connected are well-known in the art. In addition, one skilled in the art will recognize that these elements need not be connected in a single unit such as personal computer or mainframe, but may be connected over a network or via telecommunications links. The computer hardware described above may operate as a stand-alone system, or may be part of a local area network, or may comprise a series of terminals connected to a central system.

### Software System Overview

The computer program evaluates a wide range of data, some provided by the individual and supplied to the application by the professional, some provided by outside sources and also supplied to the application by the professional, and some data supplied directly to the application by outside databases and other financial computer-based applications.

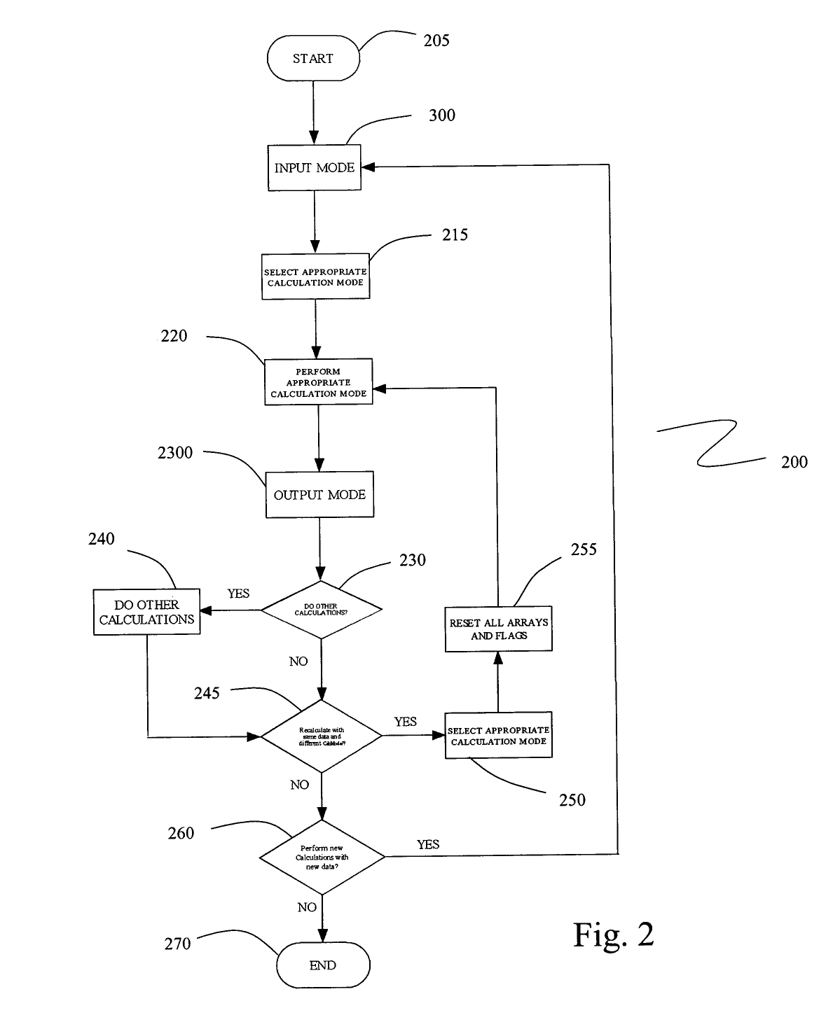

With reference to FIG. 2, as illustrated in computer software overview 200, the professional enters various financial information in input mode 300 about the client into fields corresponding to pertinent information for making the appropriate calculations, then that input optionally is checked for possible typographical errors and human-error mistakes. Once this checking is complete, the professional is given the option of selecting the calculation mode in step 215. The data provided by the professional is then collected by the application and then processed by the appropriate calculation mode via step 220. The calculations of calculation modes A 400, B 415, and C 430 utilize algorithms for determining the feasibility, price, distributions of, and liabilities incurred by, the creation of a premium financing program for the client. In calculation mode A 400, a reinsurance carrier will cover future premium payments beyond a specified and optionally variable period. If the client lives beyond the specified period, which can life expectancy plus a grace period, the reinsurance carrier will fund future premium payments. In calculation mode B 415, a reinsurance carrier will repay total outstanding loan balance and fund future premium payments required to keep the policy in-force. In calculation mode C 430, a reinsurance carrier will repay total outstanding loan balance as well as pay the client, while alive, the net death benefit of the life insurance period.

Once the output data is derived by the application, the data supplied by the professional, along with the data calculated by the application is output through output mode 2300 to an output device such as a computer CRT or LCD monitor. Because the application has now done the complex analysis and estimation of distribution and costs of the premium financing plan, the financial professional is now in a better position to use their professional judgment in advising their client as to whether the premium financing plan is advisable in the client's current situation. The data, now output to an output device like a monitor, will query the user of the application whether a hard-copy of the data in printed form should be generated, and whether or not the information created by the algorithm should be saved by means of magnetic or optical storage device for later use. At the time of output to the output device, the user of this application will also have the choice 230 of directing the application to solve for the asset inflows needed to cover the various costs of the premium financing plan. If the user chooses this, the application will solve (step 240), using the data input in the input mode 300, and also the data calculated during the calculation modes A 400, B 415, and/or C 430 to solve for the single premium immediate annuity or client contribution amount needed. The user will then be asked (step 245) if they wish to direct the application to utilize a different calculation mode. If the user chooses yes, the user then chooses the appropriate calculation mode (step 250). The program resets all arrays and flags at step 255, and returns to step 220 to perform the appropriate calculation. If the user chooses no at step 245, the user is then asked whether they desire to perform another round of input and calculations at step 260. If the user decides to run the application again, the application resets the variables (in an unillustrated step 240) and returns to input mode 300. If the user decides not to run the application again, it exits (step 270).

Aspects of the computer-based application are spreadsheet operable with the Excel® spreadsheet program available from Microsoft®. One skilled in the art will recognize that many other spreadsheet or programming languages may be utilized to implement the present invention, such as the Lotus 1-2-3® spreadsheet program available from Lotus Development Corporation or the C/C++ programming language.

### I. Detailed Description of Input Mode

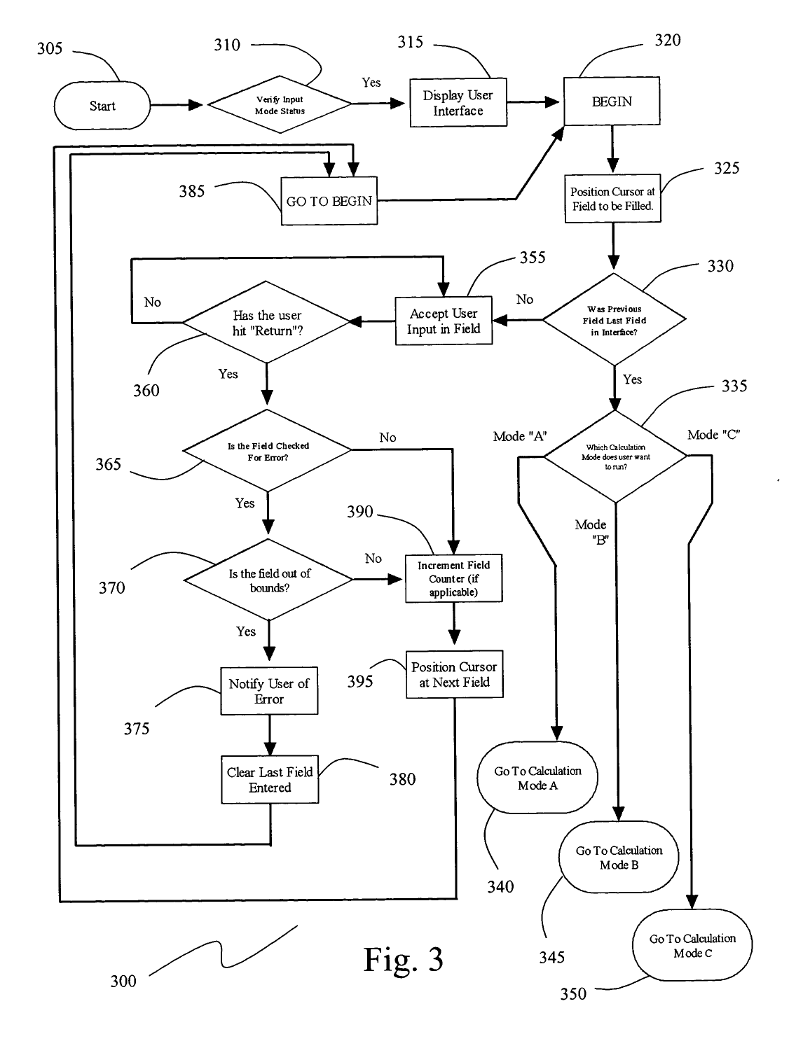

Input mode steps 300, as illustrated in FIG. 3, are now described. Input mode begins at step 305, and verifies that the program is in input mode (step 310). During the computer-based application's input mode 300, the user is presented with a graphical or text based interface 315 for entering the pertinent data relating to the client's financial situation. The application begins a data collection loop at step 320. If necessary, the cursor on the display monitor is positioned at the field to be filled (step 325). The loop verifies that the last input entered was the last field (step 330). If the last input was not the last field, the program continues to step 355 to accept data from the user. Data, such as the name of the client, the age of the client, annual income, life insurance policies, life insurance costs, sources of funds for the single premium immediate annuity, and so on, are entered by the user (step 355). The application receives an input from the user denoting the user has finished inputting that field, such as by pressing the return key (step 360). The application checks whether the inputted field is to be error checked (step 365). If the field is to be error checked, the application verifies that the field is out of bounds (step 370), and if the data is found by the program to possibly be in error, the application will then notify the user of the error (step 375), clear the last field entered (step 380), and then goes to begin (step 385) the input loop that begins at step 320. If a field is determined in step 365 to not be error checked, or is found to be within bounds in step 370, the application increments the field counter if applicable (step 390). The application then positions the cursor or like input interface at the next field to be inputted (step 395). The application then goes to begin (step 385) the input loop that begins at step 320.

If at step 330, the application determines that the last field in the interface was entered, the application then queries the user at step 335 as to which procedure in the calculation mode to use. If the user chooses calculation mode A 400 at step 335, the program then submits this information to the calculation mode A 400 through step 340. If the user chooses calculation mode B 415 at step 335, the program then submits this information to the calculation mode B 415 through step 345. If the user chooses calculation mode C 400 at step 335, the program then submits this information to the calculation mode C 430 through step 350.

The fields to be entered by the user of the application are among, but not limited to, the list that follows: the name of the client, the age of the client, the sex of the client, the agent of the client, the tax rate under which the client falls, the client's underwriting class, the client's net worth, the client's liquidity, the client's annual income, the “model term” or life expectancy of the client, the client's carriers, the total amount of the deposits into the SPIA, including, the amount of the loan to the SPIA, the SPIA dump in, and other sources for the SPIA, the offer rate of the SPIA, the exclusion ratio for the SPIA, the annualized payments from the SPIA, fields for the type of life insurance premiums the client pays, the provider, the prepay penalty, the total amount paid by client for all life insurance premiums, the amount of the investment account, the yield of the investment account, the lender that will be the source of funds, the amount that lender will loan, the rate of that loan, the step if the loan is an adjustable rate loan, the maximum rate of the loan, the terms of the loan, loan prepayment per annum, loan additions per annum, the amount that the client contributes, life settlement, SPIA dump in, other sources of funds, the total uses for the funds, new life insurance, SPIA, investment account, a check for those uses of funds. Fields can also be provided for the following: the owner of the life insurance policy(ies), and fields for each of the following for each insurance policy owned: the policy name, the policy amount, the policy's current rate, the policy's assumed rate, and the policy's guaranteed rate. There can also be fields for total new coverage under these policies, the total loan, and the total new insurance to the estate.

The variables provided in the following pseudocode are used for illustrative purposes for ease of the viewer. Any variety of variable names can be utilized. Furthermore, data structures, such as scalar and array variables, are provided herein as representative data structures. As one skilled in the art will realize, varying types of data structures can be implemented to accomplish the functionality and outcome of the pseudocode.

Input Mode PsuedoCode

<Global Variable ArrayOffset=1>

This is a global variable which will be used often in this pseudocode. The reason for this offset is that year 1 of the projection will often be stored in array element 0. The nature of arrays in programming is to often have an array start at element[0] and continue to the maximum number of cells for which the array is defined −1. For example, a 100-element array would have element indexes [0]-[99] Using an array offset of 1, and subtracting it from the loop control variable, one skilled in the art will see “TestArray[12—ArrayOffset]” instead of TestArray[11], both of which mean PROJECTED YEAR 12. If one reading the code simply ignores the variable ArrayOffset, and focuses on the 12, that person instantly knows what year the code is pointing to, without having to remember that the array element with actual index 11 points to year 12. This global variable is optional, and need not be necessary for the functionality of the present invention.

If currentMode = InputMode
Then

<display graphical or text user interface>
<position cursor at first field to be filled>

BEGIN

If the previous field was the last field in the interface

Then

<Query user as to which procedure within Calculation Mode
to use>
Case
UserResponse = ProcedureA; CurrentMode = CalcModeA

GOTO CALCULATION MODE A

UserResponse = ProcedureB; CurrentMode = CalcModeB

GOTO CALCULATION MODE B

UserResponse = ProcedureC; CurrentMode = CalcModeC

GOTO CALCULATION MODE C

ENDCASE
ENDIF
<Accept user input in field>

For example, input data on the client such as scanf(“Enter the age of the client:”). This input section can be modified to prompt the user for the plurality of inputs as described and disclosed above.

If EOL/CarriageReturn
Then

If isFieldCheckedforError = True
Then

If FieldEnteredByUser < > preSetBounds
Then

<Notify user of error>
<Clear last field entered>
<GOTO BEGIN>

Else

Increment field counter if applicable (i.e.

TotalNumberOfLifeInsurancePolicies)>
<Position cursor at next input field>
<GOTO BEGIN>

Else

<Increment field counter if applicable (i.e.

TotalNumberOfLifeInsurancePolicies)>

<GOTO BEGIN>

END INPUT MODE

### II. Detailed Description of Calculation Mode

A. Detailed Description of Calculation Mode a

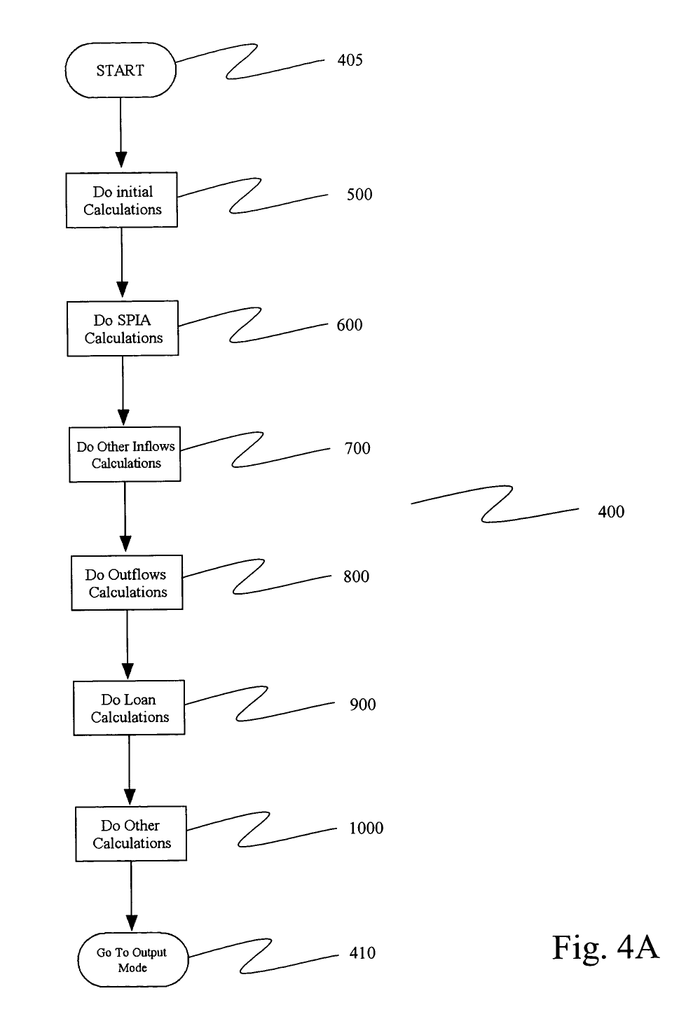

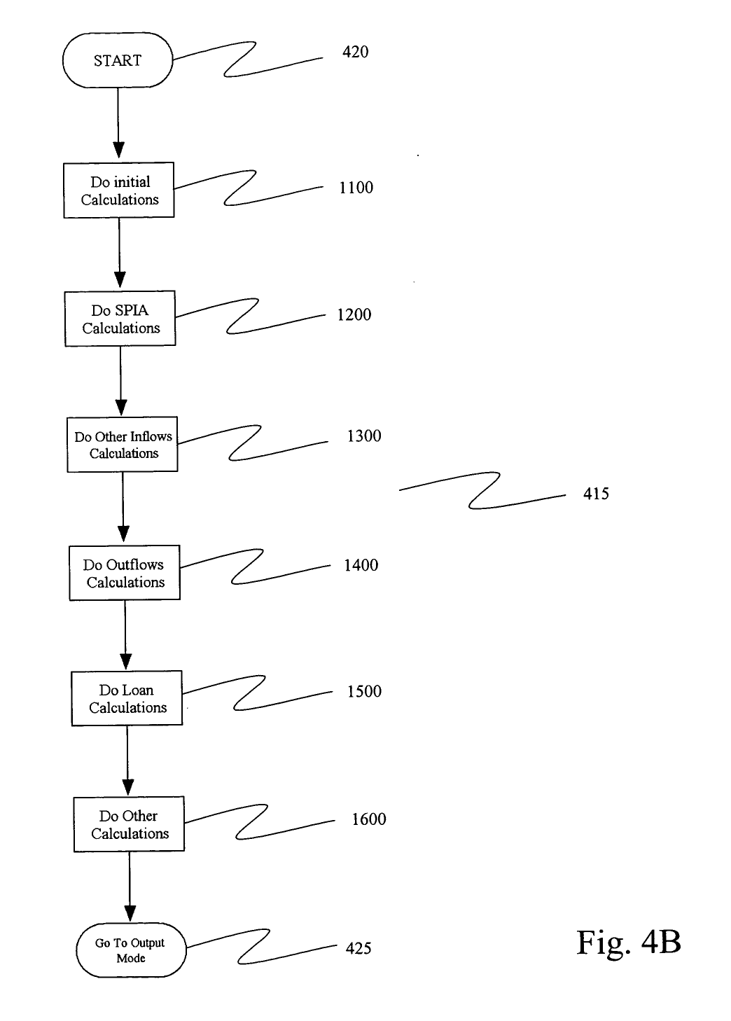

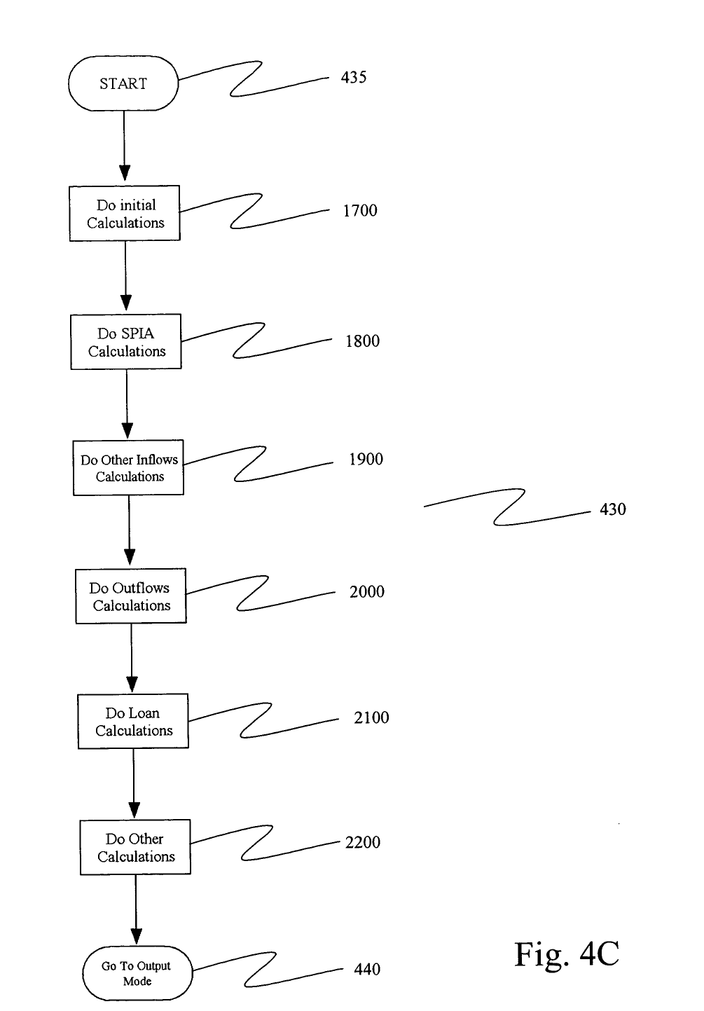

The first of three calculation modes that the user has the option of choosing is calculation mode A 400, as illustrated in FIG. 4A, which is now generally described. The calculation mode begins (step 405). The application first processes the initial calculations 500, then SPIA calculations 600, then processes other inflows calculations 700, then outflow calculations 800, then loan calculations 900, and finally other calculations 1000. This information is then transmitted to output mode 2300 via step 410. In calculation mode A 400, a reinsurance carrier will cover future premium payments beyond a specified period. If the client lives beyond the specified period, which can be life expectancy plus a grace period, the reinsurance carrier will fund future premium payments. The application utilizes calculation mode A in the manner elucidated below.

1. Initial Calculations

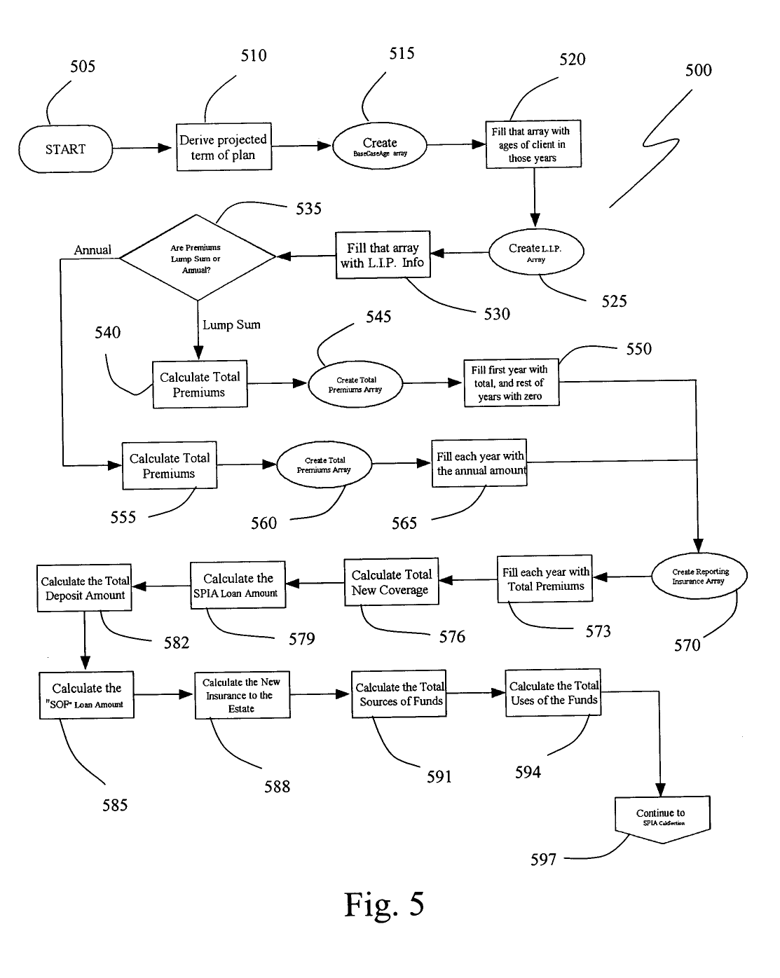

The calculation mode A 400 begins with initial calculations 500 as illustrated by FIG. 5. Initial calculations 500 begin at step 505. The application first derives the projected term for the premium financing plan (step 510). The application then creates an array (step 515) with an element for each year of the client's future projected lifetime, and fills that array with what age the client will be in that projected year (step 520). This is accomplished by adding the client's projected life expectancy to their present age, plus a “grace period” ranging from one to fifteen years. This number gives an estimate of the amount of years the client has left to live, and therefore the amount of years the SPIA is to successfully carry out its goals.

The application then generates an array (step 525) and fills it with data, such as the names, premiums, and coverage amounts of all life insurance policies on the client based on the data that was supplied by the user (step 530).

The application then checks at step 535 whether the life insurance policies are lump sum or annual. If the life insurance policy is annual, the application calculates the total premiums (step 555). The application then creates a total premiums array (step 560). Each year in the array is filled with the annual amount (step 565). If the life insurance policy is lump sum, the application calculates the total premiums (step 540). The application then creates a total premiums array (step 545). The first year is filled with the total payment, and the rest of the years in the array are filled with zeros (step 550). The application calculates (in an unillustrated step) the total of all life insurance premiums to be paid by adding together all life insurance premiums contained in the array of life insurance information. This is done by traversing the array and adding together all of the premium amounts from each policy. When the traversal reaches the end of the array, the amount in the running total is the total amount of life insurance premiums for all policies.

Next, in an unillustrated step, the application calculates the total cost of reinsurance of the life insurance premiums. This calculation is a function of future premium liabilities and the premium financing term.

The application then creates a reporting insurance array (step 570) with an element for each year in the client's projected life span, and then places the total life insurance premium amount in each element to represent the amount to be paid each year by the client (step 573).

Next, the application calculates the total new coverage (step 576) under the life insurance policies by adding together the amounts of coverage from each of the insurance policies contained in the insurance policy information array created above. The application calculates the SPIA loan needed in step 579, then calculates the total deposit amount (step 582). The application next calculates the loan amount (step 585).

The application calculates the new insurance (step 588) to the estate by subtracting the loan amount from the total new coverage. The application, in step 591, then calculates the total funds from all sources based upon the user's input of the loan amount and any other sources obtained from the user input fields that correspond to available source funds. The application then calculates the total uses of the funds (step 594). The application then moves on (step 597) to perform the SPIA related calculations below.

2. SPIA Calculations

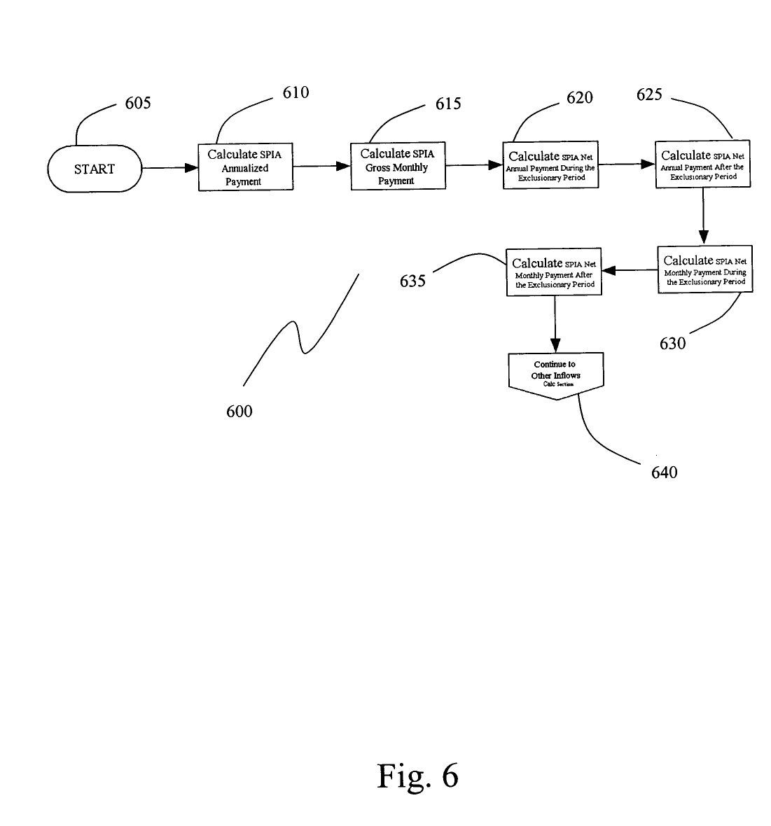

Calculation mode A continues with SPIA calculations mode 600, as illustrated in FIG. 6, which are now described. The SPIA calculations mode 600 begins at step 605. Utilizing total deposit as calculated in step 582, the application then computes the SPIA annualized payments (step 610) by multiplying the total deposit amount by the SPIA offer rate. The application next computes the SPIA gross monthly payment amount(step 615) by dividing the SPIA annualized payments by 12. Next, the application calculates the SPIA annualized net payment during the exclusionary period (step 620). This is done by subtracting client's tax rate multiplied by the quantity (the SPIA annualized payment multiplied by one minus the SPIA exclusion ratio) from the SPIA annualized payment.

The application then calculates the SPIA annualized net payment after the exclusionary period (step 625) by subtracting the quantity (the SPIA annualized payment multiplied by the client's tax rate) from the SPIA annualized payment. Next the application computes the SPIA net monthly payment amount during the exclusionary period (step 630) by dividing the SPIA annualized payment during the exclusionary period by 12. The application then calculates the SPIA net monthly payment amount after exclusion (step 635) by dividing the SPIA annualized payment after the exclusionary period by 12.

The application then proceeds (step 640) to calculate other inflows.

3. Other Inflows Calculations

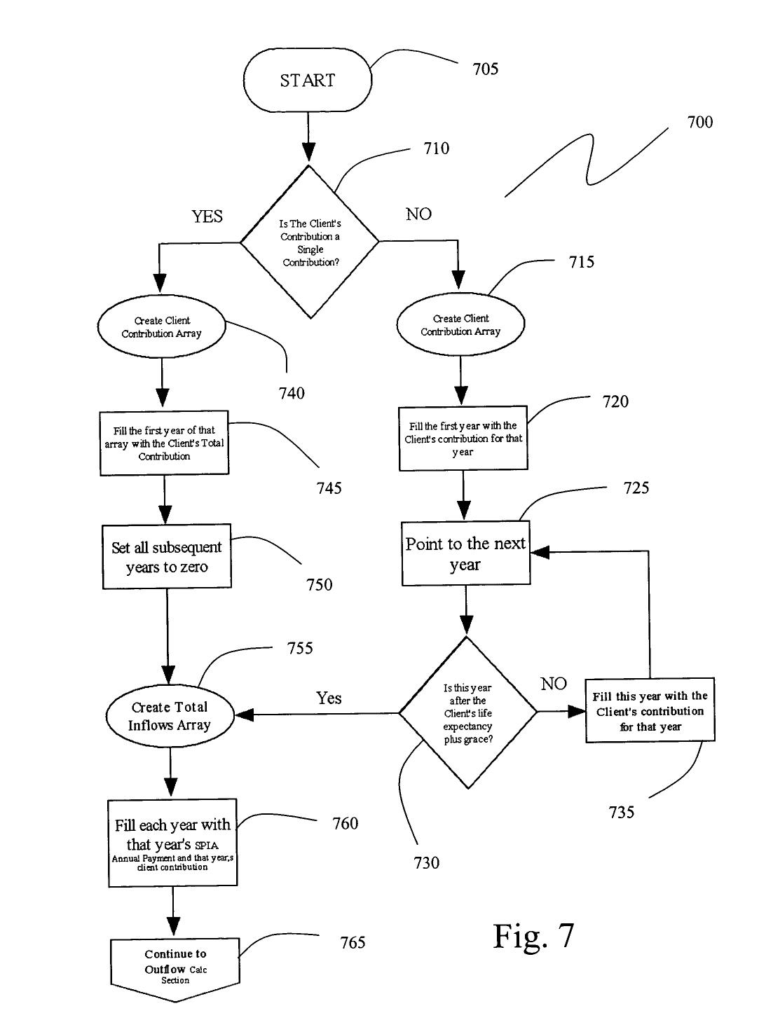

Calculation mode A continues with other inflows calculations 700, as illustrated in FIG. 7, which are now described. Beginning with step 705, the application verifies at step 710 whether the client is going to make a multiple contributions or single contribution. If the client is to make more than one contribution, an array is created (step 715) with the number of elements corresponding to the number of years in the projection. The contribution by the client for the first year is filled in the array (step 720). The program then moves to the next year in the array (step 725). The application then determines if the year is after the client's life expectancy (step 730). If yes, the application moves to step 755. If the year is not after the client's life expectancy, the application fills the year with the client's contribution for that year (step 735). The application then proceeds to the loop that begins at step 725.

If the client makes a single contribution, the application creates an array (step 740) with the number of elements corresponding to the number of years in the projection. The first element in the array is populated (step 745) by the total amount of that contribution, and the rest of the elements are filled with the amount 0 (step 750).

The application then calculates the total inflow amounts. It does this by creating an array (step 755) with the same number of elements as the projected life term, and then in step 760 populates each element with the SPIA annualized payment plus the amount of the client's contribution for that year. The amounts contained in each element of this array will correspond to the amount of total inflow for that year of the projection.

The application then moves (step 765) on to perform outflow calculations.

4. Outflow Calculations Section

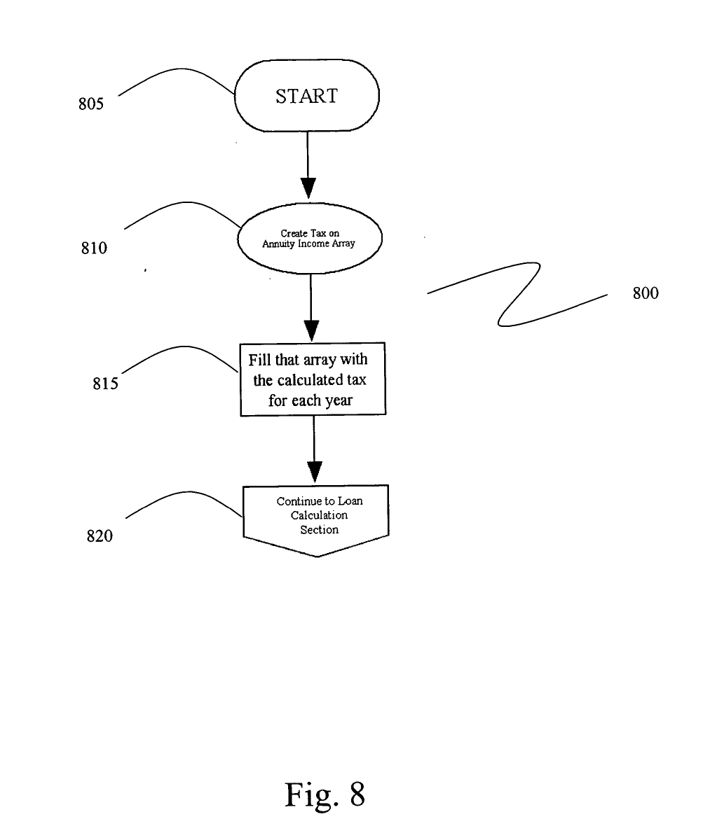

Calculation mode A next performs outflow calculations 800, as illustrated in FIG. 8, which are now described. The application begins (step 805) this by calculating the tax on the annuity income for each year of the projection. This is done by creating an array (step 810) with elements corresponding to the amount of years in the projection. The array is then filled (step 815) by placing in each element the amount of tax on the annuity income. This is calculated by multiplying the SPIA annualized income times the client's tax rate, and then multiplying that quantity by one minus the SPIA Exclusion Ratio. This section will also include insurance costs if the insurance premium is paid annually.

The program then moves (step 820) on to perform loan calculations.

5. Loan Calculations Section

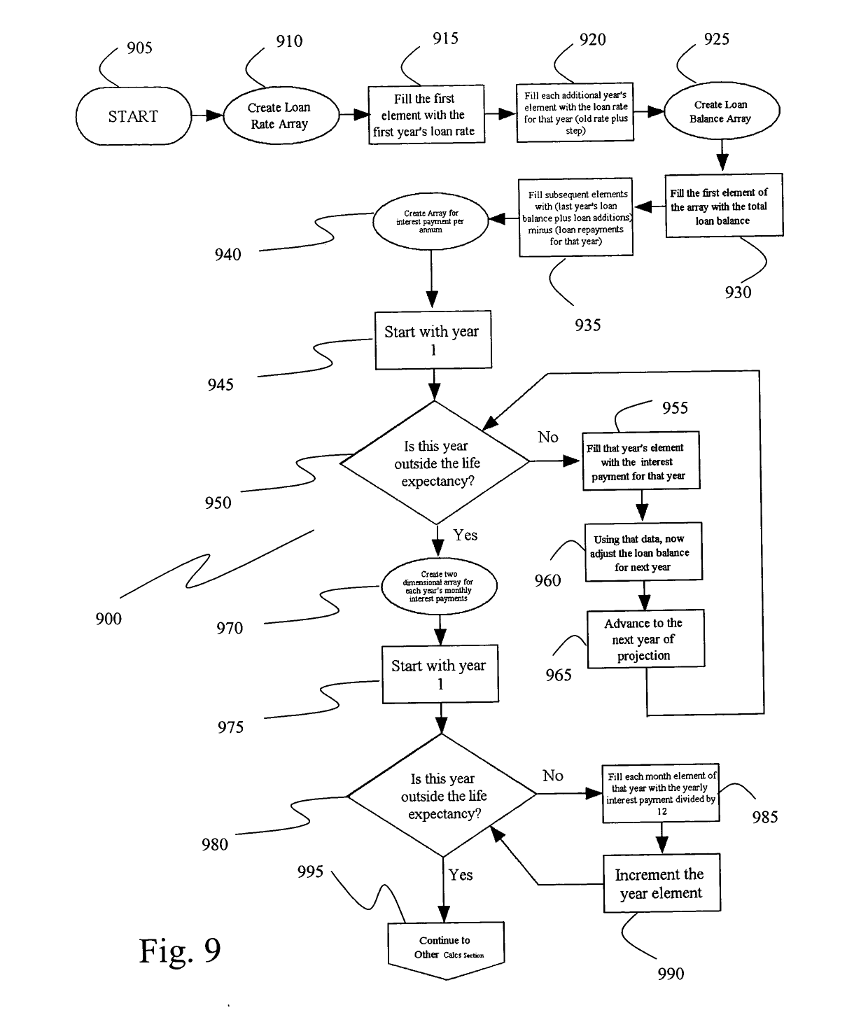

Calculation mode A continues with loan calculations 900, as illustrated in FIG. 9, which are now described. Beginning with step 905, the application creates an array (step 910) to hold the rate for the loan for each of the years of the projection. The first element in this array is filled (step 915) by the user provided assumed rate. Each subsequent element in this array is filled (step 920) by placing in it the loan rate from the previous year, plus any loan rate step amount, if the loan is a variable interest rate loan.

The application then creates an array (step 925) with the same number of elements as there are years in the projection. This array will be filled with the loan balance in each of the corresponding years of the loan. The first element in this array is populated by the total loan balance (step 930). Subsequent elements are filled in during step 935 by adding the loan balance for the current year to the loan additions for that year, and then subtracting the loan repayments and the loan interest for that year from that.

The loan interest payments for each year are calculated next. This is done by creating an array (step 940) with elements corresponding to the number of years in the term of the project. The application then starts at year 1 of the project (step 945). It determines if the current year is outside the client's life expectancy at step 950. If the year is not outside the client's life expectancy, the application then populates the array elements with the interest payment for that year (step 955) Using that data, the application adjusts the loan balance for the next year (step 960). The application then advances to the next year of the projection (step 965). This loop that begins at 950 continues until each year of the projection has been filled in the array.

When the application at step 950 determines that the year is outside the client's life expectancy, the application, in step 970, then creates a two-dimensional array with elements for year and month. The application starts with year 1 (step 975), and determines whether that year is outside the client's life expectancy (step 980). If it is not, the application fills in the corresponding elements (step 985) for each month with the monthly interest payment derived by dividing the loan's interest payment per year by 12. The application increments the year element (step 990), and returns to step 980 to continue the loop to repeat the filling of the array for the second year and subsequent years, until it reaches the end of the projected term (when the projected term is outside the life expectancy).

Next, in an unillustrated step, the loan term is derived from the projected premium financing period, which is a function of the projected years the client has to live.

The application then goes on to (through step 995) perform other calculations as explained below.

6. Other Calculations Section

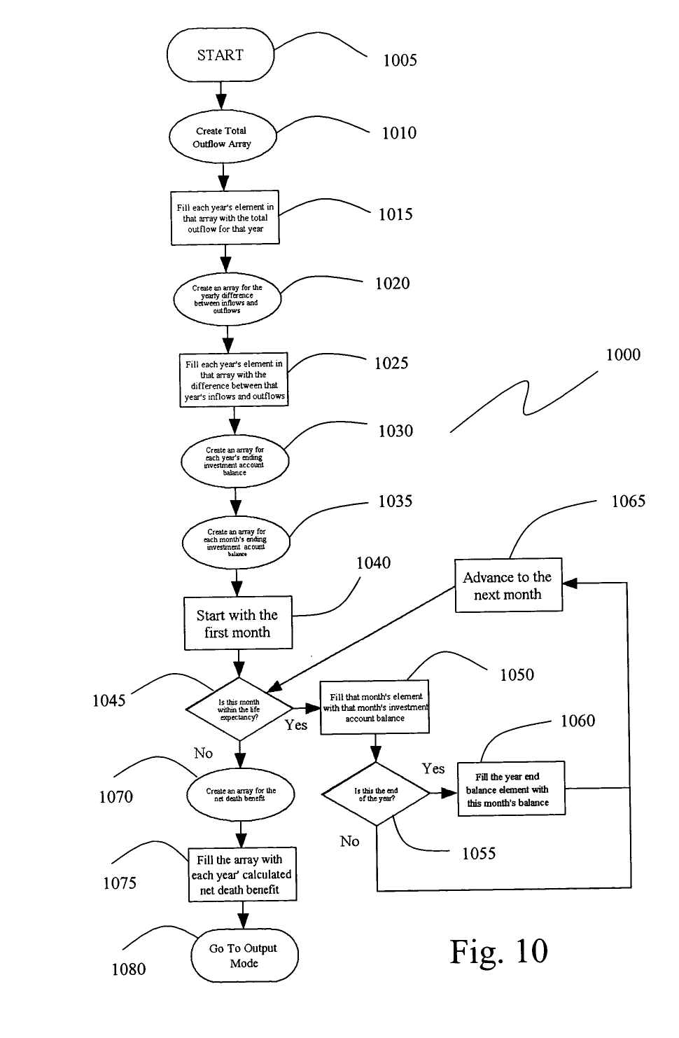

Calculation mode A then performs the other calculations 1000 as illustrated in FIG. 10. Starting with step 1005, the application creates an array (step 1010) with a number of elements corresponding to the number of years in the projected term to hold the total yearly outflow. The application then fills each array element (step 1015) with the corresponding total outflow for that year by adding the tax on the annuity income for that year with the total premiums for that year and then adding that to the loan interest payment for that year. This quantity is placed in the element of the array and represents the total outflow for that year.

The application now calculates the total difference between inflows and outflows. It does this by creating an array (step 1020) of elements corresponding to the amount of years in the projected term. It then fills each element in the array (step 1025) with the difference between total inflow and outflows. It does this by subtracting the corresponding year's outflows from the year's inflows, and storing the difference in the array created.

The application then creates an array (1030) with a corresponding amount of elements to the amount of years in the projected life term, and also creates an array (step 1035) of elements with 12 times the amount of elements as the projected life term to represent the amount of months in the projected term. Starting with the first month (step 1040), the application verifies that the month is within the life expectancy of the client (step 1045). If it is, the array element representing that month of the term is then filled (step 1050) with the investment amount plus the client's contribution for that year. The application then checks whether it is at the end of a year (step 1055). If it is not, the application advances to the next month (step 1065) and continues through the loop which begins at step 1045. When if at step 1055, the application determines that it is at the end of the year, the amount entered into the twelfth month's element is also entered into the yearly array to represent the end-of-year investment account balance (step 1060). The application then goes to step 1065, then step 1045 where it determines that the month is not within the life expectancy.

Next, the application creates an array (step 1070) that contains the same amount of elements as the number of years in the projected life term. This array will hold the client's net death benefit. Each element of the array is then populated (step 1075) with the new insurance to the estate plus that year's investment account ending balance, minus the life insurance pre-pay penalty for that year.

The program now has completed calculation mode A 400, and goes on (step 1080) to output mode 2300.

Calculation Mode PsuedoCode

If currentMode = CalcModeA
Then
BEGIN CALCULATION MODE A
<Optionally display to user something to indicate initial processing is
underway>

Initial Calculation Section

<LifeExpextancy CS·LE=100−ClientAge CS·AGE>

This is variable is used to calculate the years to project the model out (in this example to the age of 100, however it can be a different number to benefit the needs of the financial professional). This variable ClientAge is passed to this by the INPUT MODE

<array BaseCaseAge=newArray[LifeExpectancy]

This creates an array of as many elements as there are years left in client's life expectancy.

For YearOfProjection = 1; YearOfProjection <= LifeExpectancy;
YearOfProjection++

<BaseCaseAge[YearOfProjection − ArrayOffset] = ClientAge −
1+YearOfProjection>

END FOR

This section populates each element of array BaseCaseAge with the age of the client in that projected year.

<array LifeInsurancePolicy[ ][ ] = new array[TotalNumberOfLifeInsurancePolicies][3]>
For countX = 1; count x <= TotalNumberOfLifeInsurancePolicies; countX++;

LifeInsurancePolicy[countX − ArrayOffset][0] = InsurancePolicyName(x)
LifeInsurancePolicy[countX − ArrayOffset][1] = LifeInsurancePremium(x)
LifeInsurancePolicy[countX − ArrayOffset][2] = LifeInsuranceCoverage(x)

END FOR

This section creates a 2 dimensional array that contains the life insurance policy provider's name, that life insurance policy's premium amount, and the coverage the life insurance policy provides. The FOR loop would populate the fields based on the three fields for each policy field passed from the input section. TotalNumberOfLifeInsurancePolicies, InsurancePolicyName, LifeInsurance Premium, and LifeInsuranceCoverage are passed to this by the INPUT MODE.

if ArePremiumsLumpSum = True
Then

TotalPremiumsTemp = 0;
<For count2 = 1; count2 <= TotalNumberOfLifeInsurancePolicies;
count2++>

TotalPremiumsTemp = TotalPremiumsTemp +
LifeInsurancePolicy[count2 − ArrayOffset][1]

END FOR

array TotalPremiums[ ] = new Array [LifeExpectancy]
TotalPremiums[1 − ArrayOffset] = TotalPremiumsTemp
For countf = 2; countf <= LifeExpectancy; countf++

TotalPremiums[countf − ArrayOffset] = 0;

END FOR

Count2 will be used to traverse array LifeInsurancePolicy[] []Premiums's elements to total them into TotalPremiumsTemp. Because this has been indicated to be a single pay insurance plan, the total amount of the insurance is entered into the first year, and the remaining years are filled with zero. This is the amount of payment for those years. TotalNumberOfPremiums is passed to this by INPUT MODE. ArePremiumsLumpSum is a flag that is passed from the INPUT MODE/

Else
For countq = 1; countq <= TotalNumberOfLifeInsurancePolicies;
countq++

TotalPremiumsTemp = TotalPremiumsTemp +
LifeInsurancePolicy[countq − ArrayOffset][1]

END FOR
Array TotalPremiums[ ] = new Array[LifeExpectancy]
For countu = 1; countu <= LifeExpectancy; countu++

TotalPremiums[countu − ArrayOffset] = TotalPremiumsTemp

END FOR

Countq will be used to traverse array LifeInsurancePolicy[ ] [ ]Premiums's elements to total them into TotalPremiumsTemp. Because this has been indicated to be a annual pay insurance plan, the amount of the insurance is assumed to be entered in annual payment form and therefore this amount is entered into each year of the client's life expectancy. This is the amount of payment for those years. TotalNumberOfPremiums is passed to this by INPUT MODE. ArePremiumsLumpSum is a flag that is passed from the INPUT MODE.

END IF
<array ReportingInsurancePremium[ ] = new array[LifeExpectancy]
For count3 = 1; count3 <= LifeExpectancy; count3++

ReportingInsurancePremium[count3 − ArrayOffset] = TotalPremiums

END FOR

This sets each element corresponding to the projection year in array ReportingInsurancePremium to amount TotalPremiums.

For count4 = 1; count4 <= TotalNumberOfLifeInsurancePolicies;
count4++

TotalNewCoverage = TotalNewCoverage +
LifeInsurancePolicy[count4 − ArrayOffset][2]

END FOR

This adds the total amount of coverage from each policy (contained in LifeInsurancePolicy[x] [2]) to get the total coverage of all policies. TotalNumberOfLifeInsurancePolicies is passed to this by the INPUT MODE. LifeInsurancePolicy[ ] [ ] is passed to this by the INITIAL CALCULATION SECTION.

<SPIALoan=TotalDeposit−LifeSettlement−SPIADumpIn>

This calculates the SPIA loan needed. Total Deposit is passed in from THIS SECTION. LifeSettlement and SPIADumpIn are passed in from the INPUT SECTION.

<TotalDeposit=SPIALoan−TotalPremiums−InvestmentAmount−LifeSettlement−SPIADumpIn>

This calculates the total deposit. Investment Amount, SPIADumpIn, and LifeSettlement are passed to this from the INPUT SECTION. TotalPremiums is passed in from INITIAL CALCULATION SECTION.

<BIGLoanAmount=TotalPremiums+TotalSPIADeposits+InvestmentAmount>

This calculates the LoanAmount. TotalPremiums is calculated in THIS SECTION.

<NewInsurancetoEstate=TotalNewCoverage−LoanAmount>

Calculate the new life insurance to the estate. TotalNewCoverage and LoanAmount are calculated in THIS SECTION.

<TotalSourcesOfFunds=BIGLoanAmount+LifeSettlement+SPIADumpIn+OtherSources>

This calculates the total sources of funds for the SPIA. LoanAmount is calculated in THIS SECTION. LifeSettlement, SPIADumpIn, and OtherSources are passed to this by INPUT MODE.

<TotalUses=TotalPremiums+TotalSPIADeposits+InvestmentAmount>

This calculate the total uses for the money.

SPIA Calculation Section

<Optionally display to user something to indicate SPIA calculation is underway>

<SPIAAnnualizedPayment=TotalDeposit*SPIAOfferRate>

This calculates the SPIA annualized payment.

<SPIAGrossMonthlyPayment=SPIAAnualizedPayment/12>

This calculates the SPIA gross monthly payment.

<SPIAAnnNetPayDuringExclusion=SPIAAnnualizedPayment−(SPIAAnualizedpayment*(1−SPIAExclusionRatio)*ClientTaxRate>

This calculates the SPIA net payment during the exclusionary period. SPIAExclusionRatio and ClientTaxRate are passed to this from the INPUT SECTION.

<SPIAAnnNetPayAfterExculsion=SPIAAnnualizedPayment−(SPIAAnnualizedPayment*ClientTaxRate)>

This calculates the SPIA net payment after the exclusionary period. ClientTaxRate is passed to this from the INPUT SECTION.

<SPIANetMonthyDuringExclusion=SPIAAnnNetPayDuringExclusion/12>

This calculates the monthly amount during the exclusionary period.

<SPIANetMonthlyAfterExclusion=SPIAAnNetPayAfterExclusion/12>

This calculates the monthly amount after the exclusionary period.

Other Inflows Calculation

<Optionally display to user something to indicate Other Inflows calculation is underway>

If SingleClientContribution=True Then

SingleClientContribution Boolean flag is passed in from INPUT MODE

array ClientContributionArray[ ] = new array[LifeExpectancy]
For countY = 1; countY <= LifeExpectancy; county++

If county = 1
Then ClientContributionArray[1 − ArrayOffset] = ClientContrib
Else ClientContributionArray[LifeExpectancy − ArrayOffset] = 0
END IF

END FOR

If the client is to make a single contribution, then create an array with same number of elements as the years in the client's projected life expectancy, then populate the first element with the total amount of the client's contribution, and fill the rest of the array elements with zeroes. ClentContrib, LifeExpectancy, and OtherCashOutlay are passed to this by the INPUT SECTION.

Else

array ClientContributionArray[ ] = new array[LifeExpectancy]
For count5 = 1; count5 <= LifeExpectancy; count5++

ClientContributionArray[count5−ArrayOffset] = ClientContrib +
OtherCashOutlay

END FOR

END IF

This creates an array with the same number of elements as there are years in the client's life expectancy, and then place the client's contribution and other annual cash outlays into the array.

TotalInflows = new array[LifeExpectancy]
For count6 = 1; count6 <= LifeExpectancy; LifeExpectancy++

TotalInflows[count6 − ArrayOffset] = SPIAAnnualizedPayment +
ClientContributionArray[count6 − ArrayOffset]

END FOR

This creates an array of total income inflows with one element for each year of the projected life expectancy. It then populates the array with the total of the SPIA Annualized Payments plus any other annual cash outlays that the client will contribute. SPIAAnnualizedPayment is passed in from the SPIA CALCULATION SECTION. ClientContributionArray is passed in from THIS SECTION.

Outflow Calculation Section

<Optionally display to user something to indicate Outflow
calculation is underway>
TaxOnAnnuitylincome = new array[LifeExpectancy]

For count7 = 1; count7 <= LifeExpectancy; count 7++
TaxOnAnuityIncome[count7 − ArrayOffset] =
SPIAAnnualizedPayment * (1 − SPIAExclusionRatio) *
ClientTaxRate

END FOR

This creates an array of taxes on the annuity income with an array element for each year of the client's projected life expectancy. It then populates the array with the projected tax for each year on the annuity income. LifeExpectancy is passed in from the INITIAL CALCULATION SECTION. SPIAAnnualizedPayment and SPIAExclusionRatio are passed in from INPUT SECTION.

Loan Calculations Section

<Optionally display to user something to indicate Loan calculation
is underway>
<LoanRate[ ] = new array[LifeExpectancy]
<LoanRate[1−ArrayOffset] = SourceOf FundsAssumedRate>
For count 8 = 2; count8 <= LifeExpectancy; count8++

LoanRate[count8 − ArrayOffset] = LoanRate[count8 − 2] +
SourceOfFundsStep
END FOR

This creates an array with the same number of elements as the projected life expectancy of the client. Then this populates the first element of the array with the assumed interest rate of the loan. The second through last elements in the array are then populated by the rates for those years, adjusting the interest rate by a step if the loan is an adjustable rate loan.

SourceOfFundsAssumedRate and SourceOfFundsStep are passed in from the INPUT SECTION. LifeExpectancy is passed in from the INITIAL CALCULATIONS SECTION.

<LoanBalance[ ] = new array[LifeExpectancy]>
for countd = 1; countd <= LifeExpectancy; countd++

LoanBalance[countd − ArrayOffset] = BIGLoanAmount;

This creates an array with the same number of elements as the client's projected life expectancy and then fills the array with the balance of the loan, which is always the total amount of the loan.

<array LoanIntPayPerAnnum = new array[LifeExpectancy]
For count9 = 1; count9 <= LifeExpectancy; count9++

LoanIntPayPerAnnum[count9 − ArrayOffset] = LoanRate[count9−ArrayOffset] *
LoanBalance[count9 − ArrayOffset]
LoanBalance[count9] = LoanBalance[count9 − ArrayOffset] +
LoanAdditions[count9 −ArrayOffset] − LoanRepayments[count9 − ArrayOffset] −
LoanIntPayPerAnnum[count9 − ArrayOffset]

This creates an array for the per annum loan interest payment with an element for each year of the projected life expectancy of the client. It then populates the array with the amount which is equal to the loan's interest rate for that year multiplied by the loan balance for that year. Then the Loan balance for the next year is calculated by taking the loan balance from this year, adding any loan addition, and subtracting any loan repayments and loan interest paid per annum. That way, when the for loop executes next time, it will use the updated loan balance for the calculations. LifeExpectancy is passed in from the INPUT SECTION. All other variables are passed in from THIS SECTION.

<array MonthlyIntPay[ ] [ ] = new array [LifeExpectancy][12]>
<YearCounter = 0
While (YearCounter != & !> LifeExpectancy)

For MonthCounter = 1; MonthCounter <= 12; MonthCounter++

MontlyIntPay[YearCounter][MonthCounter] =
(LoanIntPayPerAnnum[YearCounter]/12)

END FOR

YearCounter++
END WHILE

This creates a two dimensional array to with an element for each month of each year in which to store the monthly interest payment. The year counter starts at 0 (which is the first year in the array and then proceeds to cycle through months 1 thru 12 of that year filling the array with the calculated monthly interest payments. LifeExpectancy is passed in from INITIAL CALCULATIONS SECTION.

Other Calculations

<Optionally display to user something to indicate Other calculations are underway>
<array TotalOutflow[ ] = new array[LifeExpectancy]
<For count10 = 1; count10 <= LifeExpectancy; count10++>

Total Outflow[count10 − ArrayOffset] = TaxOnAnnuityIncome[count10 −
ArrayOffset] + TotalPremiums + LoanIntPayPerAnnum[count10 − ArrayOffset]

END FOR

This creates an array to hold the total outflow of assets and contains an element for each year of the projected life expectancy of the client. The array is then populated by the total of the taxes on the annuity income for that year, the total life insurance premiums for the year, and the loan interest payments per annum for that year. LifeExpectancy and TotalPremiums are passed in from INITIAL CALCULATIONS. TaxOnAnnuityIncome is passed in from OUTFLOW CALCULATION SECTION.

<array TotalInflowOutflowDifference[ ] = new array[TotalYears]>
For count11 = 1; count11 <= LifeExpectancy; count11++

TotalInflowOutflowDifference[count11 − ArrayOffset] =
TotalInflow[count11 − ArrayOffset] − TotalOutflow[count11 −
ArrayOffset]

END FOR

This creates an array for the net difference between all inflows and outflows and creates an array element for each year of the projected life expectancy plus the grace, and the extra years. It then fills the elements with the total difference between inflows and outflows for each year projected until the end of the grace period. LifeExpectancy is passed in from INITIAL CALCULATIONS SECTION.

<YearEndInvAccountBalance[ ] = new array[LifeExpectancy]>
<InvestmentAccountBalance[ ] = new array[LifeExpectancy*12]>
<InvestmentAccountBalance[1 − ArrayOffset] = InvestmentAmount +
ClientContributionArray[1 − ArrayOffset]
For count12 = 2; count12 <= )LifeExpectancy*12); count12++

InvestmentAccountBalance[count12 − ArrayOffest] =
InvestmentAccountBalance[count12 − 2] * (1 + AssumedYield/12) −
IntPay[count12 − 2]

If(count12 mod 12 = 0)
Then

YearEndInvAccountBalance[(count12/12) − 1] =
InvestmentAccountBalance[count12 − ArrayOffset]

END IF

END FOR

This creates an array to contain the monthly balance of the investment account. The first month's balance is then set to the client's first year contribution total. After this, the array is filled with the monthly balances of the investment account based upon the total of the last month's investment account balance, multiplied by (1 plus the monthly assumed yield divided by 12) minus last month's interest payment. If the month is divisible evenly by 12 (the modulus operator), then it is the end of the year so the end of the year investment account balance is recorded in YearEndInvAccountBalance[ ] for later use. LifeExpectancy is passed in from the INITIAL CALCULATIONS SECTION.

<array NetDeathBenefit = new array[LifeExpectancy]>
For count 13 = 1; count13 <= LifeExpectancy; count13++

NetDeathBenefit[count13 − ArrayOffset] = NewInsuranceToEstate +
YearEndInvAccountBalance[count13 − ArrayOffset]

This creates an array with elements for the net death benefit for the client and the array contains an element for each year of the client's projected life expectancy. The array is then populated by the net death benefit for each year based upon the amount of new insurance to the estate, plus that year's ending balance of the investment account. LifeExpectancy and NewInsuranceToEstate are passed in from the INITIAL CALCULATIONS SECTION. YearEndInvAccountBalance is passed in from THIS SECTION.

<previousMode=“A”>

This sets the flag so that Ouput mode knows how long the arrays passed to it are.

<currentMode=OutputMode>

This sets the mode flag to Output mode so that the next part will execute. <Optionally display to user something to indicate calculations are complete>

GOTO OUTPUT MODE

END CALCULATON MODE A

B. Detailed Description of Calculation Mode B

The second of three calculation modes that the user has the option of choosing is calculation mode B 415, as illustrated in FIG. 4B, which is now generally described. The calculation mode begins (step 420). The application first processes the initial calculations 1100, then SPIA calculations 1200, then processes other inflows calculations 1300, then outflow calculations 1400, then loan calculations 1500, and finally other calculations 1600. This information is then transmitted to output mode 2300 via step 425. In calculation mode B, a reinsurance carrier will repay total outstanding loan balance and fund future SPIA payments required to keep the policy in-force. The application utilizes calculation mode B in the manner elucidated below.

1. Initial Calculations

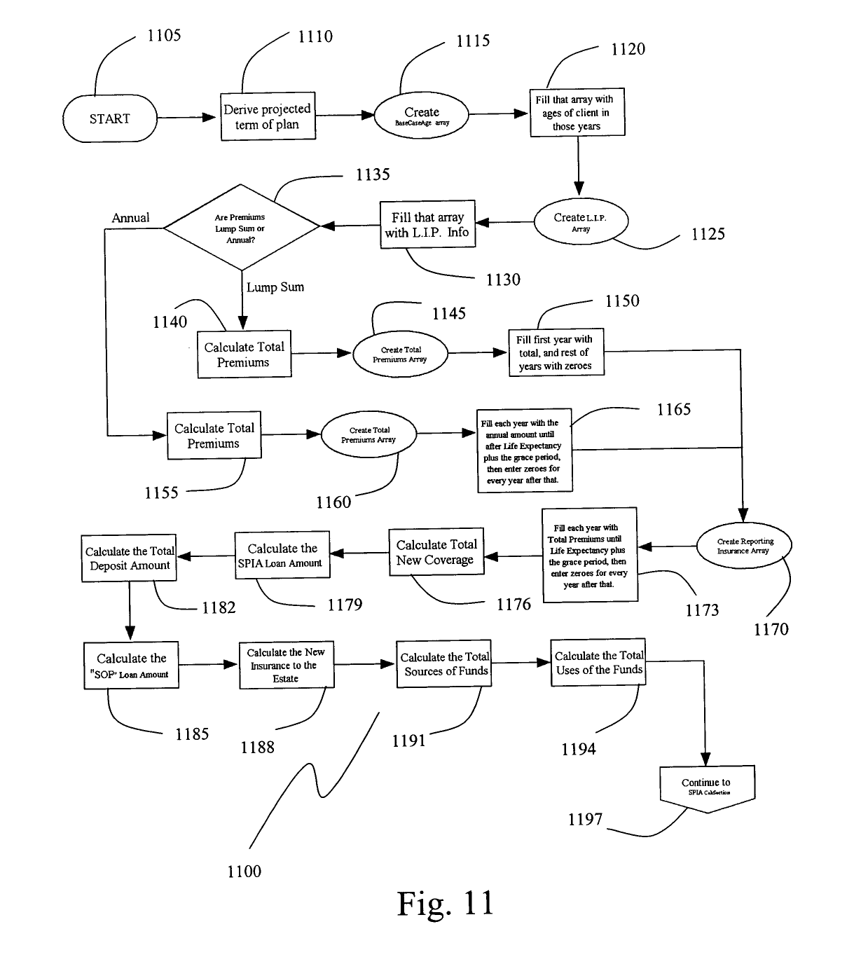

The calculation mode B 415 begins with initial calculations 1100 as illustrated by FIG. 11. Initial calculations 1100 begin at step 11 05. The application first derives the projected term for the premium financing plan (step 1110). This is accomplished by adding the client's projected life expectancy to their present age, plus a “grace period” ranging from one to fifteen years, and also adding a term beyond this grace period to accommodate the client who outlives the expected term, and thereby necessitates array elements showing the effect of the reinsurance policy on the variables concerning this financial plan. This number gives an estimate of the amount of years the client has left to live, and therefore the amount of years the SPIA is to successfully carry out its goals, and also will accommodate financial data showing the effect of the reinsurance policy on the client. The application then creates an array (step 1115) with an element for each year of the client's future projected lifetime plus a grace period and a term of years beyond the grace period to accommodate a client who outlives their projected life expectancy, and fills that array with what age the client will be in that projected year (step 1120).

The application then generates an array (step 1125) and fills it with data in step 1130, such as the names, premiums, and coverage amounts of all life insurance policies on the client based on the data that was supplied by the user.

The application then checks whether the life insurance policies are lump sum or annual (step 1135). If the life insurance policy is annual, the application calculates the total premiums (step 1155). The application then creates a total premiums array (step 1160). Each year in the array is filled with the annual amount (step 1165). If the life insurance policy is lump sum, the application calculates the total premiums (step 1140). The application then creates a total premiums array (step 1145). The first year is filled with the total payment, and the rest of the years in the array are filled with zeros (step 1150). The application calculates (through steps 1140 and 1155) the total of all life insurance premiums to be paid by adding together all life insurance premiums contained in the array of life insurance information. This is done by traversing the array and adding together all of the premium amounts from each policy. When the traversal reaches the end of the array, the amount in the running total is the total amount of life insurance premiums for all policies. From the end of the client's life expectancy plus the grace period to the outside number of years, the application will now place zeroes into the array indicating insurance premiums, as the reinsurer will now be making all insurance premiums on behalf of the client. Because these premiums are not being paid by the client, the cost to the client for the premium goes to zero, and this is so noted in the insurance premium array.

Next, in an unillustrated step, the application calculates the total cost of reinsurance of the life insurance premiums. This calculation is a function of future premium liabilities and the premium financing term.

The application then creates a reporting insurance array (step 1170) with an element for each year in the client's projected life span, and then places the total life insurance premium amount in each element to represent the amount to be paid each year by the client (step 1173). From the end of the client's life expectancy plus the grace period to the outside number of years, the application will now place zeroes into the array indicating insurance premiums, as the reinsurer will now be making all insurance premiums on behalf of the client. Because these premiums are not being paid by the client, the cost to the client for the premium goes to zero, and this is so noted in the insurance premium array.

Next, the application calculates the total new coverage (step 1176) under the life insurance policies by adding together the amounts of coverage from each of the insurance policies contained in the insurance policy information array created above. The application calculates the SPIA loan needed in step 1179, then calculates the total deposit amount (step 1182). The application next calculates the loan amount (step 1185).

The application calculates the new insurance (step 1188) to the estate by subtracting the loan amount from the total new coverage. The application, in step 1191, calculates the total funds from all sources based upon the user's input of the loan amount and any other sources obtained from the user input fields that correspond to available source funds. The application then calculates the total uses of the funds (step 1194). The application then moves on (step 1197) to perform the SPIA related calculations below.

2. SPIA Calculations

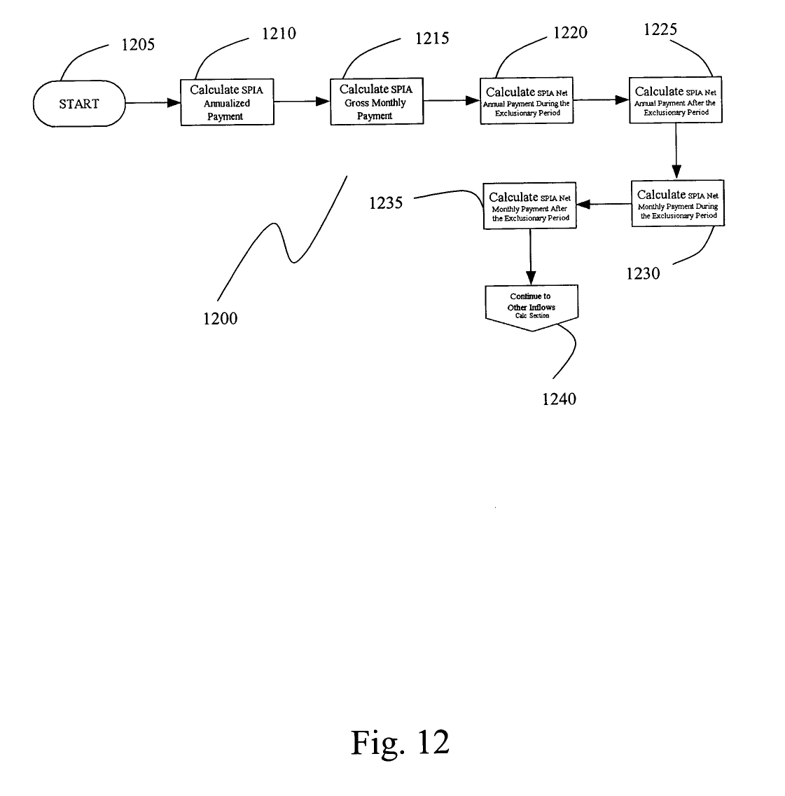

Calculation mode B continues with SPIA calculations mode 1200, as illustrated in FIG. 12, which are now described. The SPIA calculations mode 1200 begins at step 1205. Utilizing total deposit as calculated in step 1182, the application then computes the SPIA annualized payments (step 1210) by multiplying the total deposit amount by the SPIA offer rate. The application next computes the SPIA gross monthly payment amount (step 1215) by dividing the SPIA annualized payments by 12. Next, the application calculates the SPIA annualized net payment during the exclusionary period (step 1220). This is done by subtracting client's tax rate multiplied by the quantity (the SPIA annualized payment multiplied by one minus the SPIA exclusion ratio) from the SPIA annualized payment.

The application then calculates the SPIA annualized net payment after the exclusionary period (step 1225) by subtracting the quantity (the SPIA annualized payment multiplied by the client's tax rate) from the SPIA annualized payment. Next the application computes the SPIA net monthly payment amount during the exclusionary period (step 1230) by dividing the SPIA annualized payment during the exclusionary period by 12. The application then calculates the SPIA net monthly payment amount after exclusion (step 1235) by dividing the SPIA annualized payment after the exclusionary period by 12.

The application then proceeds (step 1240) to calculate other inflows.

3. Other Inflows Calculations

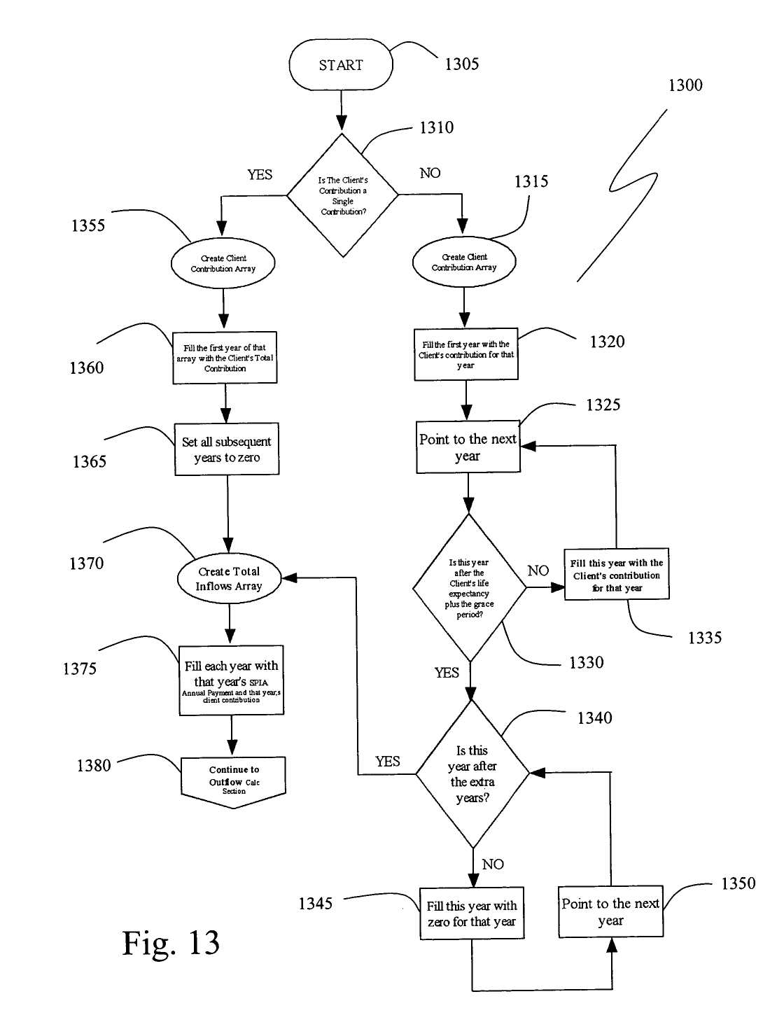

Calculation mode B then performs other inflows calculations 1300, as illustrated in FIG. 13, which are now described. Beginning with step 1305, the application verifies at step 1310 whether the client is going to make a multiple contributions or single contribution. If the client is to make more than one contribution, an array is created (step 1315) with the number of elements corresponding to the number of years in the projection. The contribution by the client for the first year is filled in the array (step 1320). The program then moves to the next year in the array (step 1325). The application then determines if the year is after the client's life expectancy plus grace period (step 1330). If yes, the application moves to step 1340. If the year is not after the client's life expectancy, the application fills the year with the client's contribution for that year (step 1335). The application then proceeds to the loop that begins at step 1325.

If at step 1330 the application determines that the year is after the client's life expectancy plus grace period, the application continues to step 1340. In step 1340, the application determines if the current year being processed is after the extra years. If it is not, the application proceeds to step 1345 where the current year is filled with a zero. The application then proceeds to the next year in step 1350, and returns to start of the loop that begins at step 1340. If at step 1340 the application determines that the year is after the extra years, the application proceeds to step 1370 (described below).

If at step 1310 the application determines that the client is making a single contribution, the application creates an array (step 1355) with the number of elements corresponding to the number of years in the projection plus the grace period and the extra years provided to hold reinsurance effect data. The first element in the array is populated (step 1360) by the total amount of that contribution, and the rest of the elements are filled with the amount 0 (step 1365).

The application arrives at step 1370 through either step 1365 or 1340, where it then calculates the total inflow amounts. It does this by creating an array (step 1370) with the same number of elements as the projected life term, and then in step 1375 populates each element with the SPIA annualized payment plus the amount of the client's contribution for that year. The amounts contained in each element of this array will correspond to the amount of total inflow for that year of the projection.

The application then moves (step 1380) on to perform outflow calculations.

4. Outflow Calculations Section

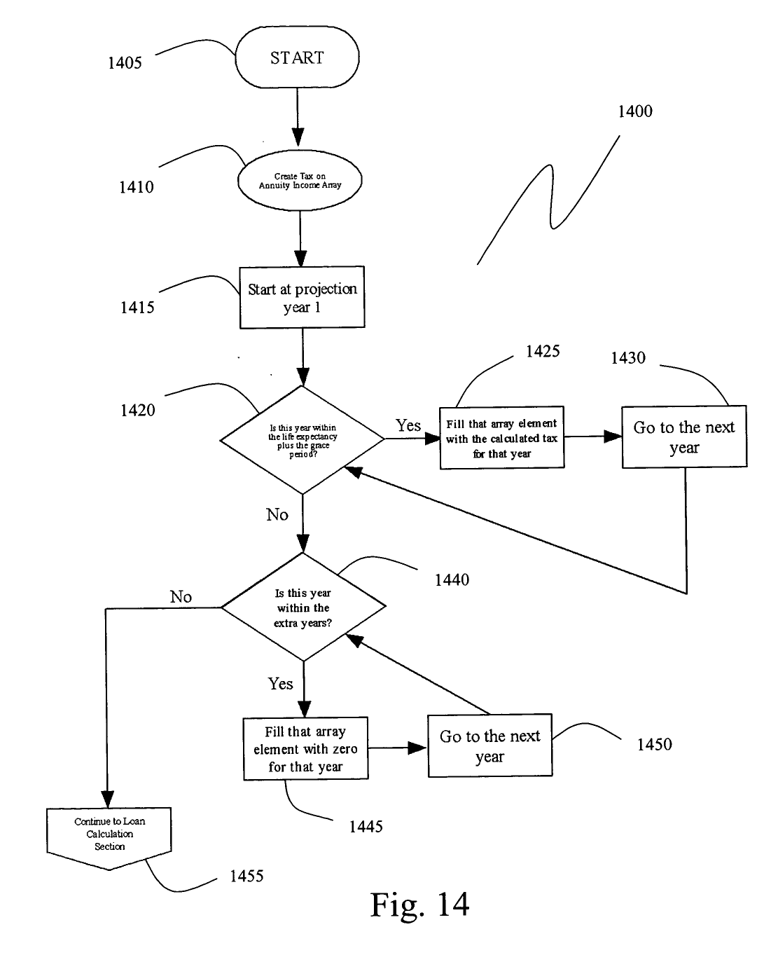

Calculation mode B continues with outflow calculations 1400, as illustrated in FIG. 14, are now described. The application begins (step 1405) this by calculating the tax on the annuity income for each year of the projection. This is done by creating an array (step 1410) with elements corresponding to the amount of years in the projection. The array is then filled beginning at step 1415 by placing in each element the amount of tax on the annuity income. This amount is calculated by multiplying the SPIA annualized income times the client's tax rate, and then multiplying that quantity by one minus the SPIA Exclusion Ratio. Outflow calculations 1400 can also include insurance costs if the insurance premium is paid annually. If the client outlives the life expectancy plus grace period, these outflows go to zero, as there is no tax to be paid on annuity income because all annuity income has been assigned to the reinsurer. Therefore, all elements from the end of the life expectancy to the end of the extra year projections are filled with zeroes. After step 1415, the application proceeds to step 1420, where it checks if the current year being filled in the array is within the life expectancy plus the grace period. If it is, the application proceeds to step 1425, where it fills that array element with the calculated tax for that year. Proceeding to step 1430, the application goes to the beginning of the loop that begins at step 1420.

When at step 1420 the application determines that the year is not within the life expectancy plus the grace period, the application proceeds to step 1440. The application then determines whether the year being processed is within the extra years. If it is, the application continues to step 1445 where the application fills that array element with zero for that year. Proceeding to step 1450, the application continues to the next year. It returns to the loop that begins at step 1440. When at 1440 the application determines that the year being processed is not within the extra years, the program then moves (step 1455) on to perform loan calculations.

5. Loan Calculations Section

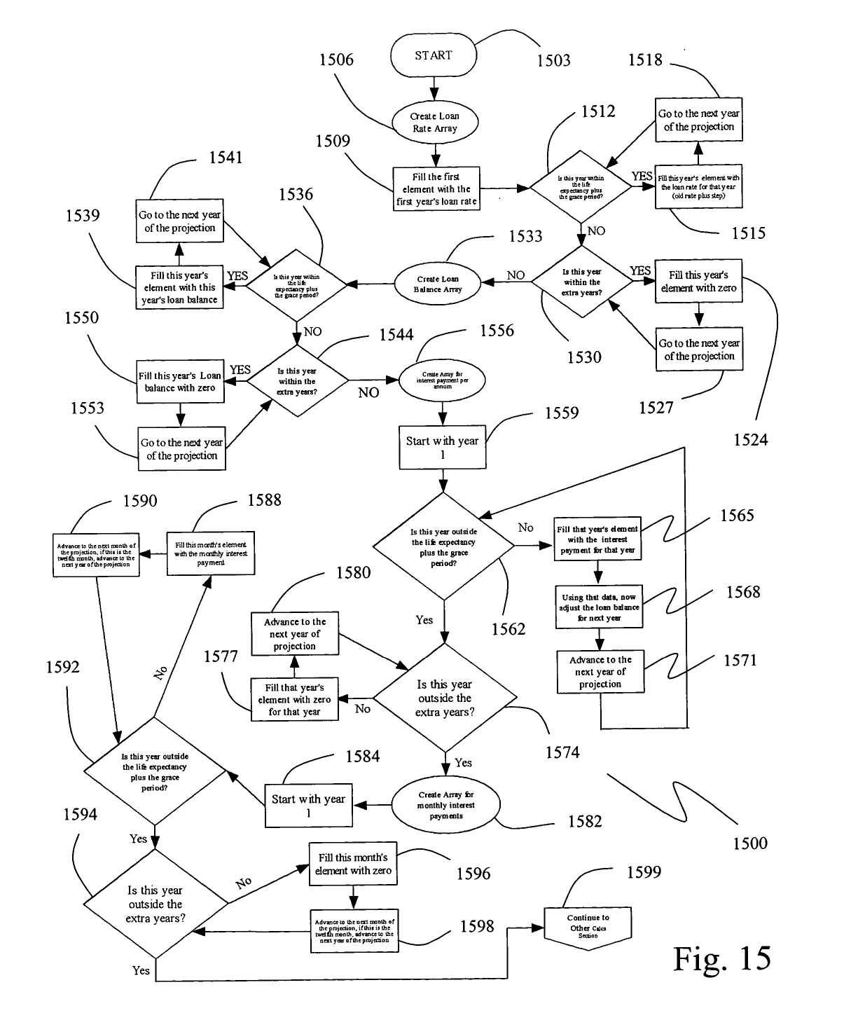

Calculation mode B then continues with loan calculations 1500, as illustrated in FIG. 15, which are now described. Beginning with step 1503, the application creates an array (step 1506) to hold the rate for the loan for each of the years of the projection plus the extra years allowed for the holding of reinsurance effect data. The first element in this array is filled (step 1509) by the user provided assumed rate. At step 1512, the application determines if the year in that element is within the life expectancy plus the grace period. If it is, the application proceeds to step 1515 where it fills this year's element with the loan rate for that year plus any loan rate step amount, if the loan is a variable interest rate loan. The program then continues to step 1518, where it goes to the beginning of the loop that begins at step 1512. If at step 1512 the application determines that the year is not within life expectancy plus grace period, the application proceeds to step 1530. If it determines at step 1530 that the year is within the extra years, it proceeds to step 1524 where it fills this year's element with zero. At step 1527 it goes to the next year position in the array of the projection, returning to the loop that begins at step 1530. If the client outlives the life expectancy plus the grace period, the loan rate then goes to zero as the reinsurer has paid the loan off in full. Because the client no longer pays any interest, and no longer has a loan outstanding, all elements of this array after life expectancy plus grace until the end of the extra projection years are filled with zeroes.

If at step 1530 the year is not within the extra years, the application then creates a loan balance array (step 1533) with the same number of elements as there are years in the projection plus a number of years to take into account the client who outlives the projection, for purposes of handling reinsurance effects to the client. This array will be filled with the loan balance in each of the corresponding years of the loan. The first element in this array is populated by the total loan balance (in an unillustrated step). Subsequent elements are filled by adding the loan balance for the current year to the loan additions for that year, and then subtracting the loan repayments and the loan interest for that year from that. At step 1536, the application determines if the current year is within the life expectancy plus the grace period. If it is, the application fills this year's position in the array with this year's loan balance at step 1539. It then, via step 1541, continues to the next year of the projection and returns to the loop that begins at step 1536. If at step 1536 the application determines that the year is not within the life expectancy plus the grace period, the application proceeds to step 1544 to being filling the rest of the array with zeros. Starting at the year after the client's grace period, the array is filled with zeroes, as the loan will have been paid off by the reinsurer. Because there is no outstanding loan, the client's loan balance goes to zero, and is noted inside the array. The application notes this by determining if the current year is within the extra years (step 1544). If it is, the application proceeds to step 1550 where it fills this year's loan balance with zero. At step 1553 the application proceeds to the next year of the projection, then returns to the beginning of the loop that begins at 1544.

When at step 1544 the application determines that the current year is not within the extra years, the application proceeds to step 1556 where the loan interest payments for each year are calculated. This is done by creating an array (step 1556) with elements corresponding to the number of years in the term of the project. The application starts at year 1 of the project (step 1559). It determines if the current year is outside the client's life expectancy plus the grace period (step 1562). If the year is not outside the client's life expectancy plus grace period, the application then populates the array elements with the interest payment for that year (step 1565). Using that data, the application adjusts the loan balance for the next year (step 1568). The application then advances to the next year of the projection (step 1571). This loop that begins at 1562 continues until each year of the projection has been filled in the array (when at step 1562 the application determines that the current year is outside the life expectancy plus the grace period). Once the projection has been filled, then the number of years outside the projection provided for the client who outlives the projection is filled with zeroes to note that there will be no more interest payments to be made, as the reinsurer has paid off the loan balance. This is accomplished by proceeding to step 1574 from step 1562. The application determines if this year is outside the extra years at step 1574. If it is not, the application fills that year's element with zero for that year at step 1577, then advances to the next year of the projection through step 1580. The application then proceeds to beginning of the loop that begins at step 1574. When at step 1574 the application determines that the year is outside the extra years, the application then proceeds to create a two dimensional array with elements corresponding to the years and months of the projection (step 1582).

The application creates an array for monthly interest payments. Starting with year one, (step 1584), the application determines whether that year is outside the client's life expectancy plus the grace period (step 1592). If it is not, the application fills in the corresponding elements (step 1588) for each month with the monthly interest payment derived by dividing the loan's interest payment per year by 12. The application increments the year element (step 1590), and returns to step 1592 in the loop to repeat the filling of the array for the second year and subsequent years, until it reaches the end of the projected term (when the projected term is outside the life expectancy plus the grace period). At this point, the application moves to step 1594, to being filling the rest of the array with zeroes. This is to note that there will be no more interest payments made by the client because if the client outlives the life expectancy plus the grace period, then the reinsurer will have paid the loan balance in full, thereby obviating the need to make interest payments. The application determines if this year is outside the extra years. If it is not, the application fills this month's element with zero at step 1596. It then advances to the next month of the projection at step 1598. If it is the twelfth month of the year, it advances to the first month of the next year of the projection. It then returns to the beginning of the loop that begins at step 1594. When at step 1594 the application determines that the year is outside the extra years, the application moves to an unillustrated step, where the loan term is derived from the projected premium financing period, which is a function of the projected years the client has to live.

The application then goes on to (through step 1599) perform a few other calculations explained below.

6. Other Calculations Section

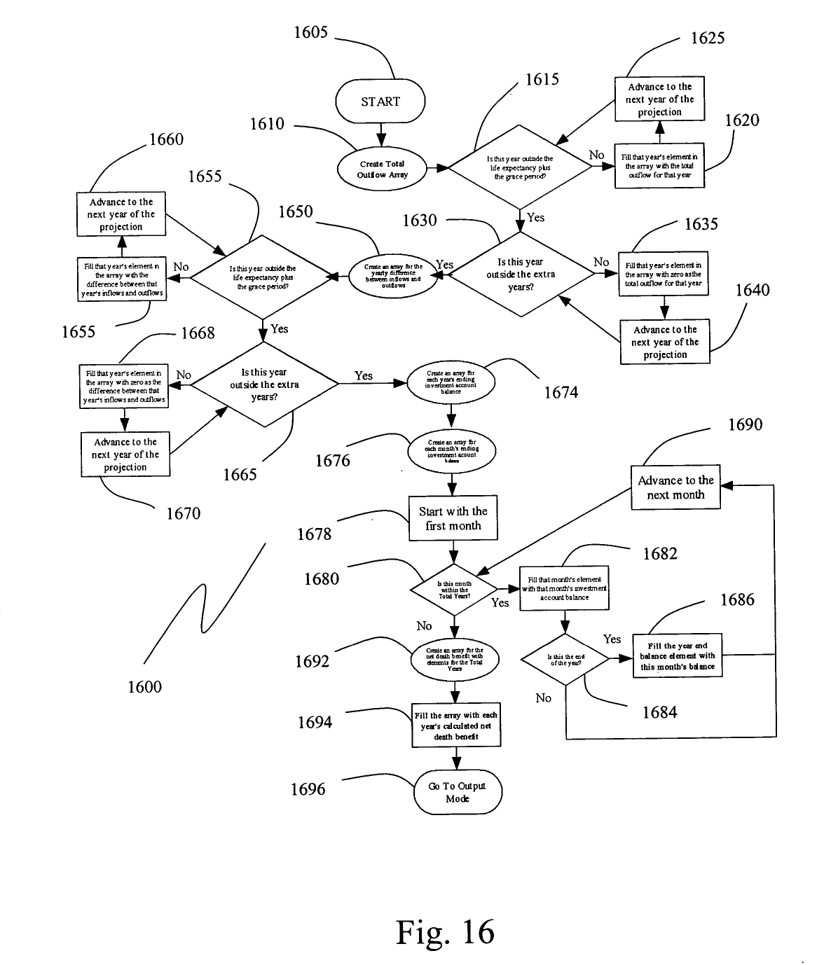

Calculation mode B next performs the other calculations 1600 as illustrated in FIG. 16. Starting with step 1605, the application creates an array (step 1610) with a number of elements corresponding to the number of years in the projected term plus the extra years projected in order to show possible reinsurance effects on the client to hold the total yearly outflow. The application determines whether the current year being processed is outside the life expectancy plus the grace period (step 1615). If it is not, the application proceeds to step 1620 to fill the total outflow for that year. The application then fills each array element with the corresponding total outflow for that year by adding the tax on the annuity income for that year with the total premiums for that year and then adding that to the loan interest payment for that year. This quantity is placed in the element of the array and represents the total outflow for that year. The application then advances to the next year of the projection (step 1625) and returns to the beginning of the loop that begins at step 1615. When at step 1615 the application determines that the year is outside the life expectancy plus the grace period, it proceeds to step 1630, where it determines if the year is outside the extra years. If it is not, the application proceeds to step 1635 where it fills that year's element in the array with zero as the total outflow for that year (step 1635). The application then advances to the next year of the projection (step 1640), and returns to the beginning of the loop that begins at step 1630. When at step 1630 determines that the year is outside the extra years, it advances to step 1650.

The application now calculates the total difference between inflows and outflows. It does this by creating an array (step 1650) of elements corresponding to the amount of years in the projected term plus the extra years projected in order to show possible reinsurance effects on the client. At step 1650 the application determines if the current year being processed is outside the life expectancy plus the grace period. If it is not, the application then fills the element in the array for that year (at step 1655) with the difference between total inflow and outflows. It does this by subtracting the corresponding year's outflows from the year's inflows, and storing the difference in the array created. The application then advances to the next year of the projection (step 1660), then proceeds to the beginning of the loop that starts at step 1655. When at step 1655 the application determines that the year is outside the life expectancy plus the grace period, it proceeds to step 1665, where it determines if the year is outside the extra years. If it is not, the application proceeds to step 1668 where it fills that year's element in the array with zero as the difference between that year's inflows and outflows (step 1668). The application then advances to the next year of the projection (step 1670), and returns to the beginning of the loop that begins at step 1665. When at step 1665 determines that the year is outside the extra years, it advances to step 1674.

The application then creates an array(1674) with a corresponding amount of elements to the amount of years in the projected life term, plus the extra years projected in order to show possible reinsurance effects on the client. It then creates an array (step 1676) of elements with 12 times the amount of elements as the projected life term to represent the amount of months in the projected term. Starting with the first month (step 1678), the application verifies that the month is within the life expectancy of the client (step 1680). If it is, the array element representing that month of the term is then filled (step 1682) with the investment amount plus the client's contribution for that year. The application then checks whether it is at the end of a year (step 1684). If it is not, the application advances to the next month (step 1690) and continues to the beginning of the loop which starts at step 1680. When if at step 1684, the application determines that it is at the end of the year, the amount entered into the twelfth month's element is also entered into the yearly array to represent the end-of-year investment account balance (step 1686). The application then goes to step 1690, then step 1680 where it determines that the month is not within the life expectancy plus grace and the extra years added to allow for possible reinsurance effect data.

When at step 1680 the application determines that the current month being processed is not within the total years, it then creates an array (step 1692) that contains the same amount of elements as the number of years in the projected life term plus the extra years projected in order to show possible reinsurance effects on the client. This array will hold the client's net death benefit. Each element of the array is then populated (step 1694) with the new insurance to the estate plus that year's investment account ending balance, minus the life insurance pre-pay penalty for that year. This shows the death benefit to the client if the client is to expire in corresponding year for which the data in the array represents.

The program now has completed calculation mode B, and advances (step 1696) to the output mode 2300.

Calculation Mode B PsuedoCode

If currentMode = CalcMode B
Then
BEGIN CALCULATION MODE B
<Optionally display to user something to indicate initial processing is
underway>

Initial Calculation Section

<LifeExpextancy CS·LE=100−ClientAge CS·AGE>

<ExtraYears=35>

This is used to calculate the years to project the model out (in this example to the age of 100, however this variable's value can be configured to conform to the financial professional's needs). This variable ClientAge is passed to this by the INPUT MODE. ExtraYears (here set to thirty-five, but variable to any number needed) is a number of years that the clients cannot possibly outlive past the life expectancy plus the grace period. For example, if the client is projected to live to age 85, and there is a grace period of 5 years figured in, this would make the client's total projection 90 years of age. Here is where a reinsurer would take over until the death of the client. For data holding purposes, a buffer of 35 years is provided so that calculations concerning the reinsurance effect on the client can be shown. Because there is little chance of someone living until 125 years old, this amount of years to show the effect on the reinsurer is probably a safe one.

<array BaseCaseAge=newArray[LifeExpectancy+ExtraYears]

<TotalYears=LifeExpectancy+ExtraYears;>

This creates an array of as many elements as there are years left in client's life expectancy plus the amount of extra years that will be used to hold reinsurance effect data for the client.

For YearOfProjection = 1; YearOfProjection <= TotalYears;
YearOfProjection++

<BaseCaseAge[YearOfProjection − ArrayOffset] = ClientAge −
1+YearOfProjection>

END FOR

This section populates each element of array BaseCaseAge with the age of the client in that projected year.

<array LifeInsurancePolicy[ ] [ ] = new array[TotalNumberOfLifeInsurancePolicies][3]>
For countX = 1; count x <= TotalNumberOfLifeInsurancePolicies; countX++;

LifeInsurancePolicy[countX − ArrayOffset][0] = InsurancePolicyName(x)
LifeInsurancePolicy[countX − ArrayOffset][1] = LifeInsurancePremium(x)
LifeInsurancePolicy[countX − ArrayOffset][2] = LifeInsuranceCoverage(x)

END FOR

This section creates a 2 dimensional array that contains the life insurance policy provider's name, that life insurance policy's premium amount, and the coverage the life insurance policy provides. The FOR loop would populate the fields based on the three fields for each policy field passed from the input section. TotalNumberOfLifeInsurancePolicies, InsurancePolicyName, LifeInsurance Premium, and LifeInsuranceCoverage are passed to this by the INPUT MODE.

if ArePremiumsLumpSum = True
Then

<For count2 = 1; count2 <= TotalNumberOfLifeInsurancePolicies;
count2++>

TotalPremiumsTemp = TotalPremiumsTemp +
LifeInsurancePolicy[count2 − ArrayOffset][1]

END FOR

array TotalPremiums[ ] = new Array [TotalYears]
TotalPremiums[1 − ArrayOffset] = TotalPremiumsTemp
For countf = 2; countf <= TotalYears; countf++

TotalPremiums[countf − ArrayOffset] = 0;

END FOR

Count2 will be used to traverse array LifeInsurancePolicy[ ] [ ]'s elements to total them into TotalPremiumsTemp. Because this has been indicated to be a single pay insurance plan, the total amount of the insurance is entered into the first year, and the remaining years are filled with zero. This is the amount of payment for those years. TotalNumberOfPremiums is passed to this by INPUT MODE. ArePremiumsLumpSum is a flag that is passed from the INPUT MODE

```
  For countq = 1; countq <= TotalNumberOfLifeInsurancePolicies;
  countq++
```

TotalPremiumsTemp = TotalPremiumsTemp +
LifeInsurancePolicy[countq − ArrayOffset][1]

```
  END FOR
  Array TotalPremiums[ ] = new Array[TotalYears]
  For countu = 1; countu <= LifeExpectancy; countu++
```

TotalPremiums[countu − ArrayOffset] = TotalPremiumsTemp

```
  END FOR
FOR countz =LifeExpectancy+1; countz <= TotalYears; countz++
  TotalPremiums[countz − ArrayOffset] = 0;
END FOR
```

Countq will be used to traverse array LifeInsurancePolicy[ ] [ ]'s elements to total them into TotalPremiumsTemp. Because this has been indicated to be a annual pay insurance plan, the amount of the insurance is assumed to be entered in annual payment form and therefore this amount is entered into each year of the client's life expectancy. This is the amount of payment for those years. Once the life expectancy has been exceeded, the total premiums are now entered as 0 until the end of the projection because at this point, the reinsurer takes over the premium payments. TotalNumberOfPremiums is passed to this by INPUT MODE. ArePremiumsLumpSum is a flag that is passed from the INPUT MODE.

END IF
<array ReportingInsurancePremium[ ] = new array[TotalYears]
For count3 = 1; count3 <= LifeExpectancy; count3++

ReportingInsurancePremium[count3 − ArrayOffset] = TotalPremiums

END FOR
FOR countq = LifeExpectancy+1; countq <= TotalYears; countq++

ReportingInsurancePremium[countq − ArrayOffset] = 0

END FOR

This sets each element corresponding to the projection year in array ReportingInsurancePremium to amount TotalPremiums. Once the life expectancy plus the grace period has been exceed by the client, the premiums are now set to 0, as the reinsurer is now making the payments.

For count4 = 1; count4 <= TotalNumberOfLifeInsurancePolicies;
count4++

TotalNewCoverage = TotalNewCoverage +
LifeInsurancePolicy[count4 − ArrayOffset][2]

END FOR

This adds the total amount of coverage from each policy (contained in LifeInsurancePolicy[x] [2]) to get the total coverage of all policies. TotalNumberOfLifeInsurancePolicies is passed to this by the INPUT MODE. LifeInsurancePolicy[ ] [ ] is passed to this by the INITIAL CALCULATION SECTION.

<SPIALoan=TotaIDeposit−LifeSettlement−SPIADumpIn>

This calculates the SPIA loan needed. Total Deposit is passed in from THIS SECTION. LifeSettlement and SPLIADumpIn are passed in from the INPUT SECTION.

<TotalDeposit=SPIALoan−TotalPremiums−InvestmentAmount−LifeSettlement−SPIADumpIn>

This calculates the total deposit. Investment Amount, SPIADumpIn, and LifeSettlement are passed to this from the INPUT SECTION. TotalPremiums is passed in from INITIAL CALCULATION SECTION.

<BIGLoanAmount=TotalPremiums+TotalSPIADeposits+InvestmentAmount>

This calculates the LoanAmount. TotalPremiums is calculated in THIS SECTION.

<NewInsurancetoEstate=TotalNewCoverage−LoanAmount>

Calculate the new life insurance to the estate. TotalNewCoverage and LoanAmount are calculated in THIS SECTION.

<TotalSourcesOfFunds=BIGLoanAmount+LifeSettlement+SPIADumpIn+OtherSources>

This calculates the total sources of funds for the SPIA. LoanAmount is calculated in THIS SECTION. LifeSettlement, SPIADumpIn, and OtherSources are passed to this by INPUT MODE.

<TotalUses=TotalPremiums+TotalSPIADeposits+InvestmentAmount>

This calculate the total uses for the money.

SPIA Calculation Section

<Optionally display to user something to indicate SPIA calculation is underway>

<SPIAAnnualizedPayment=TotalDeposit*SPIAOfferRate>

This calculates the SPIA annualized payment.

<SPIAGrossMonthlyPayment=SPIAAnnualizedPayment/12>

This calculates the SPIA gross monthly payment.

<SPIAAnnNetPayDuringExclusion=SPIAAnnualizedPayment−(SPIAAnnualizedPayment*(1−SPIAExclusionRatio)*ClientTaxRate>

This calculates the SPIA net payment during the exclusionary period. SPIAExclusionRatio and ClientTaxRate are passed to this from the INPUT SECTION.

<SPIAAnNetPayAfterExculsion=SPIAAnnualizedPayment−(SPIAAnnualizedPayment *ClientTaxRate)>

This calculates the SPIA net payment after the exclusionary period. ClientTaxRate is passed to this from the INPUT SECTION.

<SPIANetMonthyDuringExclusion=SPIAAnnNetPayDuringExclusion/12>

This calculates the monthly amount during the exclusionary period/

<SPIANetMonthlyAfterExclusion=SPIAAnNetPayAfterExclusion/12>

This calculates the monthly amount after the exclusionary period.

Other Inflows Calculation

<Optionally display to user something to indicate Other inflows
calculation is underway>
If SingleClientContribution = True
Then

SingleClientContribution Boolean flag is passed in from INPUT MODE

array ClientContributionArray[ ] = new array[TotalYears]
For county = 1; county <= TotalYears; county++

If county = 1
Then ClientContributionArray[1 − ArrayOffset] = ClientContrib
Else ClientContributionArray[county− ArrayOffset] = 0
END IF

END FOR

If the client is to make a single contribution, then create an array with same number of elements as the years in the client's projected life expectancy, then populate the first element with the total amount of the client's contribution, and fill the rest of the array elements with zeroes. ClentContrib, LifeExpectancy, and OtherCashOutlay are passed to this by the INPUT SECTION.

Else

array ClientContributionArray[ ] = new array[TotalYears]
For count5 = 1; count5 <= LifeExpectancy; count5++

ClientContributionArray[count5−ArrayOffset] = ClientContrib +
OtherCashOutlay

END FOR
For count6 = LifeExpectancy+1; count6 <= TotalYears; count6++

ClientContributionArray[count6 − ArrayOffset] = 0;

END FOR
END IF

This creates an array with the same number of elements as there are years in the client's life expectancy plus grace, plus the extra years used for reinsurance data placement, and then places the client's contribution and other annual cash outlays into the array. After the projected life expectancy, zeroes are placed into the array to show that after the life expectancy, the client will not be responsible for any future cash outlay or contribution.

TotalInflows = new array[TotalYears]
For count6 = 1; count6 <= LifeExpectancy; count6++

TotalInflows[count6 − ArrayOffset] = SPIAAnnualizedPayment +
ClientContributionArray[count6 − ArrayOffset]

END FOR
For count7 = LifeExpectancy+1; count7 <= TotalYears; count7++

TotalInflows[count7 − ArrayOffset] = 0;

END FOR

This creates an array of total income inflows with one element for each year of the projected life expectancy plus grace, plus the extra years used for reinsurance data placement. It then populates the array with the total of the SPIA Annualized Payments plus any other annual cash outlays that the client will contribute. After the life expectancy plus the grace period, the array is filled with zeroes to show that the total inflows after the life expectancy plus the grace period will go to zero. SPIAAnualizedpayment is passed in from the SPIA CALCULATION SECTION. ClientContributionArray is passed in from THIS SECTION.

Outflow Calculation Section

<Optionally display to user something to indicate Outflow calculation
is underway>
TaxOnAnnuityIncome = new array[TotalYears]

For count7 = 1; count7 <= LifeExpectancy; count7++
TaxOnAnuityIncome[count7 − ArrayOffset] =
SPIAAnnualizedPayment * (1 − SPIAExclusionRatio) *
ClientTaxRate

END FOR
FOR countg = LifeExpectancy+1; countg <= TotalYears; countg++

TaxOnAnnuityIncom[countg − ArrayOffset] = 0;

END FOR

This creates an array of taxes on the annuity income with an array element for each year of the client's projected life expectancy. It then populates the array with the projected tax for each year on the annuity income. Once the life expectancy plus the grace has been outlived by the client, the tax on the annuity income then drops to zero as the annuity income payments have been transferred to the reinsurer. LifeExpectancy is passed in from the INITIAL CALCULATION SECTION.

SPIAAnnualizedpayment and SPIAExclusionRatio are passed in from INPUT SECTION.

Loan Calculations Section

<Optionally display to user something to indicate Loan calculation is
underway>
<LoanRate[ ] = new array[TotalYears]
<LoanRate[1−ArrayOffset] = SourceOf FundsAssumedRate>
For count8 = 2; count8 <= LifeExpectancy; count8++

LoanRate[count8 − ArrayOffset] = LoanRate[count8 − 2] +
SourceOfFundsStep

END FOR
FOR countw = LifeExpectancy+1; countw <= TotalYears; countw++

LoanRate[countw − ArrayOffset] = 0;

END FOR

This creates an array with the same number of elements as the projected life expectancy plus the grace period, plus the extra years used to hold reinsurance's effect on the client data. Then this populates the first element of the array with the assumed interest rate of the loan. The second through the life expectancy plus grace's elements in the array are then populated by the rates for those years, adjusting the interest rate by a step if the loan is an adjustable rate loan. Once the grace period has been outlived by the client, the interest rate goes to zero, as the loan has been paid in full by the reinsurer.

SourceOfFundsAssumedRate and SourceOfFundsStep are passed in from the INPUT SECTION. LifeExpectancy is passed in from the INITIAL CALCULATIONS SECTION.

<LoanBalance[ ] = new array[TotalYears]>
FOR countd = 1; countd <= LifeExpectancy; countd++

LoanBalance[countd − ArrayOffset] = BIGLoanAmount;

END FOR
FOR counth = LifeExpectancy+1; counth <= TotalYears; counth++

LoanBalance[counth − ArrayOffset] = 0;

END FOR

This creates an array with the same number of elements as the client's projected life expectancy and then fills the array with the balance of the loan, which is always the total amount of the loan. Once the life expectancy plus the grace period have been outlived by the client, the loan amount then goes to zero, as the loan has been paid off by the reinsurer. Therefore, all elements from life expectancy until the end of the extra years are filled with zeroes to indicate a zero loan balance.

<array LoanIntPayPerAnnum = new array[TotalYears]
FOR count9 = 1; count9 <= LifeExpectancy; count9++

LoanIntPayPerAnnum[count9 − ArrayOffset] = LoanRate[count9−ArrayOffset] *
LoanBalance[count9 − ArrayOffset]
LoanBalance[count9] = LoanBalance[count9 − ArrayOffset] +
LoanAdditions[count9 − ArrayOffset] − LoanRepayments[count9 − ArrayOffset] −
LoanIntPayPerAnnum[count9 − ArrayOffset]

END FOR
FOR counto = LifeExpectancy+1; counto <= TotalYears; counto++

LoanIntPayPerAnnum[counto − ArrayOffset] = 0;

END FOR

This creates an array for the per annum loan interest payment with an element for each year of the projected life expectancy of the client. It then populates the array with the amount which is equal to the loan's interest rate for that year multiplied by the loan balance for that year. Then the Loan balance for the next year is calculated by taking the loan balance from this year, adding any loan addition, and subtracting any loan repayments and loan interest paid per annum. That way, when the for loop executes next time, it will use the updated loan balance for the calculations. Once the client outlives the life expectancy plus the grace period, the loan interest payment per annum will be zero, as there is no loan balance for which interest accrues as the total balance has been paid off by the reinsurer. Therefore, all elements after life expectancy until the end of the extra years are filled with zeroes.

LifeExpectancy is passed in from the INPUT SECTION. All other variables are passed in from THIS SECTION.

<array MonthlyIntPay[ ][ ] = new array [TotalYears][12]>
<YearCounter = 0
While (YearCounter != & !> LifeExpectancy)

For MonthCounter = 1; MonthCounter <= 12; MonthCounter++

MontlyIntPay[YearCounter][MonthCounter] =
(LoanIntPayPerAnnum[YearCounter]/12)

END FOR

YearCounter++
END WHILE
YearCounter2 = LifeExpectancy;
While (YearCounter2 <= ExtraYears)

For MonthCounter2 = 1; MonthCounter2 <= 12; MonthCounter2++

MonthIntPay[YearCounter][MonthCounter] = 0;

END FOR

YearCounter2++;
END WHILE

This creates a two dimensional array to with an element for each month of each year in which to store the monthly interest payment. The year counter starts at 0 (which is the first year in the array and then proceeds to cycle through months 1 thru 12 of that year filling the array with the calculated monthly interest payments. After life expectancy, the monthly interest payment is set to zero for each month until the end of the projection. TotalYears is passed in from INITIAL CALCULATIONS SECTION.

<Optionally display to user something to indicate Other calculations
are underway>
<array TotalOutflow[ ] = new array[TotalYears]
<For count10 = 1; count10 <= LifeExpectancy; count10++>

TotalOutflow[count10 − ArrayOffset] =
Tax OnAnnuityIncome[count10 − ArrayOffset] + TotalPremiums +
LoanIntPayPerAnnum[count10 − ArrayOffset]

END FOR
<For count11 = LifeExpectancy+1; count11 <= TotalYears; count11++>

TotalOutflow[count11 − ArrayOffset] = 0;

END FOR

This creates an array to hold the total outflow of assets and contains an element for each year of the projected life expectancy of the client, plus the grace period and the extra years that are charted for purposes of holding possible reinsurance effects on the client. The array is then populated by the total of the taxes on the annuity income for that year, the total life insurance premiums for the year, and the loan interest payments per annum for that year. After life expectancy plus grace, all total outflows go to zero. TotalYears and TotalPremiums are passed in from INITIAL CALCULATIONS. TaxOnAnnuityIncome is passed in from OUTFLOW CALCULATION SECTION.

<array TotalInflowOutflowDifference[ ] = new array[TotalYears]>
For count11 = 1; count11 <= LifeExpectancy; count11++

TotalInflowOutflowDifference[count11 − ArrayOffset] =
TotalInflow[count11 − ArrayOffset] − TotalOutflow[count11 −
ArrayOffset]

END FOR
For count12 = LifeExpectancy+1; count12 <= TotalYears; count12++

TotalInflowOutflowDifference[count12 − ArrayOffset] = 0;

END FOR

This creates an array for the net difference between all inflows and outflows and creates an array element for each year of the projected life expectancy, and for the extra years that are charted for purposes of holding possible reinsurance effects on the client. It then fills the elements with the total difference between inflows and outflows for each year projected. It then fills the array elements for all subsequent years after life expectancy plus grace with zeros. TotalYears is passed in from INITIAL CALCULATIONS SECTION.

<YearEndInvAccountBalance[ ] = new array[TotalYears]>
<InvestmentAccountBalance[ ] = new array[TotalYears*12]>
<InvestmentAccountBalance[1 − ArrayOffset] = InvestmentAmount +
ClientContributionArray[1 − ArrayOffset]
For count12 = 2; count12 <= )TotalYears*12); count12++

InvestmentAccountBalance[count12 − ArrayOffest] =
InvestmentAccountBalance[count12 − 2] * (1 + AssumedYield/12) −
IntPay[count12 − 2]

If count12 mod 12 = 0
Then

YearEndInvAccountBalance[(count12/12) − 1] =
InvestmentAccountBalance[count12 − ArrayOffset]

END IF

END FOR

This creates an array to contain the monthly balance of the investment account. The first month's balance is then set to the client's first year contribution total. After this, the array is filled with the monthly balances of the investment account based upon the total of the last month's investment account balance, multiplied by (1 plus the monthly assumed yield divided by 12) minus last month's interest payment. If the month is divisible evenly by 12 (the modulus operator), then it is the end of the year so the end of the year investment account balance is recorded in YearEndInvAccountBalance[ ] for later use. TotalYears is passed in from the INITIAL CALCULATIONS SECTION.

<array NetDeathBenefit = new array[TotalYears]>
For count 13 = 1; count13 <= TotalYears; count13++

NetDeathBenefit[count13 − ArrayOffset] = NewInsuranceToEstate +
YearEndInvAccountBalance[count13 − ArrayOffset]

This creates an array with elements for the net death benefit for the client and the array contains an element for each year of the client's projected life expectancy plus grace period, and for any extra years added to handle the possibility of the client outliving the projection. The array is then populated by the net death benefit for each year based upon the amount of new insurance to the estate, plus that year's ending balance of the investment account. TotalYears and NewInsuranceToEstate are passed in from the INITIAL CALCULATIONS SECTION. YearEndInvAccountBalance is passed in from THIS SECTION.

<previousMode=“B”>

This sets the flag so that the output mode knows how big the arrays to be output are.

<currentMode=OutputMode>

This sets the mode flag to Output mode so that the next part will execute.

<Optionally display to user something to indicate calculations are complete>

GOTO OUTPUT MODE

END CALCULATON MODE B

C. Detailed Description of calculation Mode C

The third of three calculation modes that the user has the option of choosing is calculation mode C 430, as illustrated in FIG. 4C, which is now generally described. The calculation mode begins (step 435). The application first processes the initial calculations 1700, then SPIA calculations 1800, then processes other inflows calculations 1900, then outflow calculations 2000, then loan calculations 2100, and finally other calculations 2200. This information is then transmitted to output mode 2300 via step 440. In calculation mode C, a reinsurance carrier will repay total outstanding loan balance as well as pay the client, while living, their net death benefit. The application utilizes calculation mode C in the manner elucidated below.

1. Initial Calculations

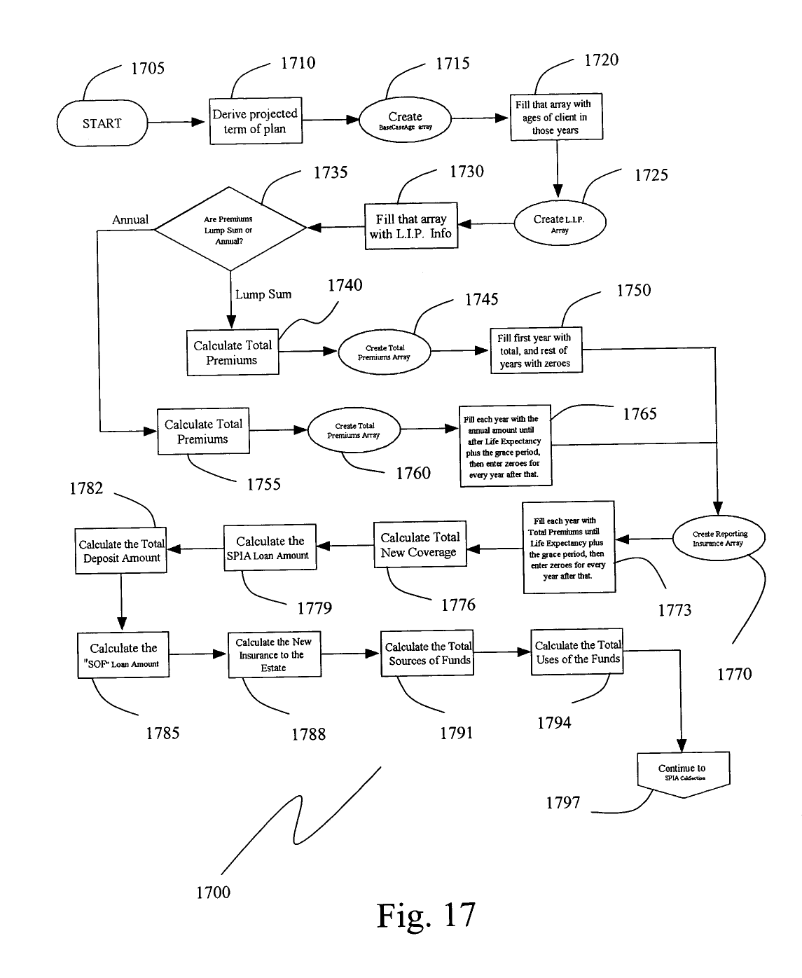

The calculation mode C 430 begins with initial calculations 1700 as illustrated by FIG. 17. Initial calculations 1700 begin at step 1705. The application first derives the projected term for the premium financing plan (step 1710). This is accomplished by adding the client's projected life expectancy to their present age, plus a “grace period” ranging from one to fifteen years, and also adding a term beyond this grace period to accommodate the client who outlives the expected term, and thereby necessitates array elements showing the effect of the reinsurance policy on the variables concerning this financial plan. This number gives an estimate of the amount of years the client has left to live, and therefore the amount of years the SPIA is to successfully carry out its goals, and also will accommodate financial data showing the effect of the reinsurance policy on the client. The application then creates an array (step 1715) with an element for each year of the client's future projected lifetime plus a grace period and a term of years beyond the grace period to accommodate a client who outlives their projected life expectancy, and fills that array with what age the client will be in that projected year (step 1720).

The application then generates an array (step 1725) and fills it with data in step 1730, such as the names, premiums, and coverage amounts of all life insurance policies on the client based on the data that was supplied by the user.

The application then checks whether the life insurance policies are lump sum or annual (step 1735). If the life insurance policy is annual, the application calculates the total premiums (step 1755). The application then creates a total premiums array (step 1760). Each year is filled with the annual amount until after life expectancy plus the grace period, then zeros are entered for every year after that.(step 1765). If at step 1735 the application determines that the life insurance policy is lump sum, the application calculates the total premiums (step 1740). The application then creates a total premiums array (step 1745). The first year is filled with the total payment, and the rest of the years in the array are filled with zeros (step 1750). The application calculates (in steps 1140 and 1155) the total of all life insurance premiums to be paid by adding together all life insurance premiums contained in the array of life insurance information. This is done by traversing the array and adding together all of the premium amounts from each policy. When the traversal reaches the end of the array, the amount in the running total is the total amount of life insurance premiums for all policies. From the end of the client's life expectancy plus the grace period to the outside number of years, the application will now place zeroes into the array indicating insurance premiums, as the reinsurer will now be making all insurance premiums on behalf of the client. Because these premiums are not being paid by the client, the cost to the client for the premium goes to zero, and this is so noted in the insurance premium array.

Next, in an unillustrated step, the application calculates the total cost of reinsurance of the life insurance premiums. This calculation is a function of future premium liabilities and the premium financing term.

The application then creates a reporting insurance array (step 1770) with an element for each year in the client's projected life span, and then places the total life insurance premium amount in each element to represent the amount to be paid each year by the client (step 1173). From the end of the client's life expectancy plus the grace period to the outside number of years, the application will now place zeroes into the array indicating insurance premiums, as the reinsurer will now be making all insurance premiums on behalf of the client. Because these premiums are not being paid by the client, the cost to the client for the premium goes to zero, and this is so noted in the insurance premium array.

Next, the application calculates the total new coverage (step 1776) under the life insurance policies by adding together the amounts of coverage from each of the insurance policies contained in the insurance policy information array created above. The application calculates the SPIA loan needed in step 1779, then calculates the total deposit amount (step 1782). The application next calculates the loan amount (step 1785).

The application calculates the new insurance (step 1788) to the estate by subtracting the loan amount from the total new coverage. The application, in step 1791, then calculates the total funds from all sources based upon the user's input of the loan amount and any other sources obtained from the user input fields that correspond to available source funds. The application then calculates the total uses of the funds (step 1794). The application then moves on (step 1797) to perform the SPIA related calculations below.

2. SPIA Calculations

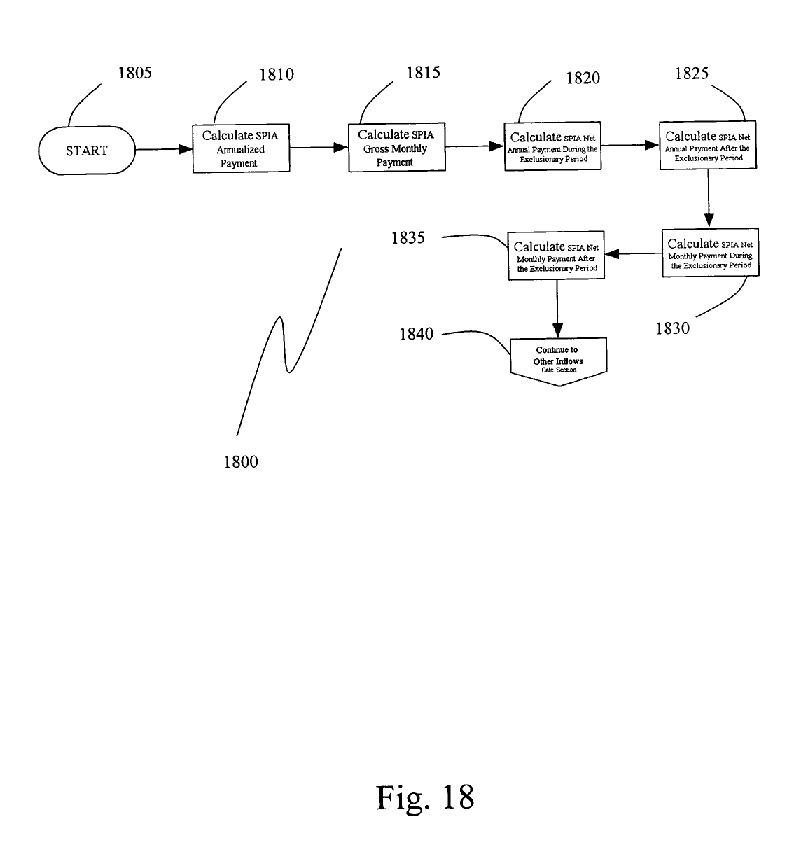

Calculation mode C continues with SPIA calculations mode 1800, as illustrated in FIG. 18, which are now described. The SPIA calculations mode 1800 begins at step 1805. Utilizing total deposit as calculated in step 1782, the application then computes the SPIA annualized payments (step 1810) by multiplying the total deposit amount by the SPIA offer rate. The application next computes the SPIA gross monthly payment amount (step 1815) by dividing the SPIA annualized payments by 12. Next, the application calculates the SPIA annualized net payment during the exclusionary period (step 1820). This is done by subtracting client's tax rate multiplied by the quantity (the SPIA annualized payment multiplied by one minus the SPIA exclusion ratio) from the SPIA annualized payment.

The application then calculates the SPIA annualized net payment after the exclusionary period (step 1825) by subtracting the quantity (the SPIA annualized payment multiplied by the client's tax rate) from the SPIA annualized payment. Next the application computes the SPIA net monthly payment amount during the exclusionary period (step 1830) by dividing the SPIA annualized payment during the exclusionary period by 12. The application then calculates the SPIA net monthly payment amount after exclusion (step 1835) by dividing the SPIA annualized payment after the exclusionary period by 12.

The application then proceeds (step 1840) to calculate other inflows.

3. Other Inflows Calculations

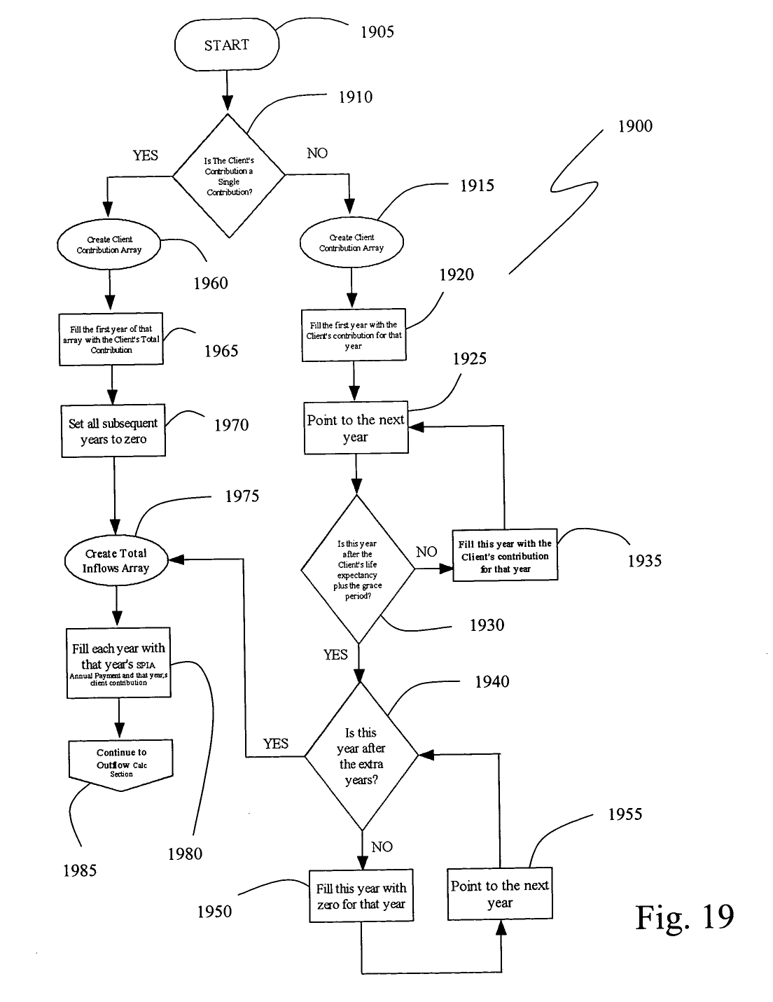

Calculation mode C then performs other inflows calculations 1900, as illustrated in FIG. 19, which are now described. Beginning with step 1905, the application verifies at step 1910 whether the client is going to make a multiple contributions or single contribution. If the client is to make more than one contribution, an array is created (step 1915) with the number of elements corresponding to the number of years in the projection. The contribution by the client for the first year is filled in the array (step 1920). The program then moves to the next year in the array (step 1925). The application then determines if the year is after the client's life expectancy plus grace period (step 1930). If yes, the application moves to step 1940. If the year is not after the client's life expectancy, the application fills the year with the client's contribution for that year (step 1935). The application then proceeds to the loop that begins at step 1925.

If at step 1930 the application determines that the year is after the client's life expectancy plus grace period, the application continues to step 1940. In step 1940, the application determines if the current year being processed is after the extra years. If it is not, the application proceeds to step 1950 where the current year is filled with a zero. The application then proceeds to the next year in step 1955, and returns to start of the loop that begins at step 1940. If at step 1940 the application determines that the year is after the extra years, the application proceeds to step 1975 (described below).

If at step 1910 the application determines that the client is making a single contribution, the application creates an array (step 1960) with the number of elements corresponding to the number of years in the projection plus the grace period and the extra years provided to hold reinsurance effect data. The first element in the array is populated (step 1965) by the total amount of that contribution, and the rest of the elements are filled with the amount 0 (step 1970).

The application arrives at step 1975 through either step 1970 or 1940, where it then calculates the total inflow amounts. It does this by creating an array (step 1975) with the same number of elements as the projected life term, and then in step 1980 populates each element with the SPIA annualized payment plus the amount of the client's contribution for that year. The amounts contained in each element of this array will correspond to the amount of total inflow for that year of the projection.

The application then moves (step 1985) on to perform outflow calculations.

4. Outflow Calculations Section

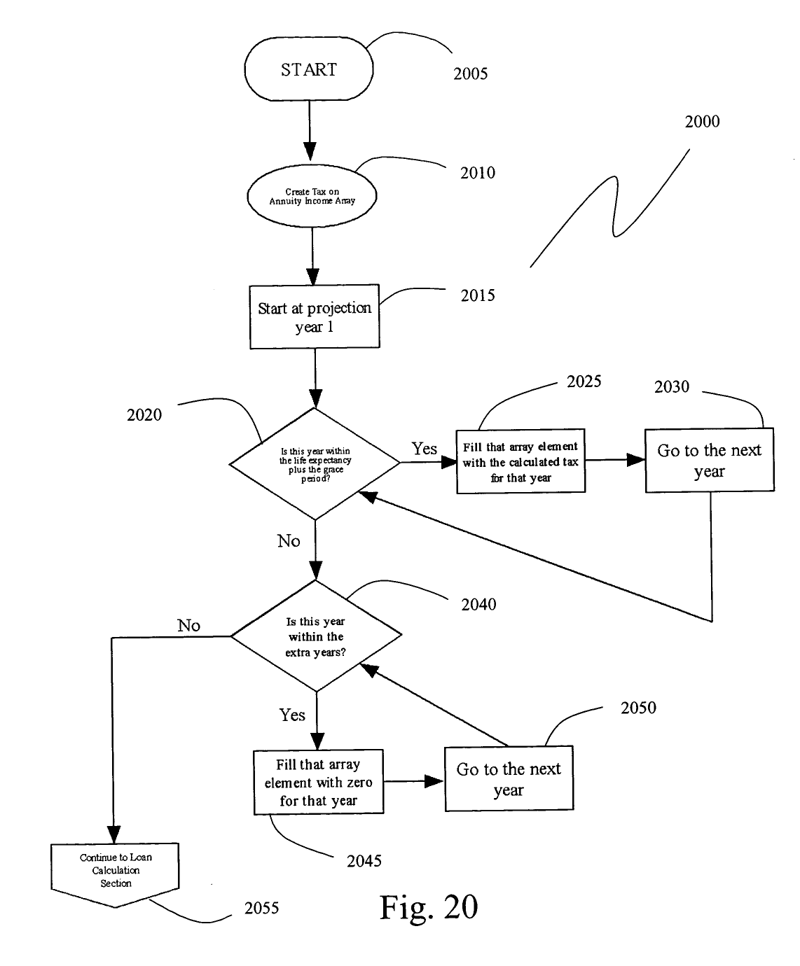

Calculation mode C continues with outflow calculations 2000, as illustrated in FIG. 20, which are now described. The application begins (step 2000) this by calculating the tax on the annuity income for each year of the projection. This is done by creating an array (step 2010) with elements corresponding to the amount of years in the projection. The array is then filled beginning at step 2015 by placing in each element the amount of tax on the annuity income. This amount is calculated by multiplying the SPIA annualized income times the client's tax rate, and then multiplying that quantity by one minus the SPIA Exclusion Ratio. Outflow calculations 2000 can also include insurance costs if the insurance premium is paid annually. If the client outlives the life expectancy plus grace period, these outflows go to zero, as there is no tax to be paid on annuity income because all annuity income has been assigned to the reinsurer. Therefore, all elements from the end of the life expectancy to the end of the extra year projections are filled with zeroes. After step 2015, the application proceeds to step 2020, where it checks if the current year being filled in the array is within the life expectancy plus the grace period. If it is, the application proceeds to step 2025, where it fills that array element with the calculated tax for that year. Proceeding to step 2030, the application goes to the beginning of the loop that begins at step 2020.

When at step 2020 the application determines that the year is not within the life expectancy plus the grace period, the application proceeds to step 2040. The application then determines whether the year being processed is within the extra years. If it is, the application continues to step 2045 where the application fills that array element with zero for that year. Proceeding to step 2050, the application continues to the next year. It returns to the loop that begins at step 2040. When at 2040 the application determines that the year being processed is not within the extra years, the program then moves (step 2055) on to perform loan calculations.

5. Loan Calculations Section

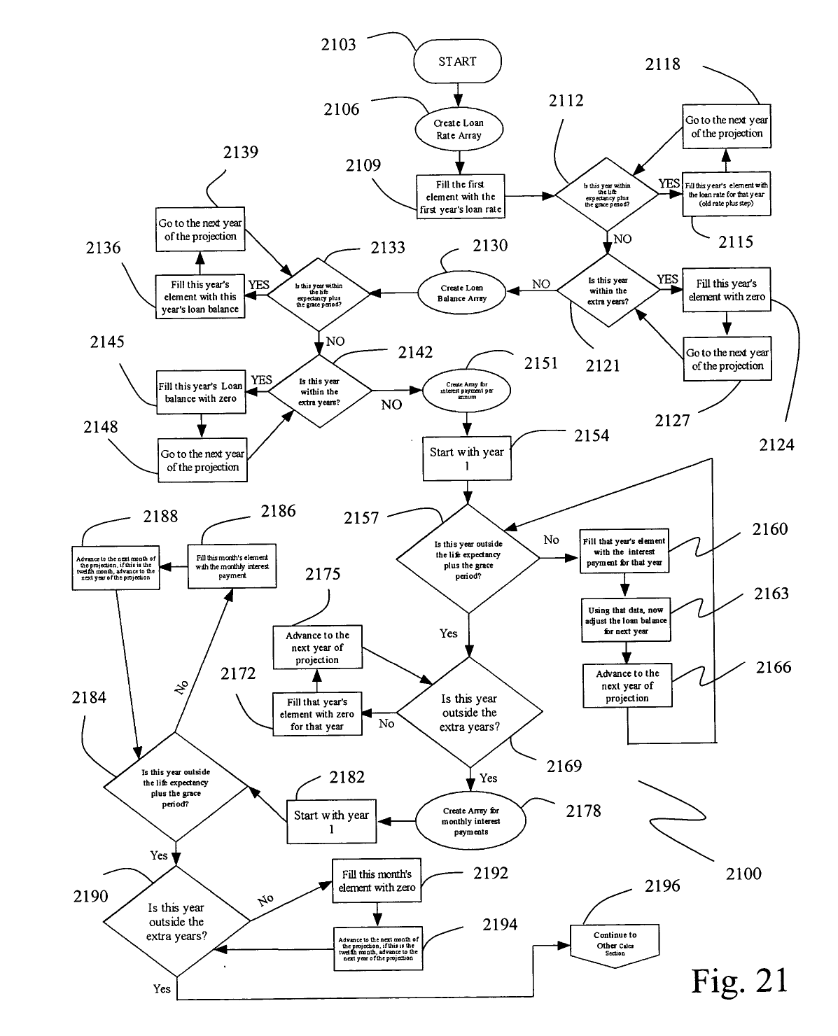

Calculation mode C then continues with loan calculations 2100, as illustrated in FIG. 21, which are now described. Beginning with step 2103, the application creates an array (step 2106) to hold the rate for the loan for each of the years of the projection plus the extra years allowed for the holding of reinsurance effect data. The first element in this array is filled (step 2109) by the user provided assumed rate. At step 2112, the application determines if the year in that element is within the life expectancy plus the grace period. If it is, the application proceeds to step 2115 where it fills this year's element with the loan rate for that year plus any loan rate step amount, if the loan is a variable interest rate loan. The program then continues to step 2118, where it goes to the beginning of the loop that begins at step 2112. If at step 2112 the application determines that the year is not within life expectancy plus grace period, the application proceeds to step 2121. If it determines at step 2121 that the year is within the extra years, it proceeds to step 2124 where it fills this year's element with zero. At step 2127 it goes to the next year position in the array of the projection, returning to the loop that begins at step 2121. If the client outlives the life expectancy plus the grace period, the loan rate then goes to zero as the reinsurer has paid the loan off in full. Because the client no longer pays any interest, and no longer has a loan outstanding, all elements of this array after life expectancy plus grace until the end of the extra projection years are filled with zeroes.

If at step 2121 the year is not within the extra years, the application then creates a loan balance array (step 2130) with the same number of elements as there are years in the projection plus a number of years to take into account the client who outlives the projection, for purposes of handling reinsurance effects to the client. This array will be filled with the loan balance in each of the corresponding years of the loan. The first element in this array is populated by the total loan balance (in an unillustrated step). Subsequent elements are filled by adding the loan balance for the current year to the loan additions for that year, and then subtracting the loan repayments and the loan interest for that year from that. At step 2133, the application determines if the current year is within the life expectancy plus the grace period. If it is, the application fills this year's position in the array with this year's loan balance at step 2136. It then, via step 2139, continues to the next year of the projection and returns to the loop that begins at step 2133. If at step 2133 the application determines that the year is not within the life expectancy plus the grace period, the application proceeds to step 2142 to being filling the rest of the array with zeros. Starting at the year after the client's grace period, the array is filled with zeroes, as the loan will have been paid off by the reinsurer. Because there is no outstanding loan, the client's loan balance goes to zero, and is noted inside the array. The application notes this by determining if the current year is within the extra years (step 2142). If it is, the application proceeds to step 2145 where it fills this year's loan balance with zero. At step 2148 the application proceeds to the next year of the projection, then returns to the beginning of the loop that begins at 2142.

When at step 2142 the application determines that the current year is not within the extra years, the application proceeds to step 2151 where the loan interest payments for each year are calculated. This is done by creating an array (step 2151) with elements corresponding to the number of years in the term of the project. The application starts at year 1 of the project (step 2154). It determines if the current year is outside the client's life expectancy plus the grace period (step 2157). If the year is not outside the client's life expectancy plus grace period, the application then populates the array elements with the interest payment for that year (step 2160). Using that data, the application adjusts the loan balance for the next year (step 2163). The application then advances to the next year of the projection (step 2166). This loop that begins at 2157 continues until each year of the projection has been filled in the array (when at step 2157 the application determines that the current year is outside the life expectancy plus the grace period). Once the projection has been filled, then the number of years outside the projection provided for the client who outlives the projection is filled with zeroes to note that there will be no more interest payments to be made, as the reinsurer has paid off the loan balance. This is accomplished by proceeding to step 2169 from step 2157. The application determines if this year is outside the extra years at step 2169. If it is not, the application fills that year's element with zero for that year at step 2172, then advances to the next year of the projection through step 2175. The application then proceeds to beginning of the loop that begins at step 2169. When at step 2169 the application determines that the year is outside the extra years, the application then proceeds to create a two dimensional array with elements corresponding to the years and months of the projection.

The application creates an array for monthly interest payments (step 2178). Starting with year one, (step 2182), the application determines whether that year is outside the client's life expectancy plus the grace period (step 2184). If it is not, the application fills in the corresponding elements (step 2186) for each month with the monthly interest payment derived by dividing the loan's interest payment per year by 12. The application increments the year element (step 2188), and returns to step 2184 in the loop to repeat the filling of the array for the second year and subsequent years, until it reaches the end of the projected term (when the projected term is outside the life expectancy plus the grace period). At this point, the application moves to step 2190, to being filling the rest of the array with zeroes. This is to note that there will be no more interest payments made by the client because if the client outlives the life expectancy plus the grace period, then the reinsurer will have paid the loan balance in full, thereby obviating the need to make interest payments. The application determines if this year is outside the extra years. If it is not, the application fills this month's element with zero at step 2192. It then advances to the next month of the projection at step 2194. If it is the twelfth month of the year, it advances to the first month of the next year of the projection. It then returns to the beginning of the loop that begins at step 2190. When at step 2190 the application determines that the year is outside the extra years, the application moves to an unillustrated step, where the loan term is derived from the projected premium financing period, which is a function of the projected years the client has to live.

The application then goes on to (through step 2196) perform a few other calculations explained below.

6. Other Calculations Section

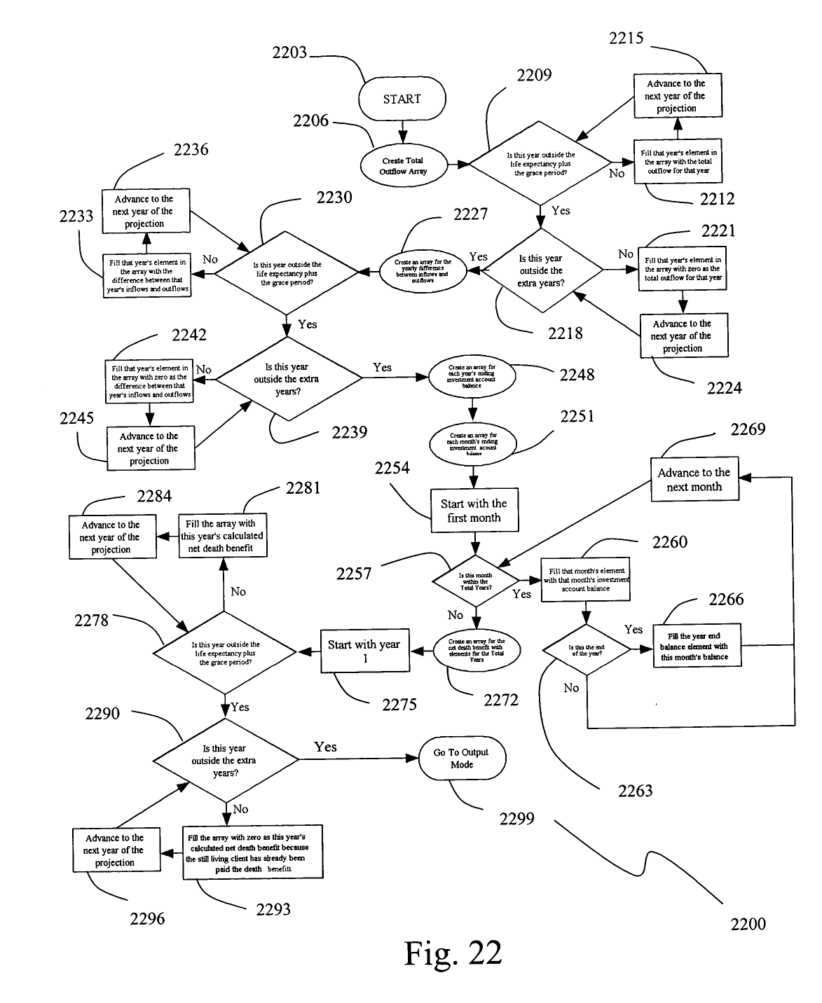

Calculation mode C next performs the other calculations 2200 as illustrated in FIG. 22. Starting with step 2203, the application creates an array (step 2206) with a number of elements corresponding to the number of years in the projected term plus the extra years projected in order to show possible reinsurance effects on the client to hold the total yearly outflow. The application determines whether the current year being processed is outside the life expectancy plus the grace period (step 2209). If it is not, the application proceeds to step 2212 to fill the total outflow for that year. The application then fills each array element with the corresponding total outflow for that year by adding the tax on the annuity income for that year with the total premiums for that year and then adding that to the loan interest payment for that year. This quantity is placed in the element of the array and represents the total outflow for that year. The application then advances to the next year of the projection (step 2215) and returns to the beginning of the loop that begins at step 2209. When at step 2209 the application determines that the year is outside the life expectancy plus the grace period, it proceeds to step 2218, where it determines if the year is outside the extra years. If it is not, the application proceeds to step 2221 where it fills that year's element in the array with zero as the total outflow for that year. The application then advances to the next year of the projection (step 2224), and returns to the beginning of the loop that begins at step 2218. When at step 2218 determines that the year is outside the extra years, it advances to step 2227.

The application now calculates the total difference between inflows and outflows. It does this by creating an array (step 2227) of elements corresponding to the amount of years in the projected term plus the extra years projected in order to show possible reinsurance effects on the client. At step 2230 the application determines if the current year being processed is outside the life expectancy plus the grace period. If it is not, the application then fills the element in the array for that year (at step 2233) with the difference between total inflow and outflows. It does this by subtracting the corresponding year's outflows from the year's inflows, and storing the difference in the array created. The application then advances to the next year of the projection (step 2236), then proceeds to the beginning of the loop that starts at step 2230. When at step 2230 the application determines that the year is outside the life expectancy plus the grace period, it proceeds to step 2239, where it determines if the year is outside the extra years. If it is not, the application proceeds to step 2242 where it fills that year's element in the array with zero as the difference between that year's inflows and outflows. The application then advances to the next year of the projection (step 2245), and returns to the beginning of the loop that begins at step 2239. When at step 2239 determines that the year is outside the extra years, it advances to step 2248.

The application then creates an array (2248) with a corresponding amount of elements to the amount of years in the projected life term, plus the extra years projected in order to show possible reinsurance effects on the client. It then creates an array (step 2251) of elements with 12 times the amount of elements as the projected life term to represent the amount of months in the projected term. Starting with the first month (step 2254), the application verifies that the month is within the life expectancy of the client (step 2257). If it is, the array element representing that month of the term is then filled (step 2260) with the investment amount plus the client's contribution for that year. The application then checks whether it is at the end of a year (step 2263). If it is not, the application advances to the next month (step 2269) and continues to the beginning of the loop which starts at step 2257. When if at step 2263, the application determines that it is at the end of the year, the amount entered into the twelfth month's element is also entered into the yearly array to represent the end-of-year investment account balance (step 2266). The application then goes to step 2269, then step 2257 where it determines that the month is not within the life expectancy plus grace and the extra years added to allow for possible reinsurance effect data.

When at step 2257 the application determines that the current month being processed is not within the total years, it then creates an array (step 2272) that contains the same amount of elements as the number of years in the projected life term plus the extra years projected in order to show possible reinsurance effects on the client. This array will hold the client's net death benefit. Each element of the array is then populated with the new insurance to the estate plus that year's investment account ending balance, minus the life insurance pre-pay penalty for that year. This shows the death benefit to the client if the client is to expire in corresponding year for which the data in the array represents. The program accomplishes this by starting with year one (step 2275). It checks to that the year is outside the life expectancy plus the grace period (step 2278). If it is not, it fills the array with this year's calculated net death benefit (step 2281), and advances to the next year of the projection (step 2284). The application then returns to the beginning of the loop that starts at step 2278. When at step 2278 the application determines that the year is outside the life expectancy plus the grace period, it moves to step 2290. It then determines if the year is outside the extra years (step 2290). If it is not, at step 2293, the application fill the array with a zero as that year's calculated net death benefit because the still living client has been already been paid the death benefit. The program then advances to the next year of the projection (step 2296), and returns to the beginning of the loop that starts at step 2290. When at step 2290 the application determines that the year is outside the extra years, it advances to step 2299.

The program now has completed calculation mode C, and advances (step 2299) to the output mode 2300.

Calculation Mode C PsuedoCode

If currentMode=CalcMode C

Then

BEGIN CALCULATION MODE C

<Optionally display to user something to indicate initial processing is underway>

Initial Calculation Section

<LifeExpextancy CS·LE=100−ClientAge CS·AGE>

<ExtraYears=35>

This is used to calculate the years to project the model out (in this example to the age of 100). This variable ClientAge is passed to this by the INPUT MODE

ExtraYears (here set to thirty-five, but variable to any number needed) is a number of years that the clients cannot possibly outlive past the life expectancy plus the grace period. For example, if the client is projected to live to age 85, and there is a grace period of 5 years figured in, this would make the client's total projection 90 years of age. Here is where a reinsurer would take over until the death of the client. For data holding purposes, a buffer of 35 years is provided so that calculations concerning the reinsurance effect on the client can be shown. Because there is little chance of someone living until 125 years old, this amount of years to show the effect on the reinsurer is probably a safe one.

<array BaseCaseAge=newArray[LifeExpectancy+ExtraYears]

<TotalYears=LifeExpectancy+ExtraYears;>

This creates an array of as many elements as there are years left in client's life expectancy plus the amount of extra years that will be used to hold reinsurance effect data for the client.

For YearOfProjection = 1; YearOfProjection <= TotalYears;
YearOfProjection++

<BaseCaseAge[YearOfProjection − ArrayOffset] = ClientAge −
1+YearOfProjection>

END FOR

This section populates each element of array BaseCaseAge with the age of the client in that projected year.

<array LifeInsurancePolicy[ ][ ] = new array[TotalNumberOfLifeInsurancePolicies][3]>
For countX = 1; count x <= TotalNumberOfLifeInsurancePolicies; countX++;

LifeInsurancePolicy[countX − ArrayOffset][0] = InsurancePolicyName(x)
LifeInsurancePolicy[countX − ArrayOffset][1] = LifeInsurancePremium(x)
LifeInsurancePolicy[countX − ArrayOffset][2] = LifeInsuranceCoverage(x)

END FOR

This section creates a 2 dimensional array that contains the life insurance policy provider's name, that life insurance policy's premium amount, and the coverage the life insurance policy provides. The FOR loop would populate the fields based on the three fields for each policy field passed from the input section. TotalNumberOfLifeInsurancePolicies, InsurancePolicyName, LifeInsurance Premium, and LifeInsuranceCoverage are passed to this by the INPUT MODE.

if ArePremiumsLumpSum = True
Then

<For count2 = 1; count2 <= TotalNumberOfLifeInsurancePolicies;
count2++>

TotalPremiumsTemp = TotalPremiumsTemp +
LifeInsurancePolicy[count2 − ArrayOffset][1]

END FOR

array TotalPremiums[ ] = new Array [TotalYears]
TotalPremiums[1 − ArrayOffset] = TotalPremiumsTemp
For countf = 2; countf <= TotalYears; countf++

TotalPremiums[countf − ArrayOffset] = 0;

END FOR

Count2 will be used to traverse array LifeInsurancePolicy[ ] [ ]'s elements to total them into TotalPremiumsTemp. Because this has been indicated to be a single pay insurance plan, the total amount of the insurance is entered into the first year, and the remaining years are filled with zero. This is the amount of payment for those years. TotalNumberOfPremiums is passed to this by INPUT MODE. ArePremiumsLumpSum is a flag that is passed from the INPUT MODE/

```
  Else
  For countq = 1; countq <= TotalNumberOfLifeInsurancePolicies;
countq++
```

TotalPremiumsTemp = TotalPremiumsTemp +
LifeInsurancePolicy[countq − ArrayOffset][1]

```
  END FOR
  Array TotalPremiums[ ] = new Array[TotalYears]
  For countu = 1; countu <= LifeExpectancy; countu++
```

TotalPremiums[countu − ArrayOffset] = TotalPremiumsTemp

```
  END FOR
FOR countz =LifeExpectancy+1; countz <= TotalYears; countz++
  TotalPremiums[countz − ArrayOffset] = 0;
END FOR
```

Countq will be used to traverse array LifeInsurancePolicy[ ] [ ]'s elements to total them into TotalPremiumsTemp. Because this has been indicated to be a annual pay insurance plan, the amount of the insurance is assumed to be entered in annual payment form and therefore this amount is entered into each year of the client's life expectancy. This is the amount of payment for those years. Once the life expectancy has been exceeded, the total premiums are now entered as 0 until the end of the projection because at this point, the reinsurer takes over the premium payments. TotalNumberOfPremiums is passed to this by INPUT MODE.

ArePremiumsLumpSum is a flag that is passed from the INPUT MODE.

END IF
<array ReportingInsurancePremium[ ] = new array[TotalYears]
For count3 = 1; count3 <= LifeExpectancy; count3++

ReportingInsurancePremium[count3 − ArrayOffset] = TotalPremiums

END FOR
FOR countq = LifeExpectancy+1; countq <= TotalYears; countq++

ReportingInsurancePremium[countq − ArrayOffset] = 0

END FOR

This sets each element corresponding to the projection year in array ReportingInsurancePremium to amount TotalPremiums. Once the life expectancy plus the grace period has been exceed by the client, the premiums are now set to 0, as the reinsurer is now making the payments.

For count4 = 1; count4 <= TotalNumberOfLifeInsurancePolicies;
count4++

TotalNewCoverage = TotalNewCoverage +
LifeInsurancePolicy[count4 − ArrayOffset][2]

END FOR

This adds the total amount of coverage from each policy (contained in LifeInsurancePolicy[x] [2]) to get the total coverage of all policies. TotalNumberOfLifeInsurancePolicies is passed to this by the INPUT MODE. LifeInsurancePolicy[ ] [ ] is passed to this by the INITIAL CALCULATION SECTION.

<SPIALoan=TotalDeposit−LifeSettlement−SPIADumpIn>

This calculates the SPIA loan needed. Total Deposit is passed in from THIS SECTION. LifeSettlement and SPIADumpIn are passed in from the INPUT SECTION.

<TotalDeposit=SPIALoan−TotalPremiums−InvestmentAmount−LifeSettlement−SPIADumpIn>

This calculates the total deposit. Investment Amount, SPIADumpIn, and LifeSettlement are passed to this from the INPUT SECTION. TotalPremiums is passed in from INITIAL CALCULATION SECTION.

<BIGLoanAmount=TotalPremiums+TotalSPIADeposits+InvestmentAmount>

This calculates the LoanAmount. TotalPremiums is calculated in THIS SECTION.

<NewInsurancetoEstate=TotalNewCoverage−LoanAmount>

Calculate the new life insurance to the estate. TotalNewCoverage and LoanAmount are calculated in THIS SECTION.

<TotalSourcesOfFunds=BIGLoanAmount+LifeSettlement+SPIADumpIn+OtherSources>

This calculates the total sources of funds for the SPIA. LoanAmount is calculated in THIS SECTION. LifeSettlement, SPIADumpIn, and OtherSources are passed to this by INPUT MODE.

<TotalUses=TotalPremiums+TotalSPIADeposits+InvestmentAmount>

This calculate the total uses for the money.

SPIA Calculation Section

<Optionally display to user something to indicate SPIA calculation is underway>

<SPIAAnnualizedPayment=TotalDeposit*SPIAOfferRate>

This calculates the SPIA annualized payment.

<SPIAGrossMonthlyPayment=SPIAAnnualizedPayment/12>

This calculates the SPIA gross monthly payment.

<SPIAAnnNetPayDuringExclusion=SPIAAnnualizedPayment−(SPIAAnnualizedPayment*(1−SPIAExclusionRatio)*ClientTaxRate>

This calculates the SPIA net payment during the exclusionary period. SPIAExclusionRatio and ClientTaxRate are passed to this from the INPUT SECTION.

<SPIAAnnNetPayAfterExculsion=SPIAAnnualizedPayment−(SPIAAnnualizedpayment*ClientTaxRate)>

This calculates the SPIA net payment after the exclusionary period. ClientTaxRate is passed to this from the INPUT SECTION.

<SPIANetMonthyDuringExclusion=SPIAAnnNetPayDuringExclusion/12>

This calculates the monthly amount during the exclusionary period/

<SPIANetMonthlyAfterExclusion=SPIAAnNetPayAfterExclusion/12>

This calculates the monthly amount after the exclusionary period.

Other Inflows Calculation

<Optionally display to user something to indicate Other Inflows
calculation is underway>
If SingleClientContribution = True
Then

SingleClientContribution Boolean flag is passed in from INPUT MODE

array ClientContributionArray[ ] = new array[TotalYears]
For county = 1; county <= TotalYears; county++

If county = 1
Then ClientContributionArray[1 − ArrayOffset] = ClientContrib
Else ClientContributionArray[county− ArrayOffset] = 0
END IF

END FOR

If the client is to make a single contribution, then create an array with same number of elements as the years in the client's projected life expectancy, then populate the first element with the total amount of the client's contribution, and fill the rest of the array elements with zeroes. ClentContrib, LifeExpectancy, and OtherCashOutlay are passed to this by the INPUT SECTION.

Else

array ClientContributionArray[ ] = new array[TotalYears]
For count5 = 1; count5 <= LifeExpectancy; count5++

ClientContributionArray[count5−ArrayOffset] = ClientContrib +
OtherCashOutlay

END FOR
For count6 = LifeExpectancy+1; count6 <= TotalYears; count6++

ClientContributionArray[count6 − ArrayOffset] = 0;

END FOR

END IF

This creates an array with the same number of elements as there are years in the client's life expectancy plus grace, plus the extra years used for reinsurance data placement, and then places the client's contribution and other annual cash outlays into the array. After the projected life expectancy, zeroes are placed into the array to show that after the life expectancy, the client will not be responsible for any future cash outlay or contribution.

TotalInflows = new array[TotalYears]
For count6 = 1; count6 <= LifeExpectancy; count6++

TotalInflows[count6 − ArrayOffset] = SPIAAnnualizedPayment +
ClientContributionArray[count6 − ArrayOffset]

END FOR
For count7 = LifeExpectancy+1; count7 <= TotalYears; count7++

TotalInflows[count7 − ArrayOffset] = 0;

END FOR

This creates an array of total income inflows with one element for each year of the projected life expectancy plus grace, plus the extra years used for reinsurance data placement. It then populates the array with the total of the SPIA Annualized Payments plus any other annual cash outlays that the client will contribute. After the life expectancy plus the grace period, the array is filled with zeroes to show that the total inflows after the life expectancy plus the grace period will go to zero. SPIAAnnualizedPayment is passed in from the SPIA CALCULATION SECTION. ClientContributionArray is passed in from THIS SECTION.

Outflow Calculation Section

<Optionally display to user something to indicate Outflow calculation is
underway>
TaxOnAnnuityIncome = new array[TotalYears]

For count7 = 1; count7 <= LifeExpectancy; count7++
TaxOnAnuityIncome[count7 − ArrayOffset] =
SPIAAnnualizedPayment * (1 − SPIAExclusionRatio) *
ClientTaxRate

END FOR
FOR countg = LifeExpectancy+1; countg <= TotalYears; countg++

TaxOnAnnuityIncom[countg − ArrayOffset] = 0;

END FOR

This creates an array of taxes on the annuity income with an array element for each year of the client's projected life expectancy. It then populates the array with the projected tax for each year on the annuity income. Once the life expectancy plus the grace has been outlived by the client, the tax on the annuity income then drops to zero as the annuity income payments have been transferred to the reinsurer. LifeExpectancy is passed in from the INITIAL CALCULATION SECTION.

SPIAAnnualizedPayment and SPIAExclusionRatio are passed in from INPUT SECTION.

Loan Calculations Sention

<Optionally display to user something to indicate Loan calculation
is underway>
<LoanRate[ ] = new array[TotalYears]
<LoanRate[1 − ArrayOffset] = SourceOf FundsAssumedRate>
For count8 = 2; count8 <= LifeExpectancy; count8++

LoanRate[count8 − ArrayOffset] = LoanRate[count8 − 2] +
SourceOfFundsStep

END FOR
FOR countw = LifeExpectancy+1; countw <= TotalYears; countw++

LoanRate[countw − ArrayOffset] = 0;

END FOR

This creates an array with the same number of elements as the projected life expectancy plus the grace period, plus the extra years used to hold reinsurance's effect on the client data. Then this populates the first element of the array with the assumed interest rate of the loan. The second through the life expectancy plus grace's elements in the array are then populated by the rates for those years, adjusting the interest rate by a step if the loan is an adjustable rate loan. Once the grace period has been outlived by the client, the interest rate goes to zero, as the loan has been paid in full by the reinsurer.

SourceOfFundsAssumedRate and SourceOfFundsStep are passed in from the INPUT SECTION. LifeExpectancy is passed in from the INITIAL CALCULATIONS SECTION.

<Loan Balance[ ] = new array[TotalYears]>
FOR countd = 1; countd <= LifeExpectancy; countd++

LoanBalance[countd − ArrayOffset] = BIGLoanAmount;

END FOR
FOR counth = LifeExpectancy+1; counth <= TotalYears; counth++

LoanBalance[counth − ArrayOffset] = 0;

END FOR

This creates an array with the same number of elements as the client's projected life expectancy and then fills the array with the balance of the loan, which is always the total amount of the loan. Once the life expectancy plus the grace period have been outlived by the client, the loan amount then goes to zero, as the loan has been paid off by the reinsurer. Therefore, all elements from life expectancy until the end of the extra years are filled with zeroes to indicate a zero loan balance.

<array LoanIntPayPerAnnum = new array[TotalYears]
FOR count9 = 1; count9 <= LifeExpectancy; count9++

LoanIntPayPerAnnum[count9 − ArrayOffset] = LoanRate[count9 −
ArrayOffset] *
LoanBalance[count9 − ArrayOffset]
LoanBalance[count9] = LoanBalance[count9 − ArrayOffset] +
LoanAdditions[count9 − ArrayOffset] − LoanRepayments[count9 −
ArrayOffset] −
LoanIntPayPerAnnum[count9 − ArrayOffset]

END FOR
FOR counto = LifeExpectancy+1; counto <= TotalYears; counto++

LoanIntPayPerAnnum[counto − ArrayOffset] = 0;

END FOR

This creates an array for the per annum loan interest payment with an element for each year of the projected life expectancy of the client. It then populates the array with the amount which is equal to the loan's interest rate for that year multiplied by the loan balance for that year. Then the Loan balance for the next year is calculated by taking the loan balance from this year, adding any loan addition, and subtracting any loan repayments and loan interest paid per annum. That way, when the for loop executes next time, it will use the updated loan balance for the calculations. Once the client outlives the life expectancy plus the grace period, the loan interest payment per annum will be zero, as there is no loan balance for which interest accrues as the total balance has been paid off by the reinsurer. Therefore, all elements after life expectancy until the end of the extra years are filled with zeroes.

LifeExpectancy is passed in from the INPUT SECTION. All other variables are passed in from THIS SECTION.

<array MonthlyIntPay[ ][ ] = new array [TotalYears][12]>
<YearCounter = 0
While (YearCounter != & !> LifeExpectancy)

For MonthCounter = 1; MonthCounter <= 12; MonthCounter++

MontlyIntPay[YearCounter][MonthCounter] =
(LoanIntPayPerAnnum[YearCounter]/12)

END FOR

YearCounter++
END WHILE
YearCounter2 = LifeExpectancy;
While (YearCounter2 <= ExtraYears)

For MonthCounter2 = 1; MonthCounter2 <= 12; MonthCounter2++

MonthIntPay[YearCounter][MonthCounter] = 0;

END FOR

YearCounter2++;
END WHILE

This creates a two dimensional array to with an element for each month of each year in which to store the monthly interest payment. The year counter starts at 0 (which is the first year in the array and then proceeds to cycle through months 1 thru 12 of that year filling the array with the calculated monthly interest payments. After life expectancy, monthly interest payment is set to zero for each month until the end of the projection. TotalYears is passed in from INITIAL CALCULATIONS SECTION.

Other Canculations

<Optionally display to user something to indicate Other calculations are
underway>
<array TotalOutflow[ ] = new array[TotalYears]
<For count10 = 1; count10 <= LifeExpectancy; count10++>

TotalOutflow[count10 − ArrayOffset] =
TaxOnAnnuityIncome[count10 −
ArrayOffset] + TotalPremiums + LoanIntPayPerAnnum[count10 −
ArrayOffset]

END FOR
<For count11 = LifeExpectancy+1; count11 <= TotalYears; count11++>

TotalOutflow[count11 − ArrayOffset] = 0;

END FOR

This creates an array to hold the total outflow of assets and contains an element for each year of the projected life expectancy of the client, plus the grace period and the extra years that are charted for purposes of holding possible reinsurance effects on the client. The array is then populated by the total of the taxes on the annuity income for that year, the total life insurance premiums for the year, and the loan interest payments per annum for that year. After life expectancy plus grace, all total outflows go to zero. TotalYears and TotalPremiums are passed in from INITIAL CALCULATIONS. TaxOnAnnuityIncome is passed in from OUTFLOW CALCULATION SECTION.

<array TotalInflowOutflowDifference[ ] = new array[TotalYears]>
For count11 = 1; count11 <= LifeExpectancy; count11++

TotalInflowOutflowDifference[count11 − ArrayOffset] =
TotalInflow[count11 −
ArrayOffset] − TotalOutflow[count11 − ArrayOffset]

END FOR
For count12 = LifeExpectancy+1; count12 <= TotalYears; count12++

TotalInflowOutflowDifference[count12 − ArrayOffset] = 0;

END FOR

This creates an array for the net difference between all inflows and outflows and creates an array element for each year of the projected life expectancy, and for the extra years that are charted for purposes of holding possible reinsurance effects on the client. It then fills the elements with the total difference between inflows and outflows for each year projected. It the fills the array elements for all subsequent years after life expectancy plus grace with zeros.

TotalYears is passed in from INITIAL CALCULATIONS SECTION.

<YearEndInvAccountBalance[ ] = new array[TotalYears]>
<InvestmentAccountBalance[ ] = new array[TotalYears*12]>
<InvestmentAccountBalance[1 − ArrayOffset] = InvestmentAmount +
ClientContributionArray[1 − ArrayOffset]
For count12 = 2; count12 <= )TotalYears*12); count12++

InvestmentAccountBalance[count12 − ArrayOffest] =
InvestmentAccountBalance[count12 − 2] * (1 + AssumedYield/12) −
IntPay[count12 − 2]

If count12 mod 12 = 0
Then

YearEndInvAccountBalance[(count12/12) − 1] =
InvestmentAccountBalance[count12 − ArrayOffset]

END IF

END FOR

This creates an array to contain the monthly balance of the investment account. The first month's balance is then set to the client's first year contribution total. After this, the array is filled with the monthly balances of the investment account based upon the total of the last month's investment account balance, multiplied by (1 plus the monthly assumed yield divided by 12) minus last month's interest payment. If the month is divisible evenly by 12 (the modulus operator), then it is the end of the year so the end of the year investment account balance is recorded in YearEndInvAccountBalance[ ] for later use. TotalYears is passed in from the INITIAL CALCULATIONS SECTION.

<array NetDeathBenefit = new array[TotalYears]>
For count13 = 1; count13 <=LifeExpectancy; count13++

NetDeathBenefit[count13 − ArrayOffset] = NewInsuranceToEstate +
YearEndInvAccountBalance[count13 − ArrayOffset]

END FOR
For count14 = LifeExpectancy + 1; count14++

NetDeathBenefit[count14 − ArrayOffset] = 0;

END FOR

This creates an array with elements for the net death benefit for the client and the array contains an element for each year of the client's projected life expectancy plus grace period, and for any extra years added to handle the possibility of the client outliving the projection. The array is then populated by the net death benefit for each year based upon the amount of new insurance to the estate, plus that year's ending balance of the investment account. The net death benefit is calculated each year and placed into the array for every year until the end of the life expectancy plus the grace period. After the life expectancy plus the grace period, the net death benefit is entered as zero. This is because if the client outlives the life expectancy plus the grace period, the reinsurer will pay the still-living client the net death benefit they would receive if they had passed away during the last year of life expectancy plus the grace period. The reinsurer will now receive the client's actual death benefit upon the death of the client, but since the client has already received their death benefit early, the client has no expected future death benefit, therefore, zeroes are entered into the client's net death benefit array for the years after life expectancy plus the grace period. TotalYears and NewInsuranceToEstate are passed in from the INITIAL CALCULATIONS SECTION. YearEndInvAccountBalance is passed in from THIS SECTION.

<previousMode=“C”>

This sets the flag so that the ouput mode knows how big the arrays to be output are.

<currentMode=OutputMode>

This sets the mode flag to Output mode so that the next part will execute.

<Optionally display to user something to indicate calculations are complete>

GOTO OUTPUT MODE

END CALCULATON MODE C

### III. Detailed Description of Output Mode

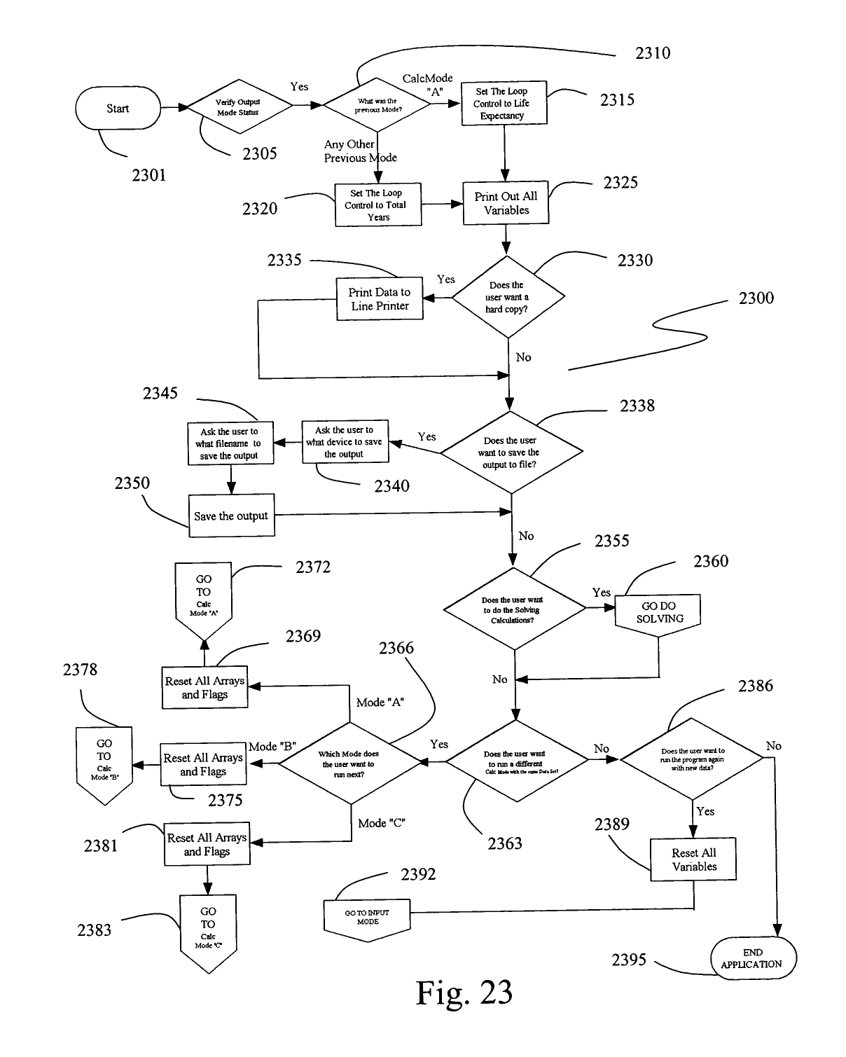

Having completed the calculation mode chosen by the user, the application advances to output mode 2300, which is herein described with reference to FIG. 23. During the output mode 2300 of the application, which starts with step 2301, the program first verifies that the application is in output mode (step 2305). In step 2310 the application determines which mode was the previous mode. If the previous mode was calculation mode A, the program advances to step 2315, where it set the loop control to life expectancy. If at step 2310 the application determines that it was previously at calculation mode B or calculation mode C, the application advances to step 2320 where it sets the loop control to total years. This tells the application how large the arrays are (how many years there are in the projection) that are to be output. The application prints (step 2325), through a text-based or graphical user interface on the video output device, all information entered by the user, as well as the information generated by the calculation mode. After this information is displayed, the user is asked in step 2330 whether or not to print out the information in hard-copy form using another output device, such as a line printer. If the user chooses to print the information out, the information is sent to the hard-copy output device (step 2338). Whether or not the user decides to print the information out, the user is next asked (step 2335) if the information should be saved on a more permanent storage medium for later use. If the user chooses to save the information, the user is asked to which device the information should be written. After the user selects the storage device (step 2340), the application asks the user to name the file in which the information will be stored (step 2345). Once the filename is inputted by the user and accepted by the application, the file is written to the selected device, and the information is stored under the filename selected by the user (step 2350). Whether or not the user selects to save the data, the application then asks (step 2355) whether the user wishes to perform a calculation to solve for the SPIA distribution amounts that will cover all taxes, interest due on the loan, and total insurance premiums by adjusting the original loan amount, while not exceeding the amount of total new coverage to the estate (as represented by step 2360). Whether or not the user chooses to run this calculation, the user is then asked (step 2363) whether or not the application should perform another set of calculations with the same data set using one of the other calculation modes. If the user desires to perform different calculations, the application prompts the user to choose which calculation mode they would like to run next (step 2366). If at step 2366 the user choose calculation mode A, the application resets all arrays and flags (step 2369), and then goes to calculation mode A (via step 2372). If at step 2366 the user choose calculation mode B, the application resets all arrays and flags (step 2375), and then goes to calculation mode B (via step 2378). If at step 2366 the user choose calculation mode C, the application resets all arrays and flags (step 2381), and then goes to calculation mode C (via step 2383).

If the user declines at step 2363 to run more calculations using the current data set, the user is asked at step 2386 whether the application should start over from the beginning with new data for this or a different client. If the user chooses to start the application over again, all of the variables used before are set to 0 or a NULL value in step 2389 so that no old data exists within those variables which could possibly corrupt future calculations. The application then in step 2392 goes back to the beginning of input mode. If the user does not wish to start the application over again at step 2386, then the application quits and exits (step 2395).

Output Mode PsuedoCode

If currentMode = OutputMode
Then

If previousMode “A”
Then

LoopControl = LifeExpectancy;

Else

LoopControl = TotalYears;

END IF

<Display Variables>

For example, display variables can be in the form of

Print (“The client's present age is:”+ ClientAge)

or (or in this section does not refer to a logical or statement)

Print (“Year of projection, clients age is: ”)
For outputCount = 1; outputCount <= LoopControl

Print (BaseCaseAge[outputCount − arrayOffset];

END FOR

or

Print (“The total inflow-outflow difference for this year is: ”)
For outputCount = 1; outputCount <= LoopControl

Print (TotalInflowOutflowDifference[outputCount −
arrayOffset])

END FOR

This section repeats these types of output statements for all variables that are to be outputted.

<Ask if user wishes to print results out>
If UserWantsPrintout = True
Then

Print all output to line printer (or similar device)

END IF
<Ask if user wishes to save the results>
If UserWantsToSave = True
Then

Ask the user what device to save to
Ask user for filename to save as
Save information as filename
<UsersChoiceOfStorageDevice><UserEnteredFilename>

END IF
<Ask if the user wants to solve for SPIA distributions that will cover
indicated cost>
If UserWantsToSolve = True
Then

Do Solving Calculations

END IF
<Ask if user wishes to run another Calculation Procedure with this data
set>
If DiffProcedSameData = True
Then

| <Query user as to which Calculation Mode procedure to use> | |
|---|---|
| Case | |
| WhichProc = A; | Reset Arrays and Flags; |
| | Do Calculation Mode A with current data set; |
| WhichProc = B; | Reset Arrays and Flags; |
| | Do Calculation Mode B with current data set; |
| WhichProc = C; | Reset Arrays and Flags; |
| | Do Calculation Mode C with current data set; |

ENDCASE

ENDIF
<Ask user whether or not to run the application again>

If DoAppAgain = True
Then

Set all variables and array elements to 0 or NULL to prevent
contamination of old data with next data for calculation

For example, set ClientAge = 0, or

for count = 1; count <= LoopControl; count++

TotalOutflow[count − ArrayOffset] = 0/

END FOR

or set ClientName = NULL

CurrentMode = InputMode
GOTO MODE 1
Else
END APPLICATION
END IF
END OUTPUT MODE
END APPLICATION

### ADVANTAGES OF THE INVENTION

The previously described versions of the present invention have many advantages, including providing an accurate and reliable means of calculating the amounts needed to provide a means to evaluate whether a premium financing program is advisable in a particular client's situation. The invention also provides a computer-based application which will take into account many factors and data such as various alternative sources of funding, various alternative inflows of assets, and various outflows of assets due to taxes, interest payments, selected insurance premiums, reinsurance costs, and transaction fees incurred in maintaining the premium financing program. Furthermore, the invention provides a means to rapidly and accurately calculate the amount of single premium immediate annuity distributions and other contributions needed in order to offset any costs associated with the creation and maintenance of a particular premium financing program. The present invention additionally provides a means for obtaining lower cost life insurance, by offsetting the cost through reinsurance, and by providing a stronger incentive to an insured to maintain the life insurance policy in full-force by providing the possibility of receiving the individual's death benefit while they are alive.

It must be noted that the present invention does not require that all the advantageous features and all the advantages be incorporated into every embodiment of the invention.

### EXAMPLES OF OPERATION AND DISCLOSURE OF BEST MODE

To avoid outliving a life insurance policy, which is used to repay the loan and leave a death benefit to a client's heirs, life insurance policies are typically funded through endowment. In doing so, a client may significantly over fund a life insurance policy. Should a client choose not to fund a policy to endowment and outlive the period for which the policy has been funded, they are at risk of significant out-of-pocket cost to fund future premium payments. The difference in funding a life insurance policy through age 90 versus endowment age can be dramatic. An example would be an 79 year-old female with health complications and a life expectancy of 5 years may pay 20-70% more to fund a life insurance policy to endowment age versus age 90. In order to offset the risk of outliving the life insurance policy and future premiums, clients typically fund policies to endowment age. By overpaying for the cost of insurance, clients must borrow significantly more to fund the life insurance policy and annuities. This reduces the economic viability of premium financing in many instances. We have added an additional element to our premium financing program, which enables clients to avoid overpaying for insurance through the use of reinsurance. Clients pay an Up-front fee to a reinsurer to bear the risk of any future premiums payments should a client outlive the period for which insurance had been purchased. In the example below, our client age 79 may purchase a life insurance policy funded to age 90, which is 5 years past her projected life expectancy. The client would pay an Up-front fee to a reinsurer to pay any future premium payments should she live past the age of 90. This enables our client to greatly reduce her cost of insurance and reduce the risk of future out-of-pocket costs. If our client were not to outlive her insurance, the reinsurance company would not be required to pay any premium payments and would keep the Up-front fee paid by the client. Reinsurance cost will vary depending on the provider and will be entered into the program where it will be added to the total loan amount. Reinsurance cost will be determined on a case-by-case basis, and will be calculated by the reinsurance provider.

### Example 1

A financial professional is trying to determine if a premium financing program is viable for his 79 year-old female client. The client has a large estate that is primarily in real estate and requires a large amount of insurance to cover future estate tax liability but does not have liquid assets to fund the cost of reinsurance. The client would be required to liquidate a portion of her estate to fund her insurance needs. The client has a projected life expectancy of 5 years, and has undergone medical underwriting for insurance and annuity quotes. The financial professional has priced the client's cost of insurance through age 90, six years past her projected life expectancy. Furthermore, the financial professional has received the cost to reinsure the client's future premium payments should she outlive the period for which the insurance has been funded. In addition, the financial professional has identified a number of lenders with a variety of financing programs available for his client. The life insurance and annuity financing program will enable him to review a number of financing programs and a number of interest rate scenarios for his client.

As an example, as shown in FIG. 12 the financial professional can input the following and calculate the results:

Client Information: Name: Confidential Female, Age: 79, Sex: female, Agent: agent, Tax Rate: 0%, Underwriting Class: special risk, Net Worth: 0, Liquidity: 0, Annual Income 0, Model Term: 20;

SPIA: Carrier(s): pooled, Deposits; Loan: 6,000,000, Life Settlement: 0, SPIA Dump In: 0, Other Sources: 0, Total Deposit: 6,000,000, Offer Rate: 17%, Exclusion Ratio: 100%, Annualized Payment: 1,020,000;

Life Premiums: Type of Premium: single, ING: 439,512, AG: 0, Manu: 0, Pac: 0, NY: 0, Number of Millions: 18; Total Premiums: 7,911,216

Investment Account: Investment Amount: 941,141, Assumed Yield: 4%;

Sources of Fund: Lender: ING, Loan Amount; 14,852,357, Assumed Rate: 6%, Step (if adjustable rate): 0.25%, Max. Rate: 7.25%, Loan Term: Interest Only for Life, Client Contribution: 0, Life Settlement: 0, SPIA Dump In: 0, Other Sources: 0; Total Sources: 14,852,357;

Use of Funds: New Life Insurance: 7,911,216, SPIA: 6,000,000, Investment Account: 941,141; Total Uses of Funds: 14,852,357;

Life Insurance: Policy Owner(s) Name: special Trust; Current Rate: 6%, Assumed Rate: 6%, Guaranteed Rate: 6%; Total New Coverage: 18,000,000, Total Loan: 14,852,357, New Insurance Estate: 3,147,643.

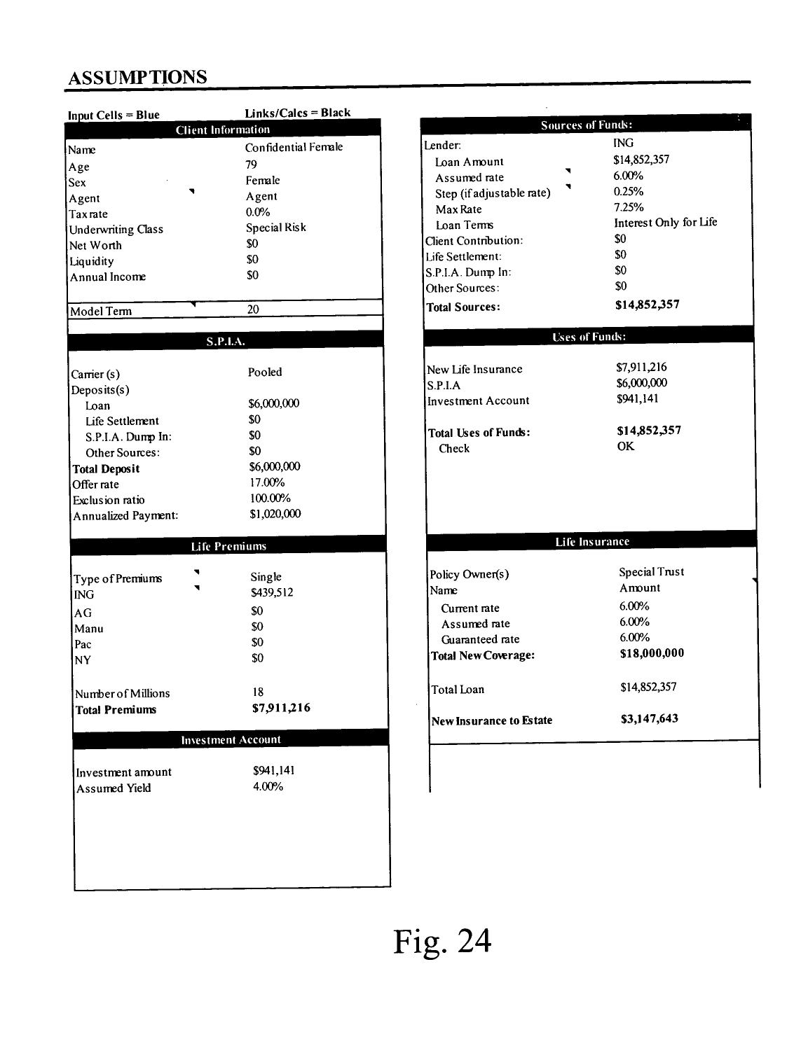

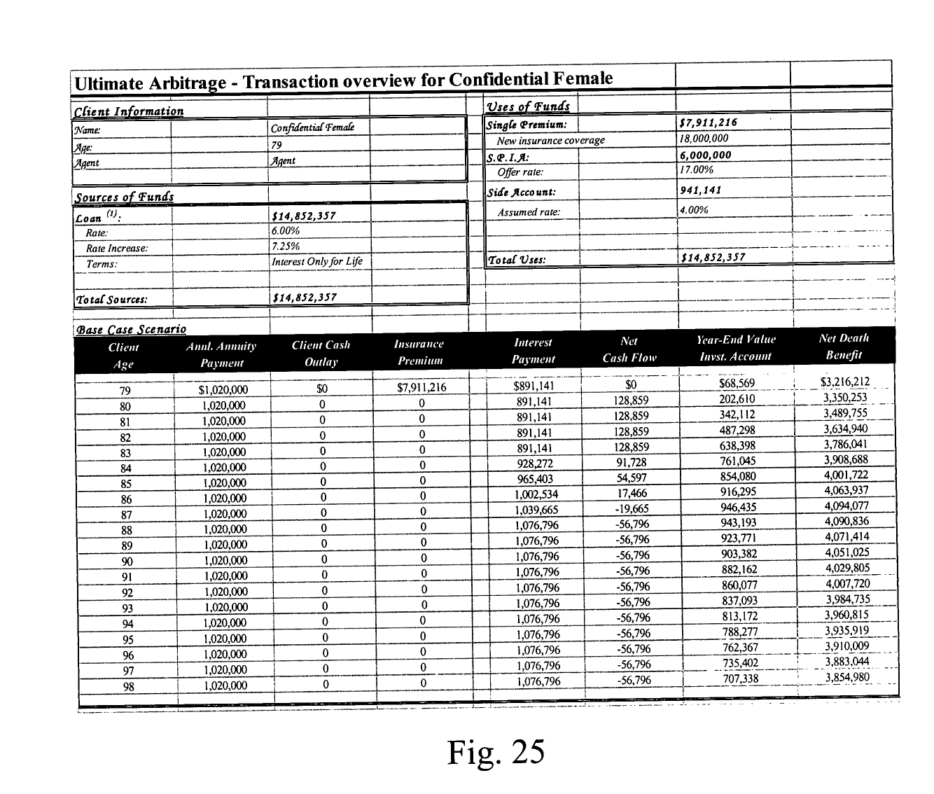

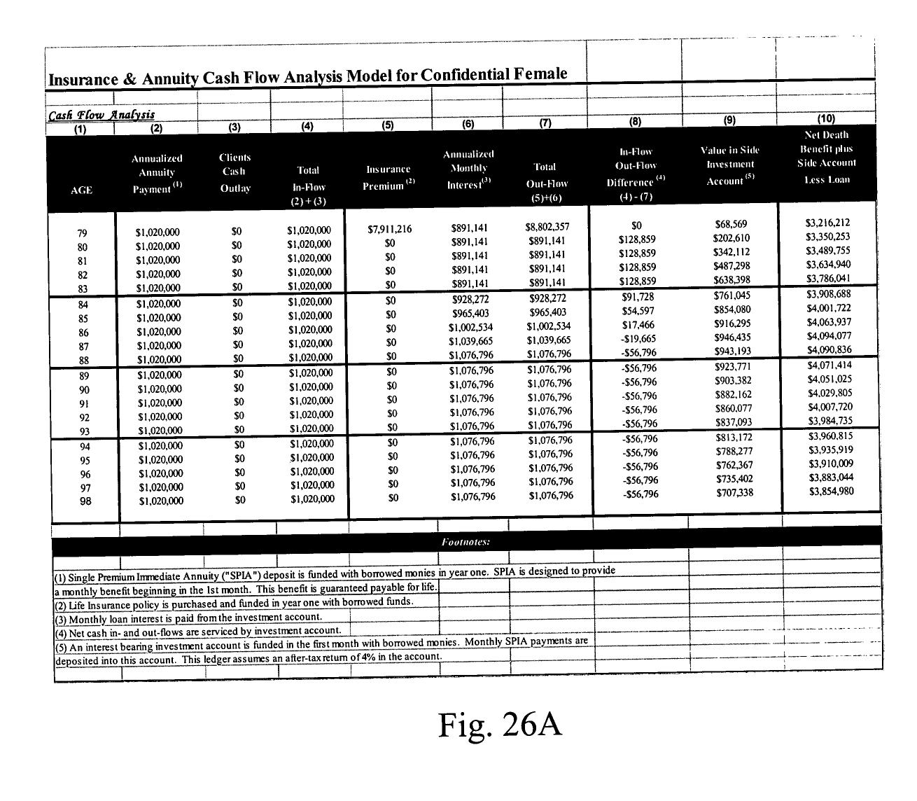

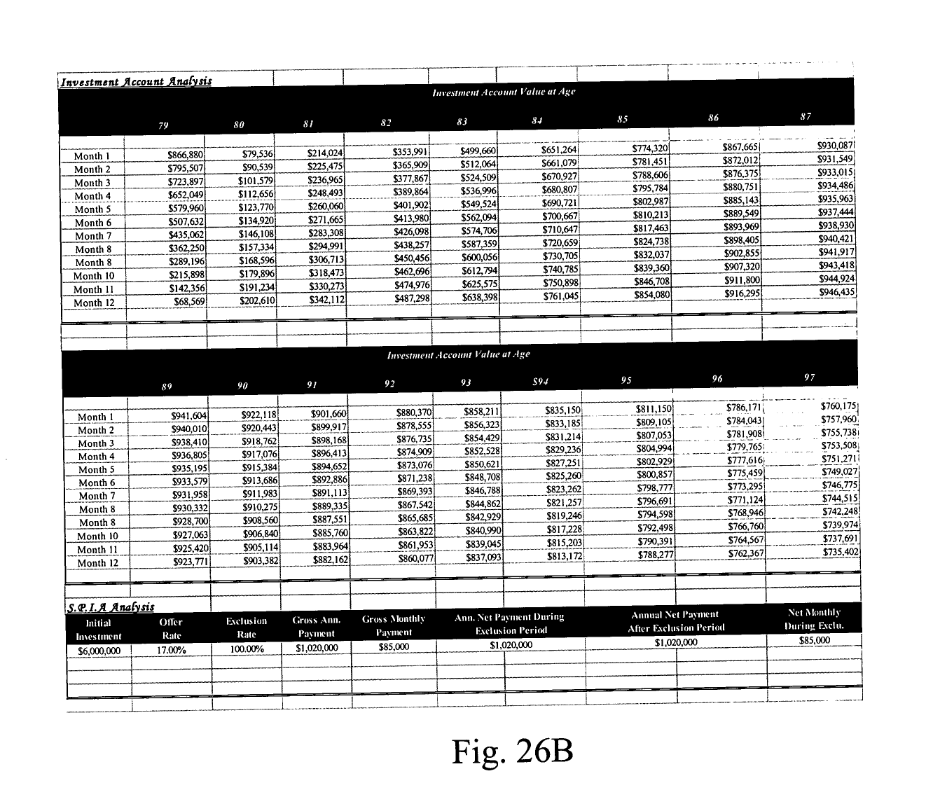

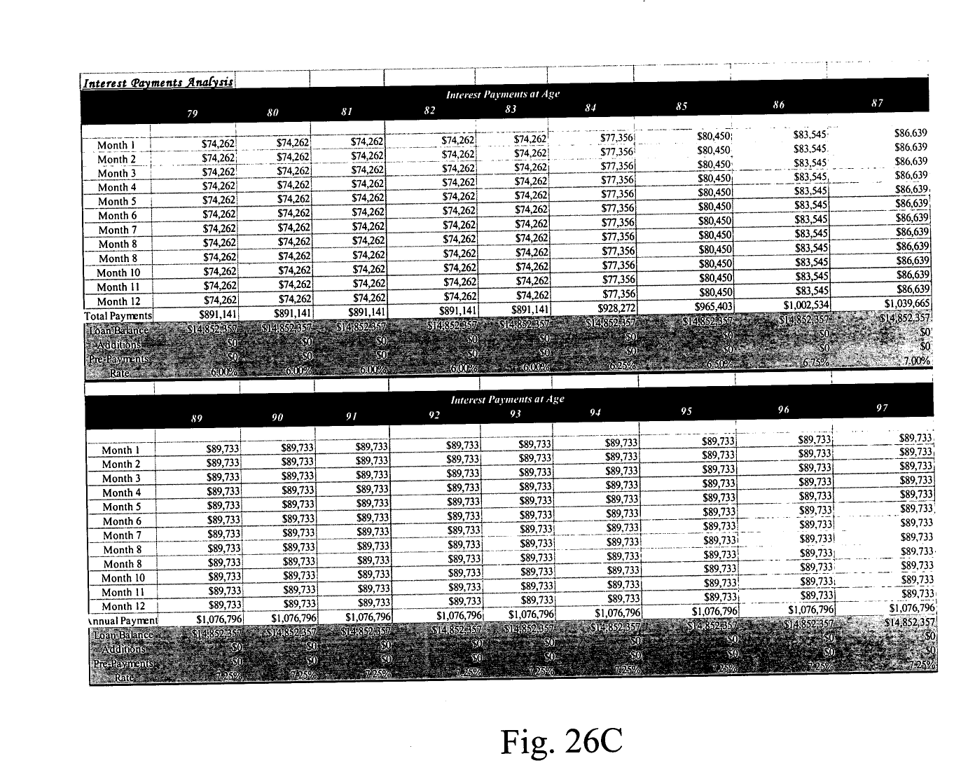

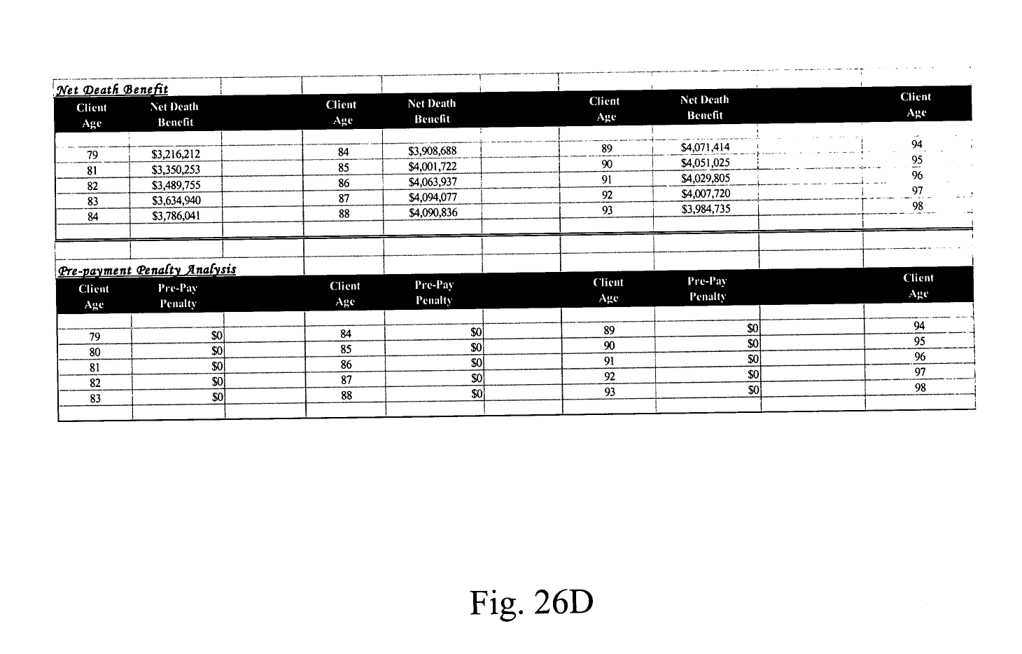

This program provides financial professionals with a powerful tool to quickly and accurately review a variety of scenarios to determine if a premium financing program is advisable to a client. The financial professional will input the client's name, age sex, life expectancy, cost of insurance, reinsurance costs, annuity payout, exclusion ratio, tax rate, SPIA dump in (if applicable), life settlement (if applicable), other sources of funds (if applicable), loan rate, loan term, model term, and SPIA payment or loan amount. The program will take into consideration a number of variables, depending on the financial professional's desired inputs to project the financial viability of a premium financing program. The program will compute future payments, taxes, premiums, loan amount, investment account balance, interest payments, client's cost, net cash flow, net death benefit to heirs on an annual and monthly basis through the model term. The program will output future cash inflows and outflows, which provide the financial professional an estimation for net cost to the client. An example is shown in the Transaction Overview as illustrated in FIG. 24. The monthly and annual ledgers enable the financial professional to view the projected cost or benefits of a premium financing program. An example is shown in the Insurance & Annuity Cash Flow Analysis Model as illustrated in FIGS. 26A through 26D. Using the program outputs the financial professional is able to make a recommendation to his client as to whether a premium financing program is a viable option.

### Example 2

A financial professional is trying to determine if a premium financing program is viable for a used space satellite purchased by a client. The satellite has an estimated life expectancy of seven years, and the client desires to utilize the satellite for six years. The financial professional verifies the useful life expectancy of the satellite. The financial professional prices the client's cost of insurance for the satellite through age nine, two years past its estimated life expectancy. Furthermore, the financial professional has received the cost to reinsure the client's future premium payments should the satellite outlive the period for which the insurance has been funded. In addition, the financial professional has identified a number of lenders with a variety of financing programs available for his client. The life insurance and annuity financing program will enable him to review a number of financing programs and a number of interest rate scenarios for his client.

As an example, the financial professional can input the following and calculate the results:

Client Information: Name: Space Transmission Company, Satellite A1, Age: 10, Tax Rate: 0%, Underwriting Class: special risk, Net Worth: 0, Liquidity: 0, Annual Income 0, Model Term: 20;

SPIA: Carrier(s): pooled, Deposits; Loan: 6,000,000, Life Settlement: 0, SPIA Dump In: 0, Other Sources: 0, Total Deposit: 6,000,000, Offer Rate: 17%, Exclusion Ratio: 100%, Annualized Payment: 1,020,000;

Insurance Premiums: Type of Premium: casualty, ING: 439,512, AG: 0, Manu: 0, Pac: 0, NY: 0, Number of Millions: 18; Total Premiums: 7,911,216

Investment Account: Investment Amount: 941,141, Assumed Yield: 4%;

Sources of Fund: Lender: ING, Loan Amount; 14,852,357, Assumed Rate: 6%, Step (if adjustable rate): 0.25%, Max. Rate: 7.25%, Loan Term: Interest Only for Life, Client Contribution: 0, Life Settlement: 0, SPIA Dump In: 0, Other Sources: 0; Total Sources: 14,852,357;

Use of Funds: New Casualty Insurance: 7,911,216, SPIA: 6,000,000, Investment Account: 941,141; Total Uses of Funds: 14,852,357;

Insurance Insurance: Policy Owner(s) Name: Space Transmission Company; Current Rate: 6%, Assumed Rate: 6%, Guaranteed Rate: 6%; Total New Coverage: 18,000,000, Total Loan: 14,852,357, New Insurance Estate: 3,147,643.

This program provides financial professionals with a powerful tool to quickly and accurately review a variety of scenarios to determine if a premium financing program is advisable to a client. This program can be tailored to any variety of insurable objects with an accurately determinable useful life expectancy. The financial professional can input a variety of information, including the client's name, the insured object, the object's age, the object's useful life expectancy, cost of insurance, reinsurance cost, annuity payout, exclusion ratio, tax rate, SPIA dump in (if applicable), settlement (if applicable), other sources of funds (if applicable), loan rate, loan term, model term, and SPIA payment or loan amount. The program will take into consideration a number of variables, depending on the financial professional's desired inputs to project the viability of a premium financing program. The program will compute future payments, taxes, premiums, loan amount, investment account balance, interest payments, client's cost, net cash flow, net settlement on an annual and monthly basis through the model term. The program will output future cash inflows and outflows, which provide the financial professional an estimation for net cost to the client. Using the program outputs the financial professional to his client as to whether a premium program is a viable option.

### CONCLUSION

Although the present invention has been described in considerable detail with reference to certain versions thereof, other versions are possible. Therefore, the spirit and scope of the appended claims should not be limited to the description of the preferred versions contained herein.

The reader's attention is directed to all papers and documents which are filed concurrently with this specification and which are open to public inspection with this specification, and the contents of all such papers and documents are incorporated herein by reference.

All the features disclosed in this specimen, including any accompanying claim, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specific function, or “step for” performing a specific function, is not to be interpreted as “means for” or “step” clause as specified in 35 U.S.C. § 112, ¶ 6. In particular, the use of “step of” in the claims herein is not intended to invoke the provisions of 35 U.S.C. § 112, ¶ 6.

We claim:

1. A method for forming an insurance plan for an individual comprising the steps of:
a) determining a life expectancy of an individual;
b) obtaining a quote for at least one life insurance policy for said individual;
c) obtaining a quote for at least one reinsurance policy for said individual;
d) determining the cost of insuring said individual through said individual's life expectancy plus a grace period;
e) determining the cost of reinsuring said individual for a period beyond their life expectancy plus said grace period; and
f) selecting an insurance plan for said individual utilizing one of said life insurance policies and one of said reinsurance policies.

2. The method according to claim 1, further comprising procuring personal and medical information about said individual before determining the life expectancy for said individual.

3. The method according to claim 1, wherein said grace period is between about 1, 3, 5, 7, 9, 10, 30, 50, 70, 90, 100, 300 or 365 days and about 2, 4, 6, 8, 20, 40, 60, 80 or 200 days.

4. The method according to claim 1, wherein said grace period is between about 1, 3, 5, 7, 9, 10, or 15 years and about 2, 4, 6, 8 or 20 years.

5. The method according to claim 1, wherein said grace period is zero days.

6. The method according to claim 1, further comprising obtaining a quote for at least one loan to assist in the payment of said insurance and reinsurance premiums.

7. The method according to claim 1, further comprising obtaining a quote for at least one single premium immediate annuity to assist in the payment of said insurance and reinsurance premiums.

8. The method according to claim 1, further comprising obtaining a quote for at least one loan and one single premium immediate annuity to assist in the payment of said insurance and reinsurance premiums.

9. The method according to claim 1, further comprising, after the selection of an insurance plan, obtaining the promise of said individual to assign their beneficial interest in said life insurance to said reinsurer if said individual is alive one day following said grace period and obtaining in return said reinsurer's promise to pay a cash payment equal to the death benefit under said life insurance policy to the individual if said individual is alive one day following said grace period.

10. The method according to claim 1, wherein selecting said insurance plan for said individual utilizing one of said life insurance policies and one of said reinsurance policies is based upon the optimal combination of life insurance policy and reinsurance policy to maximize said individual=s death benefit and minimize said individual's premiums.

11. A method for forming an insurance plan for an object comprising the steps of:
a) determining a useful life expectancy of said object;
b) obtaining a quote for at least one insurance policy for said object;
c) obtaining a quote for at least one reinsurance policy for said object;
d) determining the cost of insuring said object up through said object's useful life expectancy plus a grace period;
e) determining the cost of reinsuring said object for a period following said object's useful life expectancy plus said grace period;
f) selecting an insurance plan for said object utilizing one of said life insurance policies and one of said reinsurance policies.

12. The method according to claim 11, further comprising procuring technical data about said object before determining the useful life expectancy for said object.

13. The method according to claim 11, wherein said grace period is between about 1, 3, 5, 7, 9, 10, 30, 50, 70, 90, 100, 300 or 365 days and about 2, 4, 6, 8, 20, 40, 60, 80 or 200 days.

14. The method according to claim 11, wherein said grace period is between about 1, 3, 5, 7, 9, 10, or 15 years and about 2, 4, 6, 8 or 20 years.

15. The method according to claim 11, wherein said grace period is zero days.

16. The method according to claim 11, further comprising obtaining a quote for at least one loan to assist in the payment of said insurance and reinsurance premiums.

17. The method according to claim 11, further comprising obtaining a quote for at least one single premium immediate annuity to assist in the payment of said insurance premiums.

18. The method according to claim 11, further comprising obtaining a quote for at least one loan and one single premium immediate annuity to assist in the payment of said insurance and reinsurance premiums.

19. The method according to claim 11, further comprising obtaining the promise of a beneficial owner of said object to assign their beneficial interest in said insurance to said reinsurer if said object retains its useful character one day following said grace period and obtaining in return said reinsurer's promise to pay a cash payment equal to the benefit under said insurance policy to said owner if said object retains its useful character one day following said grace period.

20. The method according to claim 11, further comprising selecting an insurance plan for said object utilizing one of said insurance policies and one of said reinsurance policies based upon the optimal combination of insurance policy and reinsurance policy to maximize said insurance policy's benefit and minimize said object's owner's premiums.

21. A method of providing reduced cost insurance, comprising:
a) obtaining an accurate predicted date of death for an individual; and
b) providing a reduced cost insurance premium plan for said individual underwritten using the said accurate predicted date of death for said individual and an assumed reduced premium payment default risk.

22. A method of providing reduced cost insurance, comprising:
a) determining an accurate predicted date of death for an individual utilizing an accurate life expectancy calculation;
b) calculating a payment date by adding a grace period to said predicted date of death;
c) calculating a reduced cost insurance premium plan utilizing a reduced rate of default variable for said calculation; and
d) providing said reduced cost insurance premium plan for said individual.

23. A method of providing reduced cost insurance, comprising,
a) obtaining an accurate date of death for an individual;
b) calculating a payment date by adding a grace period to said date of death;
c) calculating a reduced cost insurance premium plan for said individual based upon an insurer's expectations of one or more of the following:
i) the probability said individual will die prior to said payment date is high;
ii) the probability of said insurer timely receiving each and every premium up to the time of said individual's death is high because the financial burden on the individual is reduced through the use of a loan or loan and single premium immediate annuity;
iii) the probability of said insurer timely receiving each and every premium up to the time of said individual's death is high because the financial burden on the individual is offset by the financial gain to the beneficiary or beneficiaries on either said individual's death or upon said individual living to said payment date;
iv) the probability of said insurer timely receiving each and every premium up to the time of said individual's death is high because a reinsurer will, if the individual is alive on the payment date, pay the individual an amount equal to the death benefit in exchange for becoming the beneficiary under the reduced cost insurance premium plan; and
d) Providing a reduced cost insurance premium plan for said individual based upon one or more of the aforesaid expectations.

24. A method of providing a novel reinsurance policy, comprising:
a) obtaining a payment date for an individual calculated by adding a grace period to an accurate predicted date of death for said individual; and
b) providing a novel reinsurance policy whose terms provide if said individual is alive at said payment date for the reinsurer to award a cash payment equal to the death benefit under said life insurance policy to the individual.

25. A method of providing a novel reinsurance policy, comprising,
a) obtaining a payment date for an individual calculated by adding a grace period to an accurate predicted date of death for said individual;
b) obtaining the terms of a life insurance policy for said individual;
c) promising to pay, if said individual is alive at said payment date, a cash payment to said individual;
d) promising to pay, if said individual is alive at said payment date, the remaining premium payments for said life insurance policy up to the death of said individual; and
e) obtaining the promise of said individual to assign at said payment date to the reinsurer the beneficial interest in said life insurance policy if said individual is alive at said payment date.

26. The method according to claim 25, wherein said grace period is between about 1, 3, 5, 7, 9, 10, 30, 50, 70, 90, 100, 300 or 365 days and about 2, 4, 6, 8, 20, 40, 60, 80 or 200 days.

27. The method according to claim 25, wherein said grace period is between about 1, 3, 5, 7, 9, 10, or 15 years and about 2, 4, 6, 8 or 20 years.

28. The method according to claim 25, wherein said grace period is zero days.

29. The method according to claim 25, wherein said cash payment is equal to the death benefit under said life insurance policy.

30. The method according to claim 25, wherein said cash payment is less than the death benefit under said life insurance policy.

31. The method according to claim 25, wherein said cash payment is more than the death benefit under said life insurance policy.

32. A method of providing reduced cost insurance, comprising:
a) obtaining an accurate predicted date of loss of utility for an object; and
b) providing a reduced cost insurance premium plan for said object underwritten using the said accurate predicted date of loss of utility for said object and an assumed reduced premium payment default risk.

33. A method of providing reduced cost insurance, comprising:
a) determining an accurate predicted date of loss of utility for an object;
b) calculating a payment date by adding a grace period to said predicted date of utility loss;
c) calculating a reduced cost insurance premium plan utilizing a reduced rate of default variable for said calculation; and
d) providing said reduced cost insurance premium plan for said object.

34. A method of providing reduced cost insurance, comprising,
a) obtaining an accurate date of loss of utility for an object;
b) calculating a payment date by adding a grace period to said date of loss of utility;
c) calculating a reduced cost insurance premium plan for said object based upon an insurer's expectations of one or more of the following:
i) the probability said object will lose its utility prior to said payment date is high;
ii) the probability of said insurer timely receiving each and every premium up to the time of said object's loss of utility is high because the financial burden on said individual is reduced through the use of a loan or loan and single premium immediate annuity;
iii) the probability of said insurer timely receiving each and every premium up to the time of said object's loss of utility is high because the financial burden on the owner of said object is offset by the financial gain to the beneficiary or beneficiaries on either said object's loss of utility or upon said object maintaining its utility to said payment date;
iv) the probability of said insurer timely receiving each and every premium up to the time of said object's loss of utility is high because a reinsurer will, if said object is still utile on the payment date, pay the owner of said object an amount equal to the death benefit in exchange for becoming the beneficiary under the reduced cost insurance premium plan; and
d) Providing a reduced cost insurance premium plan for said object based upon one or more of the aforesaid expectations.

35. A method of providing a novel reinsurance policy, comprising:
a) obtaining a payment date for an object calculated by adding a grace period to an accurate predicted date of loss of utility for said object; and
b) providing a novel reinsurance policy whose terms provide if said object retains its utility at said payment date for the reinsurer to award a cash payment to the owner of said object.

36. A method of providing a novel reinsurance policy, comprising,
a) obtaining a payment date for an object calculated by adding a grace period to an accurate predicted date of loss of utility for said object;
b) obtaining the terms of an insurance policy for said object; and
c) promising to pay, if said object retains its utility at said payment date, a cash payment to the owner of said object;
d) promising to pay, if said object retains its utility at said payment date, the remaining premium payments for said insurance policy up to the loss of utility of said object; and
e) obtaining the promise of the owner of said object to assign at said payment date to the reinsurer the beneficial interest in said insurance policy if said object retains its utility at said payment date.

37. The method according to claim 36, wherein said grace period is between about 1, 3, 5, 7, 9, 10, 30, 50, 70, 90, 100, 300 or 365 days and about 2, 4, 6, 8, 20, 40, 60, 80 or 200 days.

38. The method according to claim 36, wherein said grace period is between about 1, 3, 5, 7, 9, 10, or 15 years and about 2, 4, 6, 8 or 20 years.

39. The method according to claim 36, wherein said grace period is zero days.

40. The method according to claim 36, wherein said cash payment is equal to the benefit under said life insurance policy.

41. The method according to claim 36, wherein said cash payment is less than the benefit under said life insurance policy.

42. The method according to claim 36, wherein said cash payment is more than the benefit under said life insurance policy.

43. A data processing system for assisting a financial professional; in operative combination comprising:
a) a first input module for entering one or more of the following pertinent data: a name of said individual, an age of said individual, the sex of said individual, the name of an agent of said individual, the tax rate under which said individual falls, said individual's underwriting class, said individual's net worth, said individual's annual income, the life expectancy of said individual, said individual's carriers, the life insurance policies for said individual, the costs of said life insurance, the sources of finds for a single premium immediate annuity (SPIA), the total amount of the deposits into said SPIA, the amount of the loan to said SPIA, the SPIA dump in, other sources for funding said SPIA, the offer rate of said SPIA, the exclusion ration for said SPIA, the annualized payments from said SPIA, the type of life insurance premiums said individual pays, the name of said life insurance provider, the prepay penalty for said life insurance policy, the total amount paid by individual for all said life insurance premiums, the amount of individual's investment account, the yield of said investment account, the lender that will be the source of said funds, the amount that said lender will loan, the rate of said loan, the prepayment per annum for said loan, the loan additions per annum for said loan, the amount that said individual contributes, the life settlement of said insurance, other sources of said funds, the total uses for said funds, the identify of a new life insurance policy, the identify of a new SPIA, the identify of an investment account, a check for those uses of said funds, the name of the owner of said life insurance policy(ies), said policy name, said policy amount, said policy's current rate, said policy's assumed rate, said policy's guaranteed rate, said total new coverage, said total loan, and said total new insurance to the estate;
b) a second calculation module for determining the feasibility, price, distributions of, and liabilities incurred by, the creation of a premium financing program for a said individual; and
c) a third output module for displaying information generated by the second calculation module.

44. The data processing system according to claim 43, wherein said second calculation module determines the feasibility, price, distributions of, and liabilities incurred by, the creation of a premium financing program for an individual based upon a hypothetical situation wherein a reinsurance carrier will fund future premium payments beyond a specified payment date if the individual lives beyond said specified payment date under one of the three following possible financing options:
a) the individual uses their own funds to purchase the life insurance and reinsurance policies;
b) the individual obtains a loan to purchase the life insurance and reinsurance policies; and
c) the individual obtains a loan to purchase the life insurance and reinsurance policies and a single premium immediate annuity.

45. The data processing system according to claim 43, wherein said second calculation module determines the feasibility, price, distributions of, and liabilities incurred by, the creation of a premium financing program for an individual based upon a hypothetical situation wherein said individual obtains a loan to purchase the life insurance and reinsurance policies said second calculation module further comprising the following submodules:
a) an initial calculations module;
b) a SPIA calculations module;
c) an other inflows calculation module;
d) an outflow calculations module;
e) a loan calculation module; and
f) an other calculations module.

46. The data processing system according to claim 43, wherein said second calculation module determines the feasibility, price, distributions of, and liabilities incurred by, the creation of a premium financing program for an individual based upon a hypothetical situation wherein a reinsurance carrier will fund future premium payments beyond a specified payment date if the individual lives beyond said specified payment date in the instance where the individual uses their own funds to purchase the life insurance and reinsurance policies said second calculation module further comprising the following submodules:
a) an initial calculations module;
b) a SPIA calculations module;
c) an other inflows calculation module;
d) an outflow calculations module;
e) a loan calculation module; and
f) an other calculations module.

47. The data processing system according to claim 43, wherein said second calculation module determines the feasibility, price, distributions of, and liabilities incurred by, the creation of a premium financing program for an individual based upon a hypothetical situation wherein a reinsurance carrier will fund future premium payments beyond a specified payment date if the individual lives beyond said specified payment date in the instance where the individual obtains a loan to purchase the life insurance and reinsurance policies and a single premium immediate annuity said second calculation module further comprising the following submodules:
a) an initial calculations module;
b) a SPIA calculations module;
c) an other inflows calculation module;
d) an outflow calculations module;
e) a loan calculation module; and
f) an other calculations module.

48. A method for preparing a premium financing program report, comprising,
a) means for inputting one or more of the following pertinent data: a name of said individual, an age of said individual, the sex of said individual, the name of an agent of said individual, the tax rate under which said individual falls, said individual's underwriting class, said individual's net worth, said individual's annual income, the life expectancy of said individual, said individual's carriers, the life insurance policies for said individual, the costs of said life insurance, the sources of funds for a single premium immediate annuity (SPIA), the total amount of the deposits into said SPIA, the amount of the loan to said SPIA, the SPIA dump in, other sources for funding said SPIA, the offer rate of said SPIA, the exclusion ration for said SPIA, the annualized payments from said SPIA, the type of life insurance premiums said individual pays, the name of said life insurance provider, the prepay penalty for said life insurance policy, the total amount paid by individual for all said life insurance premiums, the amount of individual's investment account, the yield of said investment account, the lender that will be the source of said funds, the amount that said lender will loan, the rate of said loan, the prepayment per annum for said loan, the loan additions per annum for said loan, the amount that said individual contributes, the life settlement of said insurance, other sources of said funds, the total uses for said funds, the identify of a new life insurance policy, the identify of a new SPIA, the identify of an investment account, a check for those uses of said funds, the name of the owner of said life insurance policy(ies), said policy name, said policy amount, said policy's current rate, said policy's assumed rate, said policy's guaranteed rate, said total new coverage, said total loan, and said total new insurance to the estate;
b) means for calculating the feasibility, price, distributions of, and liabilities incurred by, the creation of a premium financing program for an individual; and
c) means for displaying information generated by said calculation means.

49. The method according to claim 48, wherein a reinsurance carrier will fund future premium payments beyond a specified payment date if the individual lives beyond said specified payment date under one of the three following possible financing options:
a) the individual uses their own funds to purchase the life insurance and reinsurance policies;
b) the individual obtains a loan to purchase the life insurance and reinsurance policies; and
c) the individual obtains a loan to purchase the life insurance and reinsurance policies and a single premium immediate annuity.

50. A method for preparing a premium financing program report, comprising:
a) inputting one or more of the following pertinent data: a name of said individual, an age of said individual, the sex of said individual, the name of an agent of said individual, the tax rate under which said individual falls, said individual's underwriting class, said individual's net worth, said individual's annual income, the life expectancy of said individual, said individual's carriers, the life insurance policies for said individual, the costs of said life insurance, the sources of funds for a single premium immediate annuity (SPIA), the total amount of the deposits into said SPIA, the amount of the loan to said SPIA, the SPIA dump in, other sources for funding said SPIA, the offer rate of said SPIA, the exclusion ration for said SPIA, the annualized payments from said SPIA, the type of life insurance premiums said individual pays, the name of said life insurance provider, the prepay penalty for said life insurance policy, the total amount paid by individual for all said life insurance premiums, the amount of individual's investment account, the yield of said investment account, the lender that will be the source of said funds, the amount that said lender will loan, the rate of said loan, the prepayment per annum for said loan, the loan additions per annum for said loan, the amount that said individual contributes, the life settlement of said insurance, other sources of said funds, the total uses for said funds, the identify of a new life insurance policy, the identify of a new SPIA, the identify of an investment account, a check for those uses of said funds, the name of the owner of said life insurance policy(ies), said policy name, said policy amount, said policy's current rate, said policy's assumed rate, said policy's guaranteed rate, said total new coverage, said total loan, and said total new insurance to the estate;
b) means for calculating the feasibility, price, distributions of, and liabilities incurred by, the creation of a premium financing program for an individual; and
c) displaying information generated by said calculation means to prepare a premium financing program report.

51. The method according to claim 50, wherein a reinsurance carrier will fund future premium payments beyond a specified payment date if the individual lives beyond said specified payment date under one of the three following possible financing options:
a) the individual uses their own funds to purchase the life insurance and reinsurance policies;
b) the individual obtains a loan to purchase the life insurance and reinsurance policies; and
c) the individual obtains a loan to purchase the life insurance and reinsurance policies and a single premium immediate annuity.

52. A data processing system for assisting a financial professional; in operative combination comprising:
a) a first input module for entering one or more of the following pertinent data: a name of an object, the present age of said object, the useful life expectancy of said object, said object's owner's name, said owner's insurance carriers, the insurance policies for said object, the costs of said insurance, the sources of funds for a single premium immediate annuity (SPIA), the total amount of the deposits into said SPIA, the amount of the loan to said SPIA, the SPIA dump in, other sources for funding said SPIA, the offer rate of said SPIA, the exclusion ratio for said SPIA, the annualized payments from said SPIA, the type of insurance premiums paid, the name of said insurance provider, the prepay penalty for said insurance policy, the total amount paid for all said insurance premiums, the amount of said owner's investment account, the yield of said investment account, the lender that will be the source of said funds, the amount that said lender will loan, the rate of said loan, the prepayment per annum for said loan, the loan additions per annum for said loan, the amount that said owner contributes, the settlement of said insurance, other sources of said funds, the total uses for said funds, the identify of a new life insurance policy, the identify of a new SPIA, the identify of an investment account, a check for those uses of said funds, the name of the owner of said insurance policy(ies), said policy name, said policy amount, said policy's current rate, said policy's assumed rate, said policy's guaranteed rate, said total new coverage, said total loan, and said total new insurance to the beneficiary;
b) a second calculation module for determining the feasibility, price, distributions of, and liabilities incurred by, the creation of a premium financing program for said object; and
c) a third output module for displaying information generated by the second calculation module.

53. The data processing system according to claim 52, wherein said second calculation module determines the feasibility, price, distributions of, and liabilities incurred by, the creation of a premium financing program for an object based upon a hypothetical situation wherein a reinsurance carrier will fund future premium payments beyond a specified payment date if said object maintains its utility beyond said specified payment date under one of the three following possible financing options:
a) the owner of said object uses their own funds to purchase the insurance and reinsurance policies;
b) the owner of said object obtains a loan to purchase the life insurance and reinsurance policies; and
c) the owner of said object obtains a loan to purchase the life insurance and reinsurance policies and a single premium immediate annuity.

54. The data processing system according to claim 52, wherein said second calculation module determines the feasibility, price, distributions of, and liabilities incurred by, the creation of a premium financing program for an object based upon a hypothetical situation wherein said owner of said object obtains a loan to purchase the insurance and reinsurance policies said second calculation module further comprising the following submodules:
a) an initial calculations module;
b) a SPIA calculations module;
c) an other inflows calculation module;
d) an outflow calculations module;
e) a loan calculation module; and
f) an other calculations module.

55. The data processing system according to claim 52, wherein said second calculation module determines the feasibility, price, distributions of, and liabilities incurred by, the creation of a premium financing program for an object based upon a hypothetical situation wherein a reinsurance carrier will fund future premium payments beyond a specified payment date if said object maintains its utility beyond said specified payment date in the instance where said owner of said object uses their own funds to purchase the insurance and reinsurance policies said second calculation module further comprising the following submodules:
a) an initial calculations module;
b) a SPIA calculations module;
c) an other inflows calculation module;
d) an outflow calculations module;
e) a loan calculation module; and
f) an other calculations module.

56. The data processing system according to claim 52, wherein said second calculation module determines the feasibility, price, distributions of, and liabilities incurred by, the creation of a premium financing program for an object based upon a hypothetical situation wherein a reinsurance carrier will fund future premium payments beyond a specified payment date if said object maintains its utility beyond said specified payment date in the instance where the owner of said object obtains a loan to purchase the insurance and reinsurance policies and a single premium immediate annuity said second calculation module further comprising the following submodules:
a) an initial calculations module;
b) a SPIA calculations module;
c) an other inflows calculation module;
d) an outflow calculations module;
e) a loan calculation module; and
f) an other calculations module.

57. A method for preparing a premium financing program report, comprising,
a) means for inputting one or more of the following pertinent data: a name of an object, the present age of said object, the useful life expectancy of said object, said object's owner's name, said owner's carriers, the insurance policies for said object, the costs of said insurance, the sources of funds for a single premium immediate annuity (SPIA), the total amount of the deposits into said SPIA, the amount of the loan to said SPIA, the SPIA dump in, other sources for funding said SPIA, the offer rate of said SPIA, the exclusion ration for said SPIA, the annualized payments from said SPIA, the type of insurance premiums paid, the name of said insurance provider, the prepay penalty for said insurance policy, the total amount paid for all said insurance premiums, the amount of said owner's investment account, the yield of said investment account, the lender that will be the source of said funds, the amount that said lender will loan, the rate of said loan, the prepayment per annum for said loan, the loan additions per annum for said loan, the amount that said owner contributes, the settlement of said insurance, other sources of said funds, the total uses for said funds, the identify of a new insurance policy, the identify of a new SPIA, the identify of an investment account, a check for those uses of said funds, the name of the owner of said insurance policy(ies), said policy name, said policy amount, said policy's current rate, said policy's assumed rate, said policy's guaranteed rate, said total new coverage, said total loan, and said total new insurance to the beneficiary;
b) means for calculating the feasibility, price, distributions of, and liabilities incurred by, the creation of a premium financing program for an object; and
c) means for displaying information generated by said calculation means.

58. The method according to claim 57, wherein a reinsurance carrier will fund future premium payments beyond a specified payment date if said object maintains its utility beyond said specified payment date under one of the three following possible financing options:
a) the owner of said object uses their own funds to purchase the insurance and reinsurance policies;
b) the owner of said object obtains a loan to purchase the insurance and reinsurance policies; and
c) the owner of said object obtains a loan to purchase the insurance and reinsurance policies and a single premium immediate annuity.

59. A method for preparing a premium financing program report, comprising:
a) inputting one or more of the following pertinent data: a name of an object, the present age of said object, the useful life expectancy of said object, said object's owner's name, said owner's carriers, the insurance policies for said object, the costs of said insurance, the sources of funds for a single premium immediate annuity (SPIA), the total amount of the deposits into said SPIA, the amount of the loan to said SPIA, the SPIA dump in, other sources for funding said SPIA, the offer rate of said SPIA, the exclusion ration for said SPIA, the annualized payments from said SPIA, the type of insurance premiums paid, the name of said insurance provider, the prepay penalty for said insurance policy, the total amount paid for all said insurance premiums, the amount of said owner's investment account, the yield of said investment account, the lender that will be the source of said funds, the amount that said lender will loan, the rate of said loan, the prepayment per annum for said loan, the loan additions per annum for said loan, the amount that said owner contributes, the settlement of said insurance, other sources of said funds, the total uses for said funds, the identify of a new insurance policy, the identify of a new SPIA, the identify of an investment account, a check for those uses of said funds, the name of the owner of said insurance policy(ies), said policy name, said policy amount, said policy's current rate, said policy's assumed rate, said policy's guaranteed rate, said total new coverage, said total loan, and said total new insurance to the beneficiary;
b) means for calculating the feasibility, price, distributions of, and liabilities incurred by, the creation of a premium financing program for an object; and
c) displaying information generated by said calculation means to prepare a premium financing program report.

60. The method according to claim 59, wherein a reinsurance carrier will fund future premium payments beyond a specified payment date if said object maintains its utility beyond said specified payment date under one of the three following possible financing options:
a) the owner of said object uses their own funds to purchase the life insurance and reinsurance policies;
b) the owner of said object obtains a loan to purchase the life insurance and reinsurance policies; and
c) the owner of said object obtains a loan to purchase the life insurance and reinsurance policies and a single premium immediate annuity.

61. A machine for tracking life span and automatically generating reports, comprising:
a) a timing means for determining a present date;
b) memory means for electronically storing at least one life span data set for an individual, an associated live or dead status of said individual, and a grace period data set;
c) means for calculating an associated target date from at least said one life span data set and said grace period data set;
d) means for comparing whether said present date is prior to or the same as said associated target date with also the said associated live or dead status of said individual;
e) means for automatically generating a report based on the comparison; and,
f) means for displaying said generated report.

62. The machine according to claim 61, wherein said means for automatically conducting machine activities occurs on a routine basis.

63. A horological machine for tracking the lifespan of individuals and automatically creating appropriate reports for interested third parties, functionally comprising:
a) a means for electronically tracking the passage of time to arrive at the present date;
b) a means for electronically storing at least one data set for an individual=s lifespan tracked said storing means connected to said electronic timing means;
c) means for collecting pertinent parameters relative to an individual and interested third parties;
d) means for calculating a target date for said individual from said collected pertinent parameters;
e) means for calculating on a routine basis whether the present date falls prior to the target date associated with said individual and whether said individual is alive at the present date and upon that joint occurrence automatically creating an appropriate report for an interested third party or parties;
f) means for calculating on a routine basis whether the present date falls prior to the target date associated with said individual and whether said individual is deceased at the present date and upon that joint occurrence automatically creating an appropriate report for an interested third party or parties;
g) means for calculating on a routine basis whether the present date equals the target date associated with said individual and upon that occurrence automatically creating an appropriate report for an interested third party or parties.
